(19) United States
(12) Patent Application Publication
(10) Pub. No.: US 2023/0105713 A1
(43) Pub. Date: Apr. 6, 2023

(54) SYSTEMS AND METHODS FOR FUNDING GAME PLAY AT CASINO TABLE GAMES

(71) Applicant: JCM American Corporation, Las Vegas, NV (US)

(72) Inventors: Mike Nguyen, Las Vegas, NV (US); David Kubajak, Las Vegas, NV (US); Edwin Lai, Las Vegas, NV (US); Chris Blevins, Las Vegas, NV (US); Dillon Archibald, Las Vegas, NV (US); Jordan Cagle, Las Vegas, NV (US)

(21) Appl. No.: 17/449,947

(22) Filed: Oct. 4, 2021

(51) Int. Cl. G07F 17/32

(52) U.S. Cl. CPC G07F 17/3223; G07F 17/3288; G07F 17/3248; G07F 17/3225; G07F 17/322; G07F 17/3272

(57) ABSTRACT

System and method for funding wagers at live casino gaming tables. The systems and methods may use various interconnections of components including, but not limited to, mobile devices, mobile wallet systems, bill validators, TITO Systems, printers, peripheral systems (e.g., FUZION), player interface devices, wireless interfaces, payment processing systems, casino management systems and others. Wireless interface units may be integrated into casino gaming tables (or positioned nearby) and configured to communicate with mobile devices of the players. The system and methods allow players to use mobile wallets, virtual TITO tickets, physical TITO tickets, and other sources to obtain gaming chips for wagering and receiving cash outs in the same forms.

### FIELD OF THE INVENTION

The embodiments of the present invention relate to systems and methods of facilitating mobile transactions and ticket transactions at casino gaming tables. The systems and methods may involve a user's mobile electronic device, such as a mobile phone or tablet, bill validators, ticket printers, etc.

### BACKGROUND

Casinos operate gaming tables on which players play games of chance such as Blackjack, Pai Gow, 3 Card Poker, Let it Ride, Craps, Roulette, etc. Typically, a player purchases gaming chips using cash. Upon receipt of the cash, the dealer provides the player with a corresponding value of gaming chips and drops the cash in a cash box incorporated in the gaming table for later count and verification.

It would be advantageous to the casino and players to provide players with means to purchase gaming chips using other means including, for example, virtual tickets and/or mobile wallet funds.

### SUMMARY

The embodiments disclosed herein involve various configurations of components, including a mobile device (e.g., smart device), mobile wallet system, bill validator, TITO System, printer, Peripheral System, player interface device and wireless interface (which may be part of a peripheral network adapter) and a payment processing system.

Some embodiments described herein generally reference methods and systems for adding funds to a mobile wallet of a user, receiving a communication from the mobile wallet to obtain an amount of funds from a financial account of the user, obtaining the amount of funds from the financial account of the user, and communicating to the mobile wallet to credit the obtained amount of funds into the mobile wallet of the user for use at a casino table game.

Some embodiments may include a configuration in which the method may be performed by a Peripheral System of a casino, wherein the Peripheral System may be communicatively linked with a table game system. One such Peripheral System is the FUZION System manufactured and sold by JCM American Corporation and Japan Cash Machine Co., Ltd. FUZION is a service or system that can be used to drive transactions involving casino peripherals including a bill validator, TITO ticket printer, player interface device and other peripherals used as a middleman to connect other peripherals.

Some embodiments may include a configuration in which the communication to the mobile wallet to credit the obtained amount of funds uses a mobile cellular network.

Embodiments described herein generally reference methods and systems of generating a gaming ticket operable to be applied as payment for gaming chips at a casino table game. The methods may include receiving information related to the gaming ticket from a mobile wallet of a user; transmitting a first communication to a TITO System associated with the casino; receiving a second communication from the TITO System that the gaming ticket may be valid; transmitting a third communication to a Peripheral Network Adapter to cause a printer to print the gaming ticket; receiving from the Peripheral Network Adapter a fourth communication that the gaming ticket has been printed; and transmitting a fifth communication to the mobile wallet to cause the information related to the gaming ticket to be removed or deleted.

Some embodiments may include a configuration in which the information related to the gaming ticket includes information related to a virtual gaming ticket stored on the mobile wallet.

Some embodiments may include a configuration in which the first communication from the TITO System and the second communication from the TITO System are through a TITO Gateway.

The systems herein may include: a bill validator operable to be communicatively linked with a table game system; a Peripheral System operable to communicate with a mobile wallet of a user; a Peripheral Network Adapter communicatively linked with the Peripheral System and the bill validator. The systems may be operable to perform a method that includes: receiving, at the Peripheral System, a first communication from the mobile wallet containing an amount to be used to purchase gaming chips; generating, at the Peripheral System, a validation number based at least on the amount; transmitting at least the validation number to the Peripheral Network Adapter; initiating, by the Peripheral Network Adapter, a virtual ticket transaction with the casino table game system and sending the validation number to the casino table game system.

Some embodiments may include a configuration in which the first communication from the mobile wallet contains information related to a virtual TITO ticket recorded in the mobile wallet.

Some embodiments described herein generally reference systems and methods operable to transfer funds associated with gaming chips of a casino to a mobile wallet of a user, or to another form of credit or value for the user. The systems may include: a Peripheral System operable to communicate with the mobile wallet; and a TITO Gateway communicatively linked with the Peripheral System and operable to send and receive communications between the Peripheral System and a TITO System of the casino. The Peripheral System may be operable to: receive a scan of a printed TITO ticket, the printed TITO ticket having first information representing the gaming chip value; obtain validation of the first information on the printed TITO ticket by sending a first communication through the TITO Gateway to the TITO System and receiving a second communication from the TITO System through the TITO Gateway; create a virtual TITO ticket based on the first information in the scan of the printed TITO ticket; send a third communication to the TITO System through the TITO Gateway with second information regarding the virtual TITO ticket; and send a notification to the mobile wallet to have funds related to the gaming chip value deposited into the mobile wallet.

In all embodiments detailed herein, the system configurations are designed to fund wagers at casino table games and cash out gaming chips at casino table games.

### BRIEF DESCRIPTION OF THE DRAWINGS

The disclosure will be readily understood by the following detailed description in conjunction with the accompanying drawings, wherein like reference numerals designate like structural elements.

Generally, and broadly, FIGS. 1-3 illustrate block diagrams of system configurations for facilitating the embodiments of the present invention.

FIG. 1 is a block diagram illustrating possible component interactions according to the embodiments of the present invention;

FIG. 2 is a block diagram illustrating a mobile device coupled to wireless interface according to the embodiments of the present invention;

FIG. 3 illustrates a block diagram of a mobile device communicating with a player wallet system according to the embodiments of the present invention;

Generally, and broadly, FIGS. 4-46 illustrate block diagrams of various funding configurations according to the embodiments of the present invention.

FIG. 4 illustrates a block diagram of a component funding configuration according to the embodiments of the present invention;

FIG. 5 illustrates a block diagram of a component funding configuration according to the embodiments of the present invention;

FIG. 6 illustrates a block diagram of a component funding configuration according to the embodiments of the present invention;

FIG. 7 illustrates a block diagram of a component funding configuration according to the embodiments of the present invention;

FIG. 8 illustrates a block diagram of a component funding configuration according to the embodiments of the present invention;

FIG. 9 illustrates a block diagram of a component funding configuration according to the embodiments of the present invention;

FIG. 10 illustrates a block diagram of a component funding configuration according to the embodiments of the present invention;

FIG. 11 illustrates a block diagram of a component funding configuration according to the embodiments of the present invention;

FIG. 12 illustrates a block diagram of a component funding configuration according to the embodiments of the present invention;

FIG. 13 illustrates a block diagram of a component funding configuration according to the embodiments of the present invention;

FIG. 14 illustrates a block diagram of a component funding configuration according to the embodiments of the present invention;

FIG. 15 illustrates a block diagram of a component funding configuration according to the embodiments of the present invention;

FIG. 16 illustrates a block diagram of a component funding configuration according to the embodiments of the present invention;

FIG. 17 illustrates a block diagram of a component funding configuration according to the embodiments of the present invention;

FIG. 18 illustrates a block diagram of a component funding configuration according to the embodiments of the present invention;

FIG. 19 illustrates a block diagram of a component funding configuration according to the embodiments of the present invention;

FIG. 20 illustrates a block diagram of a component funding configuration according to the embodiments of the present invention;

FIG. 21 illustrates a block diagram of a component funding configuration according to the embodiments of the present invention;

FIG. 22 illustrates a block diagram of a component funding configuration according to the embodiments of the present invention;

FIG. 23 illustrates a block diagram of a component funding configuration according to the embodiments of the present invention;

FIG. 24 illustrates a block diagram of a component funding configuration according to the embodiments of the present invention;

FIG. 25 illustrates a block diagram of a component funding configuration according to the embodiments of the present invention;

FIG. 26 illustrates a block diagram of a component funding configuration according to the embodiments of the present invention;

FIG. 27 illustrates a block diagram of a component funding configuration according to the embodiments of the present invention;

FIG. 28 illustrates a block diagram of a component funding configuration according to the embodiments of the present invention;

FIG. 29 illustrates a block diagram of a component funding configuration according to the embodiments of the present invention;

FIG. 30 illustrates a block diagram of a component funding configuration according to the embodiments of the present invention;

FIG. 31 illustrates a block diagram of a component funding configuration according to the embodiments of the present invention;

FIG. 32 illustrates a block diagram of a component funding configuration according to the embodiments of the present invention;

FIG. 33 illustrates a block diagram of a component funding configuration according to the embodiments of the present invention;

FIG. 34 illustrates a block diagram of a component funding configuration according to the embodiments of the present invention;

FIG. 35 illustrates a block diagram of a component funding configuration according to the embodiments of the present invention;

FIG. 36 illustrates a block diagram of a component funding configuration according to the embodiments of the present invention;

FIG. 37 illustrates a block diagram of a component funding configuration according to the embodiments of the present invention;

FIG. 38 illustrates a block diagram of a component funding configuration according to the embodiments of the present invention;

FIG. 39 illustrates a block diagram of a component funding configuration according to the embodiments of the present invention;

FIG. 40 illustrates a block diagram of a component funding configuration according to the embodiments of the present invention;

FIG. 41 illustrates a block diagram of a component funding configuration according to the embodiments of the present invention;

FIG. 42 illustrates a block diagram of a component funding configuration according to the embodiments of the present invention;

FIG. 43 illustrates a block diagram of a component funding configuration according to the embodiments of the present invention;

FIG. 44 illustrates a block diagram of a component funding configuration according to the embodiments of the present invention;

FIG. 45 illustrates a block diagram of a component funding configuration according to the embodiments of the present invention;

FIG. 46 illustrates a block diagram of a component funding configuration according to the embodiments of the present invention;

Generally, and broadly, FIGS. 47-109 illustrate block diagrams of various buy-in use cases according to the embodiments of the present invention.

FIG. 47 illustrates a block diagram of a system configuration for transferring funds via physical TITO tickets or virtual TITO tickets using system components for buy-in uses according to the embodiments of the present invention;

FIG. 48 illustrates a block diagram of a system configuration for transferring funds via physical TITO tickets or virtual TITO tickets using system components for buy-in uses according to the embodiments of the present invention;

FIG. 49 illustrates a block diagram of a system configuration for transferring funds via physical TITO tickets or virtual TITO tickets using system components for buy-in uses according to the embodiments of the present invention;

FIG. 50 illustrates a block diagram of a system configuration for transferring funds via physical TITO tickets or virtual TITO tickets using system components for buy-in uses according to the embodiments of the present invention;

FIG. 51 illustrates a block diagram of a system configuration for transferring funds via physical TITO tickets or virtual TITO tickets using system components for buy-in uses according to the embodiments of the present invention;

FIG. 52 illustrates a block diagram of a system configuration for transferring funds via physical TITO tickets or virtual TITO tickets using system components for buy-in uses according to the embodiments of the present invention;

FIG. 53 illustrates a block diagram of a system configuration for transferring funds via physical TITO tickets or virtual TITO tickets using system components for buy-in uses according to the embodiments of the present invention;

FIG. 54 illustrates a block diagram of a system configuration for transferring funds via physical TITO tickets or virtual TITO tickets using system components for buy-in uses according to the embodiments of the present invention;

FIG. 55 illustrates a block diagram of a system configuration for transferring funds via physical TITO tickets or virtual TITO tickets using system components for buy-in uses according to the embodiments of the present invention;

FIG. 56 illustrates a block diagram of a system configuration for transferring funds via physical TITO tickets or virtual TITO tickets using system components for buy-in uses according to the embodiments of the present invention;

FIG. 57 illustrates a block diagram of a system configuration for transferring funds via physical TITO tickets or virtual TITO tickets using system components for buy-in uses according to the embodiments of the present invention;

FIG. 58 illustrates a block diagram of a system configuration for transferring funds via physical TITO tickets or virtual TITO tickets using system components for buy-in uses according to the embodiments of the present invention;

FIG. 59 illustrates a block diagram of a system configuration for transferring funds via physical TITO tickets or virtual TITO tickets using system components for buy-in uses according to the embodiments of the present invention;

FIG. 60 illustrates a block diagram of a system configuration for transferring funds via physical TITO tickets or virtual TITO tickets using system components for buy-in uses according to the embodiments of the present invention;

FIG. 61 illustrates a block diagram of a system configuration for transferring funds via physical TITO tickets or virtual TITO tickets using system components for buy-in uses according to the embodiments of the present invention;

FIG. 62 illustrates a block diagram of a system configuration for transferring funds via physical TITO tickets or virtual TITO tickets using system components for buy-in uses according to the embodiments of the present invention;

FIG. 63 illustrates a block diagram of a system configuration for transferring funds via physical TITO tickets or virtual TITO tickets using system components for buy-in uses according to the embodiments of the present invention;

FIG. 64 illustrates a block diagram of a system configuration for transferring funds via physical TITO tickets or virtual TITO tickets using system components for buy-in uses according to the embodiments of the present invention;

FIG. 65 illustrates a block diagram of a system configuration for transferring funds via physical TITO tickets or virtual TITO tickets using system components for buy-in uses according to the embodiments of the present invention;

FIG. 66 illustrates a block diagram of a system configuration for transferring funds via physical TITO tickets or virtual TITO tickets using system components for buy-in uses according to the embodiments of the present invention;

FIG. 67 illustrates a block diagram of a system configuration for transferring funds via physical TITO tickets or virtual TITO tickets using system components for buy-in uses according to the embodiments of the present invention;

FIG. 68 illustrates a block diagram of a system configuration for transferring funds via physical TITO tickets or virtual TITO tickets using system components for buy-in uses according to the embodiments of the present invention;

FIG. 69 illustrates a block diagram of a system configuration for transferring funds via physical TITO tickets or virtual TITO tickets using system components for buy-in uses according to the embodiments of the present invention;

FIG. 70 illustrates a block diagram of a system configuration for transferring funds via physical TITO tickets or virtual TITO tickets using system components for buy-in uses according to the embodiments of the present invention;

FIG. 71 illustrates a block diagram of a system configuration for transferring funds via physical TITO tickets or virtual TITO tickets using system components for buy-in uses according to the embodiments of the present invention;

FIG. 72 illustrates a block diagram of a system configuration for transferring funds via physical TITO tickets or virtual TITO tickets using system components for buy-in uses according to the embodiments of the present invention;

FIG. 73 illustrates a block diagram of a system configuration for transferring funds via physical TITO tickets or virtual TITO tickets using system components for buy-in uses according to the embodiments of the present invention;

FIG. 74 illustrates a block diagram of a system configuration for transferring funds via physical TITO tickets or virtual TITO tickets using system components for buy-in uses according to the embodiments of the present invention;

FIG. 75 illustrates a block diagram of a system configuration for transferring funds via physical TITO tickets or virtual TITO tickets using system components for buy-in uses according to the embodiments of the present invention;

FIG. 76 illustrates a block diagram of a system configuration for transferring funds via physical TITO tickets or virtual TITO tickets using system components for buy-in uses according to the embodiments of the present invention;

FIG. 77 illustrates a block diagram of a system configuration for transferring funds via physical TITO tickets or virtual TITO tickets using system components for buy-in uses according to the embodiments of the present invention;

FIG. 78 illustrates a block diagram of a system configuration for transferring funds via physical TITO tickets or virtual TITO tickets using system components for buy-in uses according to the embodiments of the present invention;

FIG. 79 illustrates a block diagram of a system configuration for transferring funds via physical TITO tickets or virtual TITO tickets using system components for buy-in uses according to the embodiments of the present invention;

FIG. 80 illustrates a block diagram of a system configuration for transferring funds via physical TITO tickets or virtual TITO tickets using system components for buy-in uses according to the embodiments of the present invention;

FIG. 81 illustrates a block diagram of a system configuration for transferring funds via physical TITO tickets or virtual TITO tickets using system components for buy-in uses according to the embodiments of the present invention;

FIG. 82 illustrates a block diagram of a system configuration for transferring funds via physical TITO tickets or virtual TITO tickets using system components for buy-in uses according to the embodiments of the present invention;

FIG. 83 illustrates a block diagram of a system configuration for transferring funds via physical TITO tickets or virtual TITO tickets using system components for buy-in uses according to the embodiments of the present invention;

FIG. 84 illustrates a block diagram of a system configuration for transferring funds via physical TITO tickets or virtual TITO tickets using system components for buy-in uses according to the embodiments of the present invention;

FIG. 85 illustrates a block diagram of a system configuration for transferring funds via physical TITO tickets or virtual TITO tickets using system components for buy-in uses according to the embodiments of the present invention;

FIG. 86 illustrates a block diagram of a system configuration for transferring funds via physical TITO tickets or virtual TITO tickets using system components for buy-in uses according to the embodiments of the present invention;

FIG. 87 illustrates a block diagram of a system configuration for transferring funds via physical TITO tickets or virtual TITO tickets using system components for buy-in uses according to the embodiments of the present invention;

FIG. 88 illustrates a block diagram of a system configuration for transferring funds via physical TITO tickets or virtual TITO tickets using system components for buy-in uses according to the embodiments of the present invention;

FIG. 89 illustrates a block diagram of a system configuration for transferring funds via physical TITO tickets or virtual TITO tickets using system components for buy-in uses according to the embodiments of the present invention;

FIG. 90 illustrates a block diagram of a system configuration for transferring funds via physical TITO tickets or virtual TITO tickets using system components for buy-in uses according to the embodiments of the present invention;

FIG. 91 illustrates a block diagram of a system configuration for transferring funds via physical TITO tickets or virtual TITO tickets using system components for buy-in uses according to the embodiments of the present invention;

FIG. 92 illustrates a block diagram of a system configuration for transferring funds via physical TITO tickets or virtual TITO tickets using system components for buy-in uses according to the embodiments of the present invention;

FIG. 93 illustrates a block diagram of a system configuration for transferring funds via physical TITO tickets or virtual TITO tickets using system components for buy-in uses according to the embodiments of the present invention;

FIG. 94 illustrates a block diagram of a system configuration for transferring funds via physical TITO tickets or virtual TITO tickets using system components for buy-in uses according to the embodiments of the present invention;

FIG. 95 illustrates a block diagram of a system configuration for transferring funds via physical TITO tickets or virtual TITO tickets using system components for buy-in uses according to the embodiments of the present invention;

FIG. 96 illustrates a block diagram of a system configuration for transferring funds via physical TITO tickets or virtual TITO tickets using system components for buy-in uses according to the embodiments of the present invention;

FIG. 97 illustrates a block diagram of a system configuration for transferring funds via physical TITO tickets or virtual TITO tickets using system components for buy-in uses according to the embodiments of the present invention;

FIG. 98 illustrates a block diagram of a system configuration for transferring funds via physical TITO tickets or virtual TITO tickets using system components for buy-in uses according to the embodiments of the present invention;

FIG. 99 illustrates a block diagram of a system configuration for transferring funds via physical TITO tickets or virtual TITO tickets using system components for buy-in uses according to the embodiments of the present invention;

FIG. 100 illustrates a block diagram of a system configuration for transferring funds via physical TITO tickets or virtual TITO tickets using system components for buy-in uses according to the embodiments of the present invention;

FIG. 101 illustrates a block diagram of a system configuration for transferring funds via physical TITO tickets or virtual TITO tickets using system components for buy-in uses according to the embodiments of the present invention;

FIG. 102 illustrates a block diagram of a system configuration for transferring funds via physical TITO tickets or virtual TITO tickets using system components for buy-in uses according to the embodiments of the present invention;

FIG. 103 illustrates a block diagram of a system configuration for transferring funds via physical TITO tickets or virtual TITO tickets using system components for buy-in uses according to the embodiments of the present invention;

FIG. 104 illustrates a block diagram of a system configuration for transferring funds via physical TITO tickets or virtual TITO tickets using system components for buy-in uses according to the embodiments of the present invention;

FIG. 105 illustrates a block diagram of a system configuration for transferring funds via physical TITO tickets or virtual TITO tickets using system components for buy-in uses according to the embodiments of the present invention;

FIG. 106 illustrates a block diagram of a system configuration for transferring funds via physical TITO tickets or virtual TITO tickets using system components for buy-in uses according to the embodiments of the present invention;

FIG. 107 illustrates a block diagram of a system configuration for transferring funds via physical TITO tickets or virtual TITO tickets using system components for buy-in uses according to the embodiments of the present invention;

FIG. 108 illustrates a block diagram of a system configuration for transferring funds via physical TITO tickets or virtual TITO tickets using system components for buy-in uses according to the embodiments of the present invention;

FIG. 109 illustrates a block diagram of a system configuration for transferring funds via physical TITO tickets or virtual TITO tickets using system components for buy-in uses according to the embodiments of the present invention;

Generally, and broadly, FIGS. 110-144 illustrate block diagrams of various buy-in processes according to the embodiments of the present invention.

FIG. 110 illustrates a block diagram of a buy-in process according to the embodiments of the present invention;

FIG. 111 illustrates a block diagram of a buy-in process according to the embodiments of the present invention;

FIG. 112 illustrates a block diagram of a buy-in process according to the embodiments of the present invention;

FIG. 113 illustrates a block diagram of a buy-in process according to the embodiments of the present invention;

FIG. 114 illustrates a block diagram of a buy-in process according to the embodiments of the present invention;

FIG. 115 illustrates a block diagram of a buy-in process according to the embodiments of the present invention;

FIG. 116 illustrates a block diagram of a buy-in process according to the embodiments of the present invention;

FIG. 117 illustrates a block diagram of a buy-in process according to the embodiments of the present invention;

FIG. 118 illustrates a block diagram of a buy-in process according to the embodiments of the present invention;

FIG. 119 illustrates a block diagram of a buy-in process according to the embodiments of the present invention;

FIG. 120 illustrates a block diagram of a buy-in process according to the embodiments of the present invention;

FIG. 121 illustrates a block diagram of a buy-in process according to the embodiments of the present invention;

FIG. 122 illustrates a block diagram of a buy-in process according to the embodiments of the present invention;

FIG. 123 illustrates a block diagram of a buy-in process according to the embodiments of the present invention;

FIG. 124 illustrates a block diagram of a buy-in process according to the embodiments of the present invention;

FIG. 125 illustrates a block diagram of a buy-in process according to the embodiments of the present invention;

FIG. 126 illustrates a block diagram of a buy-in process according to the embodiments of the present invention;

FIG. 127 illustrates a block diagram of a buy-in process according to the embodiments of the present invention;

FIG. 128 illustrates a block diagram of a buy-in process according to the embodiments of the present invention;

FIG. 129 illustrates a block diagram of a buy-in process according to the embodiments of the present invention;

FIG. 130 illustrates a block diagram of a buy-in process according to the embodiments of the present invention;

FIG. 131 illustrates a block diagram of a buy-in process according to the embodiments of the present invention;

FIG. 132 illustrates a block diagram of a buy-in process according to the embodiments of the present invention;

FIG. 133 illustrates a block diagram of a buy-in process according to the embodiments of the present invention;

FIG. 134 illustrates a block diagram of a buy-in process according to the embodiments of the present invention;

FIG. 135 illustrates a block diagram of a buy-in process according to the embodiments of the present invention;

FIG. 136 illustrates a block diagram of a buy-in process according to the embodiments of the present invention;

FIG. 137 illustrates a block diagram of a buy-in process according to the embodiments of the present invention;

FIG. 138 illustrates a block diagram of a buy-in process according to the embodiments of the present invention;

FIG. 139 illustrates a block diagram of a buy-in process according to the embodiments of the present invention;

FIG. 140 illustrates a block diagram of a buy-in process according to the embodiments of the present invention;

FIG. 141 illustrates a block diagram of a buy-in process according to the embodiments of the present invention;

FIG. 142 illustrates a block diagram of a buy-in process according to the embodiments of the present invention;

FIG. 143 illustrates a block diagram of a buy-in process according to the embodiments of the present invention;

FIG. 144 illustrates a block diagram of a buy-in process according to the embodiments of the present invention;

Generally, and broadly, FIGS. 145-165 illustrate block diagrams of various cash out use cases according to the embodiments of the present invention.

FIG. 145 a block diagram of a system configuration for cash out option cases according to the embodiments of the present invention;

FIG. 146 a block diagram of a system configuration for cash out option cases according to the embodiments of the present invention;

FIG. 147 a block diagram of a system configuration for cash out option cases according to the embodiments of the present invention;

FIG. 148 a block diagram of a system configuration for cash out option cases according to the embodiments of the present invention;

FIG. 149 a block diagram of a system configuration for cash out option cases according to the embodiments of the present invention;

FIG. 150 a block diagram of a system configuration for cash out option cases according to the embodiments of the present invention;

FIG. 151 a block diagram of a system configuration for cash out option cases according to the embodiments of the present invention;

FIG. 152 a block diagram of a system configuration for cash out option cases according to the embodiments of the present invention;

FIG. 153 a block diagram of a system configuration for cash out option cases according to the embodiments of the present invention;

FIG. 154 a block diagram of a system configuration for cash out option cases according to the embodiments of the present invention;

FIG. 155 a block diagram of a system configuration for cash out option cases according to the embodiments of the present invention;

FIG. 156 a block diagram of a system configuration for cash out option cases according to the embodiments of the present invention;

FIG. 157 a block diagram of a system configuration for cash out option cases according to the embodiments of the present invention;

FIG. 158 a block diagram of a system configuration for cash out option cases according to the embodiments of the present invention;

FIG. 159 a block diagram of a system configuration for cash out option cases according to the embodiments of the present invention;

FIG. 160 a block diagram of a system configuration for cash out option cases according to the embodiments of the present invention;

FIG. 161 a block diagram of a system configuration for cash out option cases according to the embodiments of the present invention;

FIG. 162 a block diagram of a system configuration for cash out option cases according to the embodiments of the present invention;

FIG. 163 a block diagram of a system configuration for cash out option cases according to the embodiments of the present invention;

FIG. 164 a block diagram of a system configuration for cash out option cases according to the embodiments of the present invention;

FIG. 165 a block diagram of a system configuration for cash out option cases according to the embodiments of the present invention;

Generally, and broadly, FIGS. 166-175 illustrate block diagrams of various fund transfer out systems according to the embodiments of the present invention.

FIG. 166 illustrates a block diagram of a system configuration for fund transfer out options according to the embodiments of the present invention;

FIG. 167 illustrates a block diagram of a system configuration for fund transfer out options according to the embodiments of the present invention;

FIG. 168 illustrates a block diagram of a system configuration for fund transfer out options according to the embodiments of the present invention;

FIG. 169 illustrates a block diagram of a system configuration for fund transfer out options according to the embodiments of the present invention;

FIG. 170 illustrates a block diagram of a system configuration for fund transfer out options according to the embodiments of the present invention;

FIG. 171 illustrates a block diagram of a system configuration for fund transfer out options according to the embodiments of the present invention;

FIG. 172 illustrates a block diagram of a system configuration for fund transfer out options according to the embodiments of the present invention;

FIG. 173 illustrates a block diagram of a system configuration for fund transfer out options according to the embodiments of the present invention;

FIG. 174 illustrates a block diagram of a system configuration for fund transfer out options according to the embodiments of the present invention;

FIG. 175 illustrates a block diagram of a system configuration for fund transfer out options according to the embodiments of the present invention;

Generally, and broadly, FIGS. 176-196 illustrate block diagrams of various cash out processes according to the embodiments of the present invention.

FIG. 176 illustrates a block diagram of a system configuration for fund cash out options according to the embodiments of the present invention;

FIG. 177 illustrates a block diagram of a system configuration for fund cash out options according to the embodiments of the present invention;

FIG. 178 illustrates a block diagram of a system configuration for fund cash out options according to the embodiments of the present invention;

FIG. 179 illustrates a block diagram of a system configuration for fund cash out options according to the embodiments of the present invention;

FIG. 180 illustrates a block diagram of a system configuration for fund cash out options according to the embodiments of the present invention;

FIG. 181 illustrates a block diagram of a system configuration for fund cash out options according to the embodiments of the present invention;

FIG. 182 illustrates a block diagram of a system configuration for fund cash out options according to the embodiments of the present invention;

FIG. 183 illustrates a block diagram of a system configuration for fund cash out options according to the embodiments of the present invention;

FIG. 184 illustrates a block diagram of a system configuration for fund cash out options according to the embodiments of the present invention;

FIG. 185 illustrates a block diagram of a system configuration for fund cash out options according to the embodiments of the present invention;

FIG. 186 illustrates a block diagram of a system configuration for fund cash out options according to the embodiments of the present invention;

FIG. 187 illustrates a block diagram of a system configuration for fund cash out options according to the embodiments of the present invention;

FIG. 188 illustrates a block diagram of a system configuration for fund cash out options according to the embodiments of the present invention;

FIG. 189 illustrates a block diagram of a system configuration for fund cash out options according to the embodiments of the present invention;

FIG. 190 illustrates a block diagram of a system configuration for fund cash out options according to the embodiments of the present invention;

FIG. 191 illustrates a block diagram of a system configuration for fund cash out options according to the embodiments of the present invention;

FIG. 192 illustrates a block diagram of a system configuration for fund cash out options according to the embodiments of the present invention;

FIG. 193 illustrates a block diagram of a system configuration for fund cash out options according to the embodiments of the present invention;

FIG. 194 illustrates a block diagram of a system configuration for fund cash out options according to the embodiments of the present invention;

FIG. 195 illustrates a block diagram of a system configuration for fund cash out options according to the embodiments of the present invention;

FIG. 196 illustrates a block diagram of a system configuration for fund cash out options according to the embodiments of the present invention; and

FIG. 197 illustrates a casino gaming table with multiple wireless interface units integrated therein according to the embodiments of the present invention.

Additionally, it should be understood that the proportions and dimensions (either relative or absolute) of the various features and elements (and collections and groupings thereof) and the boundaries, separations, and positional relationships presented therebetween, are provided in the accompanying Figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The embodiments described herein are generally, but not necessarily exclusively, directed to systems, devices, and methods to obtain, transfer, and apply funds for wagering within a casino or other gaming establishment. The systems, devices, and methods may allow for interaction(s) between a personal mobile electronic device of a user and various systems and equipment operated by the casino or gaming establishment or a third party.

Hereinafter, “casino” will refer to any establishment that operates casino table games at which a user may make wagers. Exemplary casino table games include blackjack, Let it Ride, 3 Card Poker, craps, roulette, etc.

Examples of user personal mobile electronic devices include cell phones, personal digital assistants (PDA), tablet or laptop computers, smart cards, smart watches, smart key chains, devices with an implantable smart chip, and the like. Hereinafter, such personal mobile electronic devices will be referred to as “mobile devices.” Mobile devices may implement or otherwise execute or access various mobile wallet applications, which a user may operate to make or receive payments, transfer funds, or other financial transactions, such as with equipment, devices, or systems of the casino. More specific details on such devices and their operations are described in greater detail below.

Examples of the various systems, devices, and equipment operated by a casino in conjunction with an electronic gaming device include bank note or bill acceptor/validators (or “bill validators”), gaming ticket receivers/printers, kiosks at which a user may obtain gaming credit (hereinafter, “credit”) or funds for wagering, routers, and antennas to provide wireless communications (such as Wi-Fi®, Bluetooth, radio frequency identification technologies, near field communication technologies, or other technologies), internet connection servers and systems, casino accounting services, and other systems and equipment. Such systems, devices, and equipment may be based in hardware or software. Such systems, devices, and equipment may be implemented, either in hardware or software, to provide secure transactions with the mobile device. Specific devices, methods, and systems operated by the casino are described in greater detail below.

Some embodiments include systems, devices, and methods by which funds (such as credit or cash value) may be added to a mobile wallet application on a user's mobile device. In these embodiments: funds may be added or deposited into a mobile wallet at a casino's kiosk; funds may be added or deposited into a mobile wallet using an in-app bank token; funds may be deposited into a mobile wallet directly without additional systems; and funds may be deposited into a mobile wallet through bill validators using cash (bills) or gaming tickets. The funds may be obtained by communications with a bank or other financial institution having an account of the user. Variations on these embodiments are described in greater detail below.

Some embodiments include systems, devices, and methods by which funds on a mobile wallet application on a user's mobile device may be applied as a credit to a casino table game system by bump transferring, such as by use of near field communication. In one category of embodiments, a user's mobile device may be used to have a physical gaming ticket printed from a virtual gaming ticket stored on the user's mobile device. In a second category, a physical gaming ticket is printed based on electronic credit. In a third category, a bump transfer occurs at a casino kiosk to print a physical gaming ticket. In a fourth category, a cash out of a user's mobile wallet may be performed at a casino's cage. In a fifth category, credit to a casino table game system may be obtained from a previously created virtual gaming ticket by use of a simulated gaming ticket transaction at a bill validator. In a sixth category, credit to a casino table game system may be obtained from a newly created virtual gaming ticket by use of a simulated gaming ticket transaction at a bill validator. In a seventh category, credit to a casino table game system may be obtained from an electronic credit on the user's mobile wallet by using a newly created gaming ticket number as part of a simulated gaming ticket transaction at a bill validator. In an eighth category, credit to a casino table game system may be obtained from an electronic credit using a simulated bill validator bill transaction. In a ninth category, credit to a casino table game system may be obtained using Automated Funds Transfer methods.

Some embodiments include systems, devices, and methods by which funds may be applied to a casino table game system through service between a casino table game system and a Ticket-In/Ticket-Out service. In a first category, credit to a casino table game system may be obtained by a Peripheral System interacting with the user's mobile device, such as through wireless networks. In a second category, credit to a casino table game system may be obtained by redemption of a gaming ticket from a user's mobile wallet interacting with the Peripheral System. In a third category, credit to a casino table game system may be obtained by redemption of a gaming ticket from a user's mobile wallet interacting with a Ticket-In/Ticket-Out Translation service. In a fourth category, credit to a casino table game system may be obtained by a funds transfer from a user's mobile wallet interacting with the Peripheral System, such as over a wireless network. In a fifth category, a credit to a casino table game system may be obtained by a funds transfer from a user's bank or other financial account interacting with the Peripheral System. In a sixth category, credit to a casino table game system may be obtained by the Peripheral System indicating how much to credit table game system. In a seventh category, credit to a casino table game system may be obtained using a separate Ticket-In/Ticket-Out service for mobile transactions.

Some embodiments include systems, devices, and methods by which funds or credits may be redeemed, refunded, or obtained from a casino table game system and applied to a user's mobile wallet. In a first category, a physical gaming ticket may be scanned, and the credit deposited into a user's mobile wallet. In a second category, redemption may occur at a casino's cage into a user's mobile wallet. In a third category, an Automated Funds Transfer may use a bump transfer to redeem credit from the casino table game system to the user's mobile wallet using a wireless network. In a fourth category, a bump transfer may redeem credit from the casino table game system to the user's mobile wallet using a wireless network using a virtual printer transaction. In a fifth category, a bump transfer may redeem credit from the casino table game system by communication over a wireless network from the casino table game system to a casino management system (CMS). In a sixth category, a bump transfer may cause the casino table game system to transfer credit using a Peripheral System in communication with a CMS. In a seventh category, a delay in printing a cash out ticket may be implemented to allow a user to perform a bump transfer from the casino table game system to a mobile wallet. In an eighth category, a mobile wallet that is or was used for adding credit to a casino table game system may be used for cash out operations. In a ninth category, the casino table game system has a cash out capability to allow applying credit to a mobile wallet application.

Some embodiments include systems, devices, and methods by which a user may transfer funds or value on a mobile wallet to external funds (such as bank or other financial accounts). In a first category, a user's mobile device may cause printing of virtual gaming tickets at a casino cage. In a second category, funds on a mobile wallet may be transferred using capabilities at a casino kiosk. In a third category, a user is able to transfer funds directly to a bank account (or other financial account) using capabilities of a mobile wallet application. In a fourth category, a user is able to transfer funds to a bank account (or other financial account) using capabilities at a casino cage. In a fifth category, a mobile wallet app is used in conjunction with a casino cage to obtain cash (currency, coins).

For convenient reference, a list of acronyms used herein is provided below:
BV Bill Validator
CMS Casino Management System
NFC Near Field Communication
PNA Peripheral Network Adapter
RFID Radio Frequency Identification
TITO Ticket-In/Ticket-Out

The systems, methods, and devices described herein make use of a set of similar—but not necessarily identical—components. As used herein, the term “system” can also be used to refer to subsystems that may be used within other systems. As used herein, “component” will refer to a system, whether implemented in hardware or software, a subsystem, a device performing a certain operation, or a method of operation. Operations performed by the systems, methods, and devices may be performed using one or more processing units.

As used herein, a “processing unit” will refer to any of a processor, microprocessor, microcontroller, application specific integrated circuit and related circuitry, or other operational elements as would be known to one skilled in the art. Also encompassed by the term “component” are digital and analog communication elements, circuits, or devices, such as may be operable to send and/or receive signals or messages over a variety of communication channels. Such channels include, but are not limited to, fiber optic links, coax or twisted pair cable, other forms of wired connections, wireless connections such as Bluetooth, Wi-Fi®, cellular communication networks, various near field communication links, and the like.

Described below are components to be used in subsequent block diagrams of the systems, methods, and devices that may be used in various embodiments disclosed herein. It is not implied that all such components are included in each embodiment, nor that the embodiments are limited to these components or devices. Less commonly used components may be described in relation to particular subsequent Figures. Similarly named components in the Figures may be similar in structure and/or operation, but may have differences; it is not implied they are identical devices.

A first such component is a user's mobile device, which is identified in Figures provided herewith as the mobile device 110. A mobile device may be a mobile phone, a smart card, a smart watch, a laptop or tablet computer, a smart key chain, a personal digital assistant, or another user device. The mobile device may include any of various electromagnetic communication technologies. These electromagnetic communication technologies include, but are not limited to, Bluetooth or Bluetooth Low Energy, infrared or other optical technologies, Wi-Fi®, NFC bump, cellular technologies including, but not limited to CDMA, EDGE, 2G, 3G, 4G, 4G-LTE, or 5G, or other electromagnetic communication technologies. A mobile device 110 may also be able to display a code (e.g., bar code, alphanumeric code, QR code, or other code format) that the user may then manually enter into another device or component.

Another such component is the casino table game (“CTG”), which is identified in the Figures provided herewith as the CTG. An CTG may be any type of casino table game including those incorporating electronic user interfaces, live or virtual dealers, etc. A plurality of casino table games may be communicatively linked to create a casino table game system (CTG System 150). A CTG is often operated by a live dealer that exchanges cash for gaming chips. The gaming chips may then be used to place wagers at the CTG.

In the embodiments disclosed in relation to the Figures below, the described CTG may not be shown explicitly, but in such cases is assumed to be communicatively linked with a Player Interface Device as described below. The communication link between the Player Interface Device and the CTG may be a wired or wireless communication link.

A mobile device may interact, communicate, or interface with a CTG through any of various components, referred to as Player Interface Devices. These include, but are not limited to, a near field communication device or other device integrated into the CTG (such as in a tabletop of the CTG), a bill validator as described below, a bill validator having a bezel containing communication technologies (NFC, optical code readers, or other technologies), a TITO System as described below, a card (credit card, debit card, specialty card, etc.) reader, or another type of component.

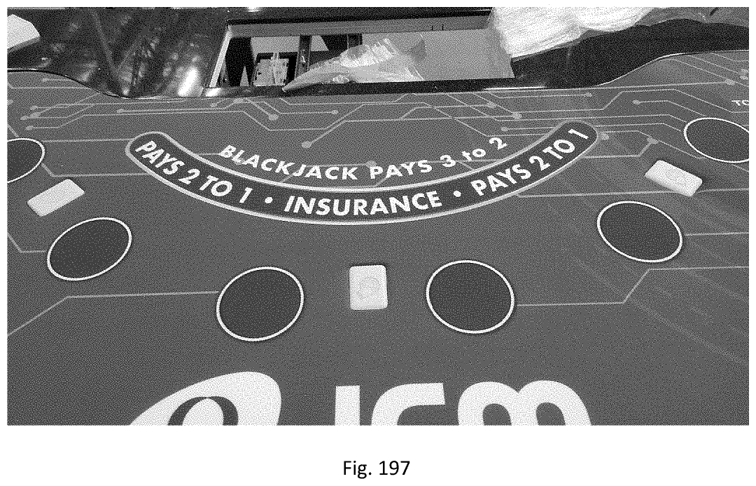

In one embodiment the Player Interface Device is installed (see FIG. 197) on, in, or near the CTG allowing a player to interface with the CTG System for purposes of transferring credits or tickets to or from the CTG System.

Another such component is a mobile wallet, which is identified in Figures provided herewith as the mobile wallet 114 (i.e., player wallet system). A mobile wallet may be implemented as a software program configured to run on a user's mobile device. The mobile wallet may also be implemented, in whole or in part, in hardware, such as with an RFID system, as a readable chip, or other technologies implemented on or in conjunction with the user's mobile device. The Player Wallet System is a service or system available inside or outside the casino network that stores player credit in the form of a monetary amount and/or in the form of one of more TITO tickets.

Additionally and/or alternatively, a mobile wallet may be a separate service, such as PayPal®, with which a user's mobile device communicates, such as by cellular telephone service, Wi-Fi®, or another technology. A user's mobile device may communicate with a server of such a separate mobile wallet by any of a variety of methods. Such methods may include, but are not limited to, stages in which the mobile device repeatedly polls the server for updates after initiating a transaction, the mobile device polls the server and waits for a response, the server may push-notify the mobile device any time there are changes in the data in the mobile wallet, and the server may notify the mobile device by email.

Another such component may be the kiosk, which is identified in Figures provided herewith as the kiosk. A kiosk is a device or system operated by a casino, often on a gaming floor of the casino, as a convenience for users. Often, though not necessarily, these are implemented as self-service machines, analogous to banking automated teller machines. A kiosk can provide various services and operations for users, such as printing of gaming tickets, transfer of funds to or from a mobile wallet, and other operations as detailed below.

Another such component may be a bill validator (BV), which is identified in Figures provided herewith as the bill validator 118. A BV is a device that may accept cash (e.g., currency, coin) and work, by itself or in conjunction with other devices or systems, to make the accepted cash available to the user in another form, such as funds on a user's mobile wallet, a printed gaming ticket, or other form. The BV may be a component associated with an individual CTG or CTG System 150. The BV may perform detection for counterfeit cash. The BV may work in conjunction, such as by various communication technologies, with the other components and systems described herein. A BV may perform other operations as well. A BV, or some of its components and/or subsystems, may be included, in whole or in part, as part of or within an CTG or CTG System 150. The BV may be configured to accept physical or virtual TITO tickets.

Another such component is the Ticket-In-Ticket-Out (TITO) system, which is identified in Figures provided herewith as the TITO System 120. A TITO System is a device or service, implemented either in software or hardware, operable to accept a printed gaming ticket and apply a corresponding credit to an electronic gaming machine, a user's mobile wallet, or communicate the credit to another component. The TITO System may also be operable to print a physical gaming ticket with a record of the credit (such as a ticket with a bar code, QR code, or the like). A TITO System may also be able to implement a virtual gaming ticket, with a value or credit that may be stored or recorded in a user's mobile wallet, or communicated or transferred to another component, such as a CTG or CTG System. A gaming ticket, whether physical or virtual, will also be referred to herein as a “TITO ticket,” a “TITO,” or simply “ticket.” A TITO System, or some of its components and/or subsystems, may be included, in whole or in part, as part of or within a CTG or CTG System.

Another such component may be a TITO Gateway, which is identified in Figures provided herewith as the TITO Gateway 122. The TITO Gateway may be a third-party device or service, implemented either in software or hardware, that operates with a TITO System and a Peripheral System (described below) to facilitate creation, validation, and invalidation of TITO tickets. A TITO Gateway, or some of its components and/or subsystems, may be included, in whole or in part, as part of or within a CTG or CTG System.

Another such component may be a TITO Translation Service, which is identified in Figures provided herewith as the TITO Translation Service 124. A TITO Translation Service may be a device or service, implemented either in software or hardware, which makes or allows for communications between a CTG or CTG System and a TITO System. A TITO Translation Service, or some of its components and/or subsystems, may be included, in whole or in part, as part of or within a CTG or CTG System.

Another such component may be a printer, which is identified in Figures provided herewith as the Printer 128. A printer, such as may be a component of a CTG or CTG System, TITO System 120, or may be a separate component. The printer may be operable to print a physical gaming ticket, a receipt, or other physical document as part of the systems and methods described herein. A printer, or some of its components and/or subsystems, may be included, in whole or in part, as part of or within a CTG or CTG System. The Printer 128 may be configured to create and send virtual tickets, receipts, or other documents in addition to physical ones.

Another such component may be the Peripheral System, which is identified in Figures provided herewith as the Peripheral System 130. A Peripheral System is a service or system that may work with or within a casino network (such as the casino management system (CMS) 136 described below). The Peripheral System 130 may assist and/or interface between various peripheral components of a CMS 136, such as the components described herein. A Peripheral System, or some of its components and/or subsystems, may be included, in whole or in part, as part of or within a CTG or CTG System.

Another such component may be the Peripheral Network Adapter (PNA), which is identified in Figures provided herewith as the PNA 142. The PNA may connect to one or more peripheral components and a network (e.g., casino management system (CMS)), described below, allowing those peripherals to be part of the system and enable operations such as transferring credit to or from the CTG System. Such components include the components described herein. Alternatively, the PNA may be a component within any of the components described herein. A PNA, or some of its components and/or subsystems, may be included, in whole or in part, as part of or within a CTG or CTG System. The PNA can be two separate devices (a Wireless Interface and a Peripheral Network Adapter (PNA) or a single device that integrates the functionality of both the wireless interface and the PNA. While the PNA may be its own device, it may also be part of another component such as a bill validator, ticket printer, player interface device, etc.

Another such component may be the Player Interface Device, which is identified in Figures provided herewith as the Player Interface Device 134. A Player Interface Device will refer herein, as stated previously, to any device connected with the casino table game system or individual table games with which a user may interact, such as with a mobile device. A Player Interface Device can refer to, among other devices, a bill validator, a bill validator having a bezel containing communication technologies (NFC, optical code readers, or other technologies), a TITO System as described above, a card (credit card, debit card, specialty card, etc.) reader, or another type of component. A Player Interface Device, or some of its components and/or subsystems, may be included, in whole or in part, as part of or within a CTG or CTG System.

Another such component may be a Casino Management System (CMS), which is identified in Figures provided herewith as the CMS 136. A CMS may be a network service or system used within a casino to link some or all of the components listed above. One role of the CMS is to keep careful accounting of all payments, in whatever form, whether received or disbursed.

As used herein, “bank” may refer to any financial institution with which a user is affiliated. Examples of such financial institutions include, but are not limited to, banks, credit unions, online credit services, and credit card companies. In the following Figures, a bank is identified in Figures provided herewith as the Bank 138. Hereinafter, a “bank account” will refer to a user accessible financial account at any such financial institution from which funds or credit may be obtained, or to which funds or credit can be deposited.

A cage is a location in a casino, usually manned by a cashier of the casino, at which a user may obtain cash, such as by redemption or refund of gaming tickets (whether virtual or physical), casino chips, exchange of currency, or other records or sources of funds or credit. In the following Figures, a cage will be identified in Figures provided herewith as the cage 140.

Other components may be described in the descriptions of the following Figures.

Applicant incorporates by reference for all purposes co-pending U.S. patent application Ser. Nos. 16/823,677 and 16/994,879 owned by Applicant and which detail mobile wallets.

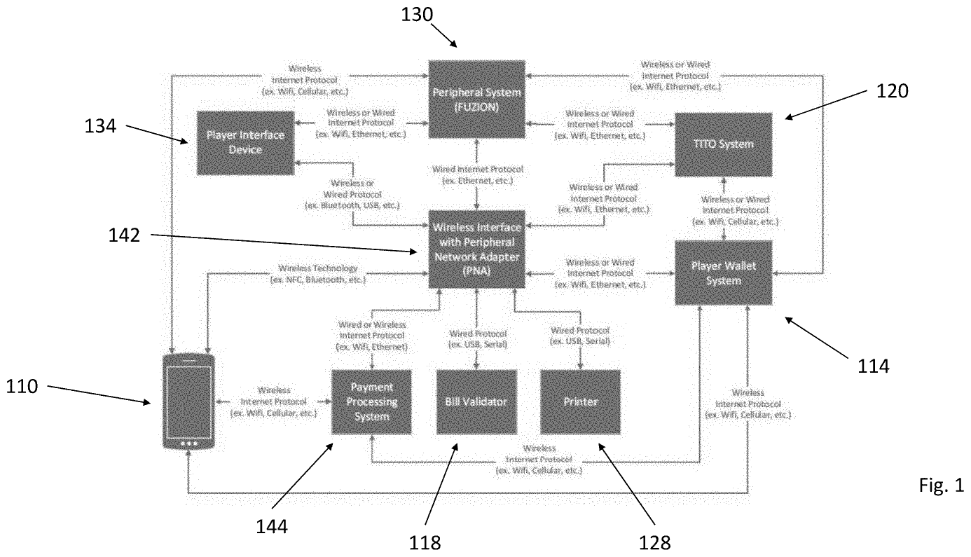

FIG. 1 shows a system schematic illustrating exemplary possible interconnections of system components including the mobile device 110, mobile wallet system 114, bill validator 118, TITO System 120, printer 128, Peripheral System 130, player interface device 134 and a wireless interface with peripheral network adapter 142 and a payment processing system 144. Some of the interconnections shown may not be required to undertake the processes described herein. Nor are the interconnections shown exhaustive.

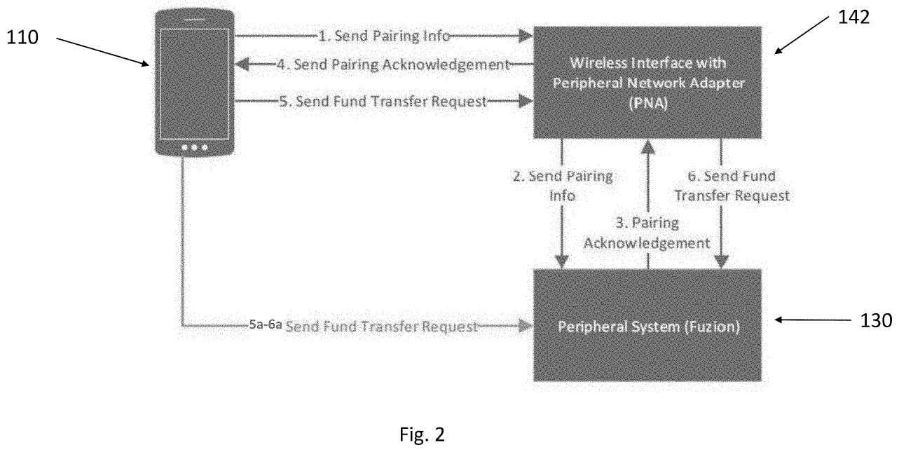

FIG. 2 shows processes for establishing communications between the mobile device 110 and Peripheral System 130. Steps 1-4 represent the pairing process between the mobile device 110 and the wireless interface with peripheral network adapter 142. Steps 5 and 6 show an instance where data pass through the wireless interface with peripheral network adapter 142, and steps 5a and 6a show an instance where the data pass directly to the Peripheral System 130. Communications between the mobile device 110 and the peripheral network system 130 via the wireless interface with peripheral network adapter 142 are considered more secure than direct cellular or WiFi communications.

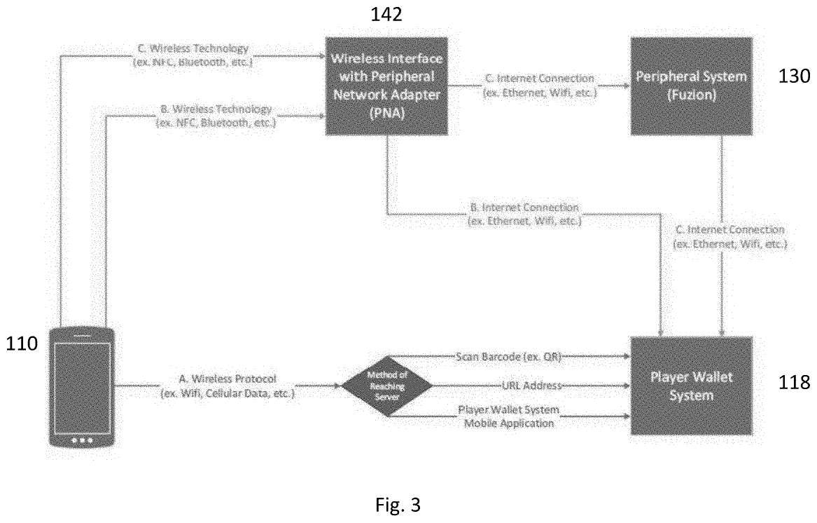

FIG. 3 shows processes for establishing communications between the mobile device 110 and the mobile wallet system 114. As shown, the mobile device 110 may connect to the Player Wallet System 114 (i) by scanning a bar code; entering a URL or using a mobile application then connecting via a wireless protocol such as WiFi; (ii) via the wireless interface with peripheral network adapter 142 or (iii) through the wireless interface with peripheral network adapter 142 via the Peripheral System 130.

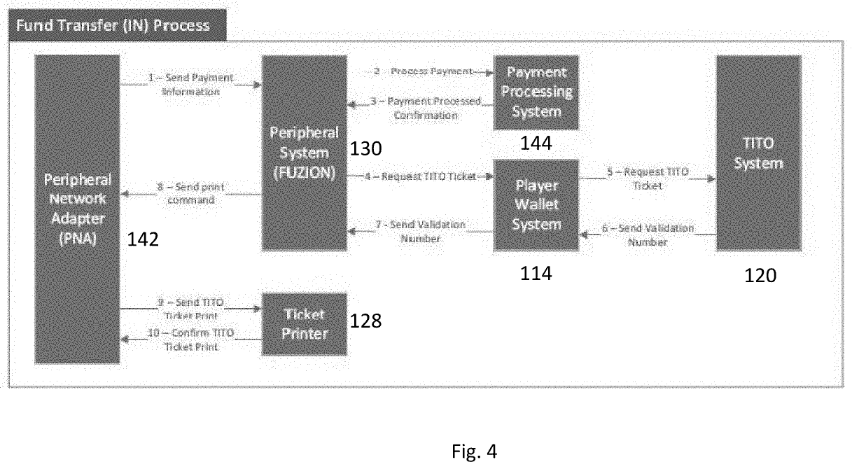

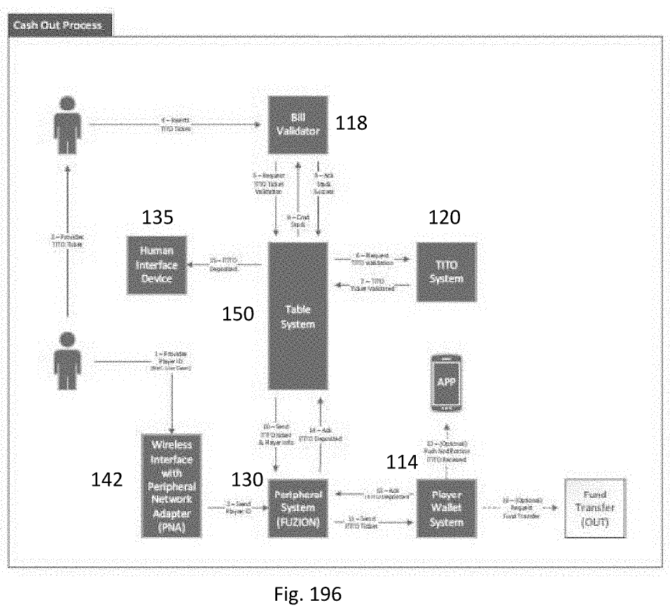

Generally, and broadly, FIGS. 4-196 illustrate block diagrams of various funding configurations according to the embodiments of the present invention. Those skilled in the art will readily appreciate that the detailed description given herein with respect to these Figures is for explanatory purposes only and should not be construed as limiting. Many of the embodiments in each section are straightforward variations of others in the corresponding section, and unnecessary repetition of their components and operations will be reduced.

Some of FIGS. 4-196 shows enumerated sequences of steps or operations, such as the direction of flow of signals or information, or passing to a next stage in a method. It is not implied that the various operations necessarily must be performed in the enumerated sequence. Further, it is also not implied that a sequential pair of ‘back and forth’ steps or communications necessarily involves only one communication in each direction. As an example, a transmission over a communication channel may not be received correctly (as determined by error detection) and an automatic repeat request signal may be transmitted.

### Funding Options

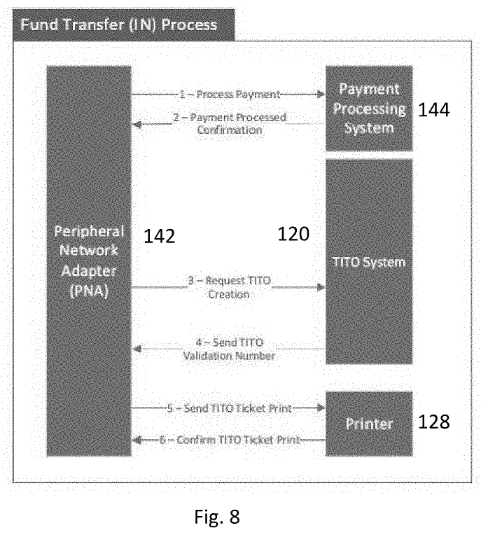

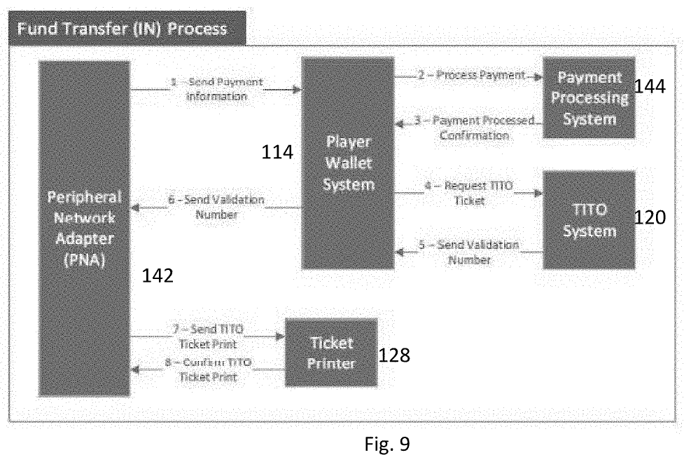

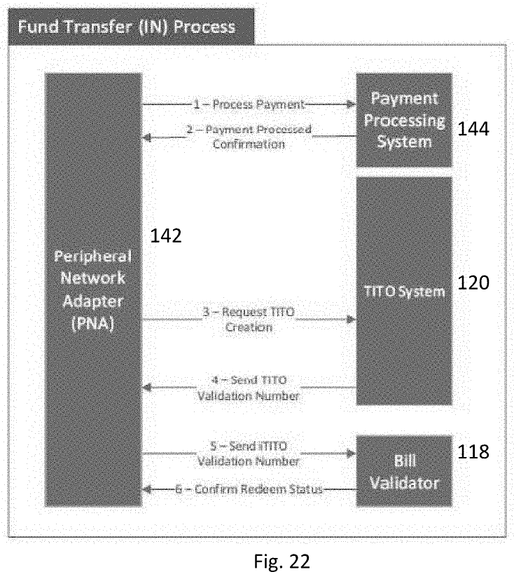

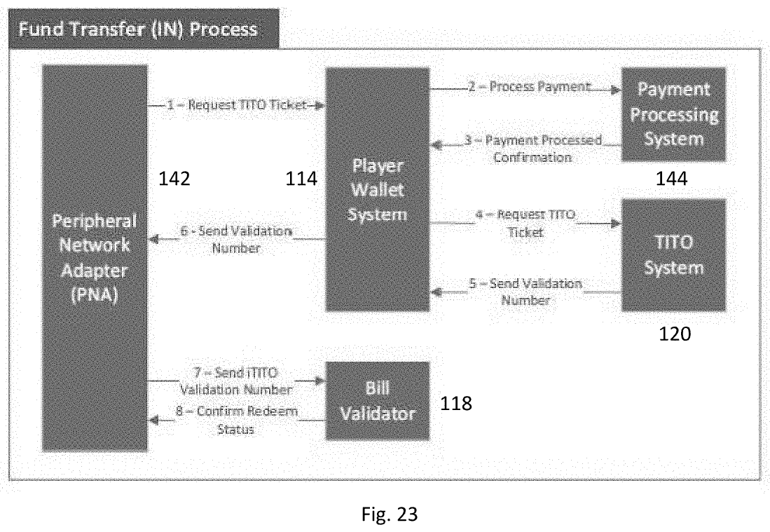

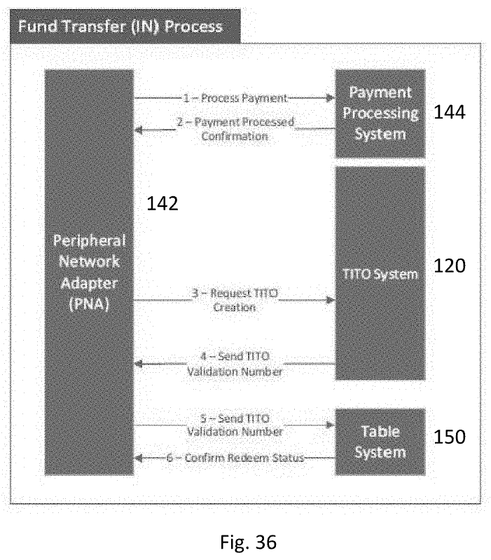

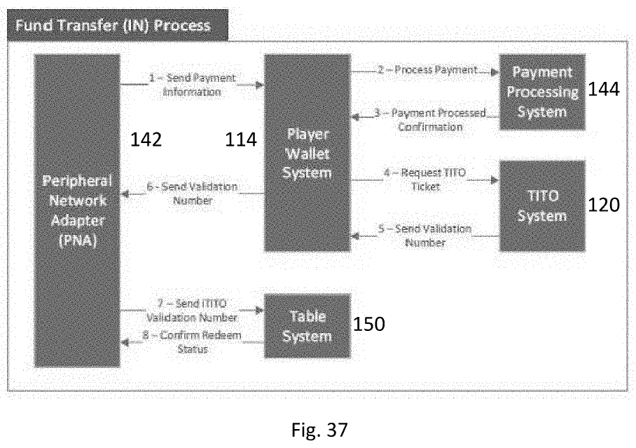

FIGS. 4-46 show system configurations for transferring funds via physical TITO tickets or virtual TITO tickets using system components.

FIGS. 4-17 show enumerated sequences of steps or operations involving a printed TITO ticket for funding wagers at a CTG.

FIGS. 4-9 show systems utilizing the wireless interface with peripheral network adapter (PNA) 142. As shown, the PNA 142 communicates with one or more of the Peripheral System 130, payment processing system 144 and Player Wallet System 114.

FIG. 4 shows a system where the payment information passes through the PNA 142 to the Peripheral System 130 and then to the payment processing system 144. Once the payment has been processed, and the funds have been deducted, the PNA 142 causes a TITO ticket to be printed using the printer 128.

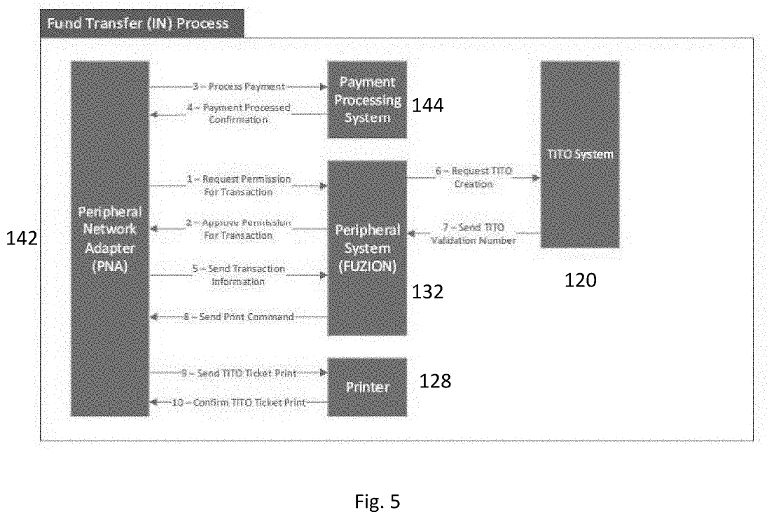

FIG. 5 shows a system where the payment information passes through the PNA 142 directly to the payment processing system 144. Once the payment has been processed, and the funds have been deducted, the PNA 142 causes a TITO ticket to be printed using the printer 128.

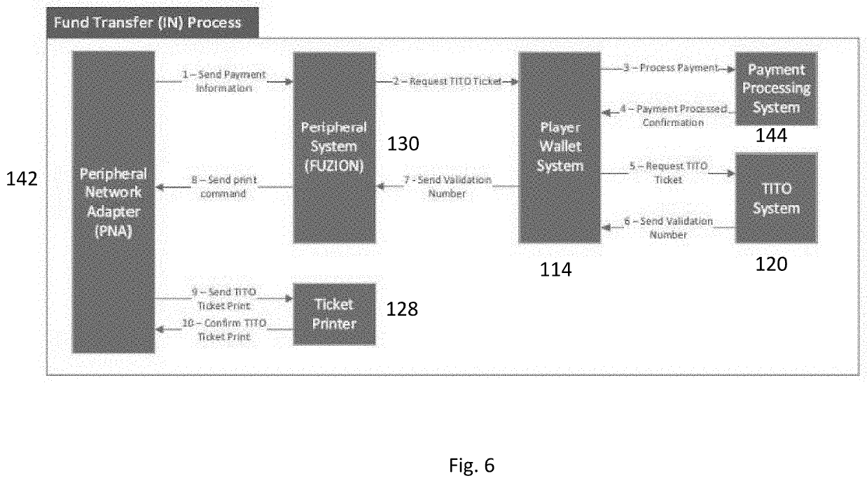

FIG. 6 shows a system where the Player Wallet System 118 is used in place of a card payment of mobile payment. Once the payment has been processed, and the funds have been deducted, the PNA 142 causes a TITO ticket to be printed using the printer 128.

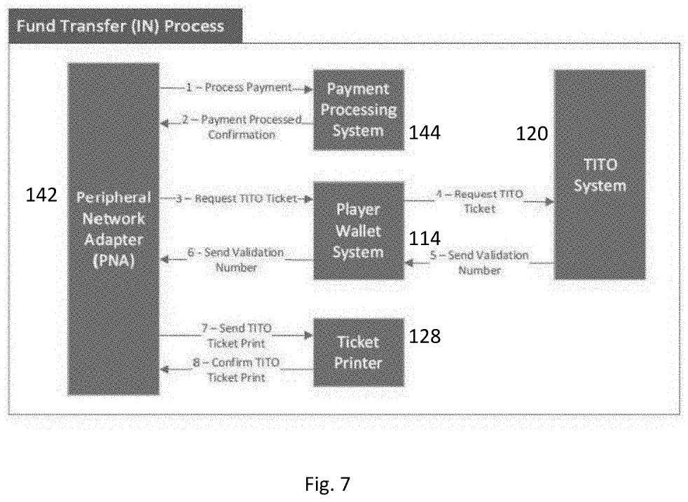

FIGS. 7-9 show systems from FIGS. 4-6 without the Peripheral System 130. As shown, the PNA 142 communicates with one or more of the payment processing system 144, Player Wallet System 114 and TITO System 120.

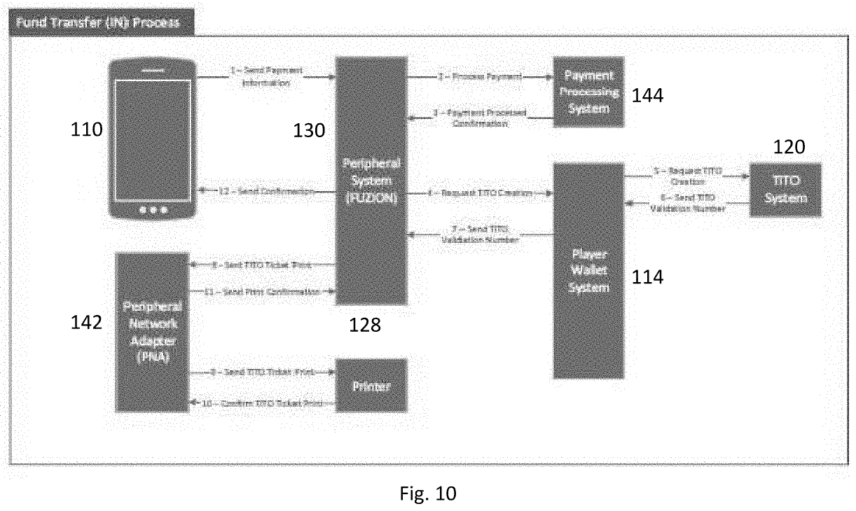

FIGS. 10-17 show systems utilizing the mobile device 110 to perform the funding transaction. As shown, the mobile device 110 communicates with one or more of the Peripheral System 130 Player Wallet System 118.

FIG. 10 shows the payment information processed through the Peripheral System 130 to the payment processing system 144. After the payment has been processed and the funds have been deducted, the PNA 142 causes physical TITO ticket to be printed using the printer 128.

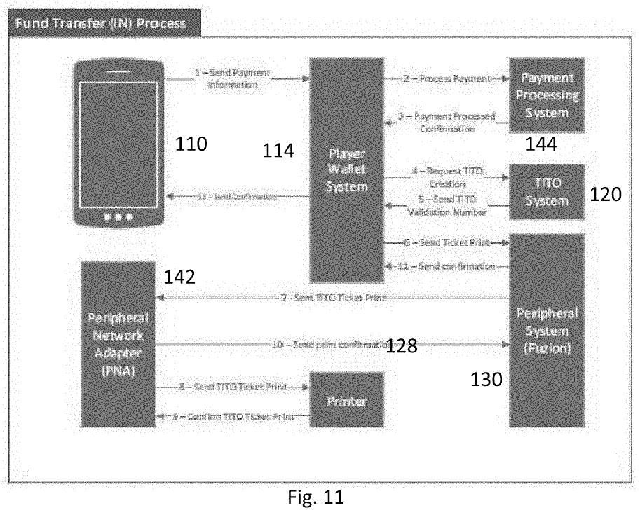

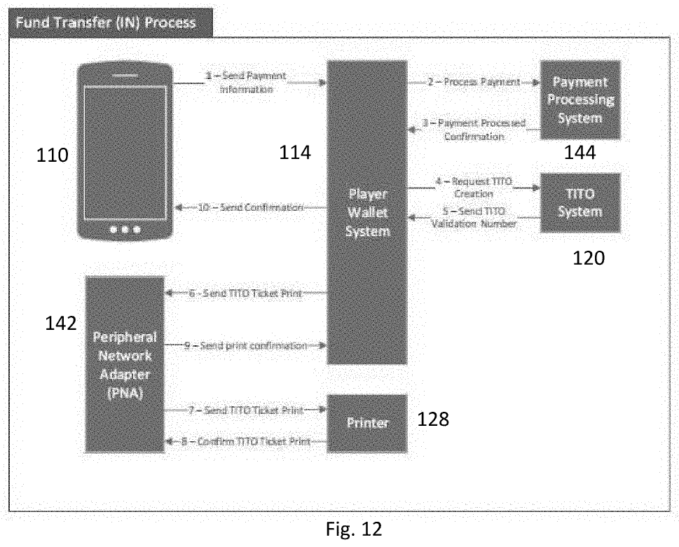

FIG. 11 shows the payment information processed through the Player Wallet System 118 to the payment processing system 144 along with the Peripheral System 130. After the payment has been processed and the funds have been deducted, the PNA 142 causes physical TITO ticket to be printed using the printer 128. FIG. 12 shows the same configuration as FIG. 11 without the inclusion of the Peripheral System 130.

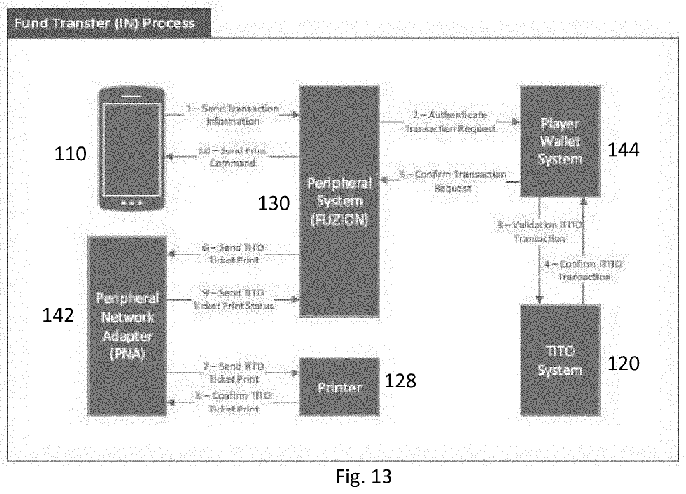

FIGS. 13-17 show configurations wherein virtual TITO tickets in a user's Player Wallet System and processed through one or more of the following Peripheral System 130, PNA 142 and mobile wallet system 114.

FIG. 13 shows the transaction information is passed through the Peripheral System 130 so that the Peripheral System 130 may verify the virtual TITO ticket information with the mobile wallet system 114. Once the virtual TITO ticket is verified, the PNA 142 causes a physical TITO ticket to be printed by the printer 128.

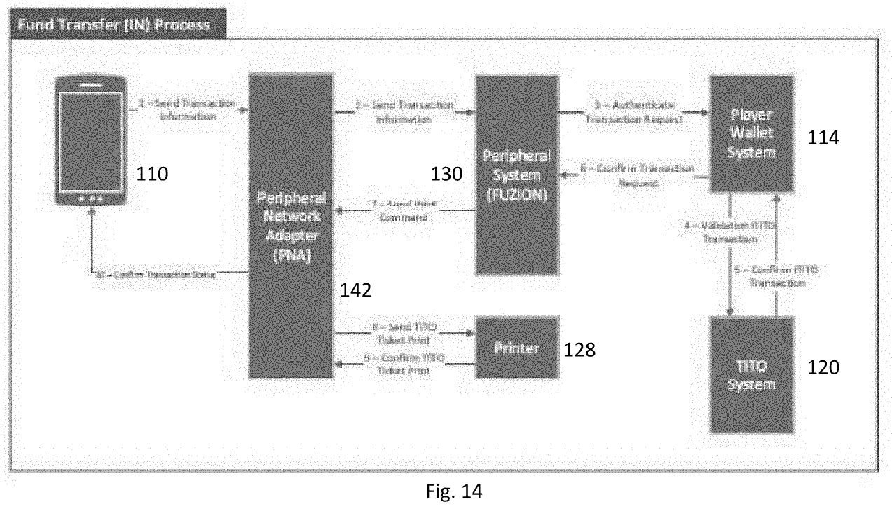

FIG. 14 shows the transaction information being sent by the mobile device 110 through the PNA 142. The PNA passes the transaction information to the Peripheral System 130. The Peripheral System 130 then verifies the virtual TITO ticket information with the mobile wallet system 114. Once the virtual TITO ticket is verified, the PNA causes a physical TITO ticket to be printed by the printer 128.

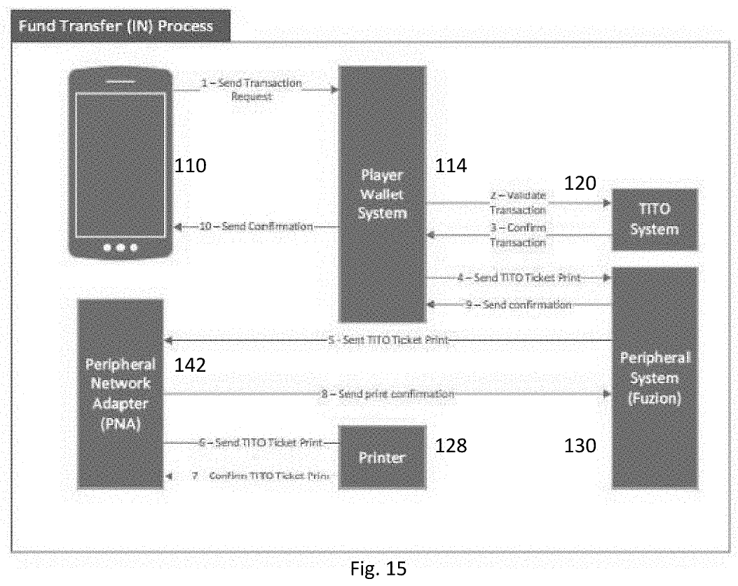

FIG. 15 shows mobile device 110 communicating directly with the Player Wallet System 118. The mobile wallet system 118 verifies the virtual TITO ticket information. Once the virtual TITO ticket information is verified, the PNA 142 causes a physical TITO ticket to be printed by the printer 128.

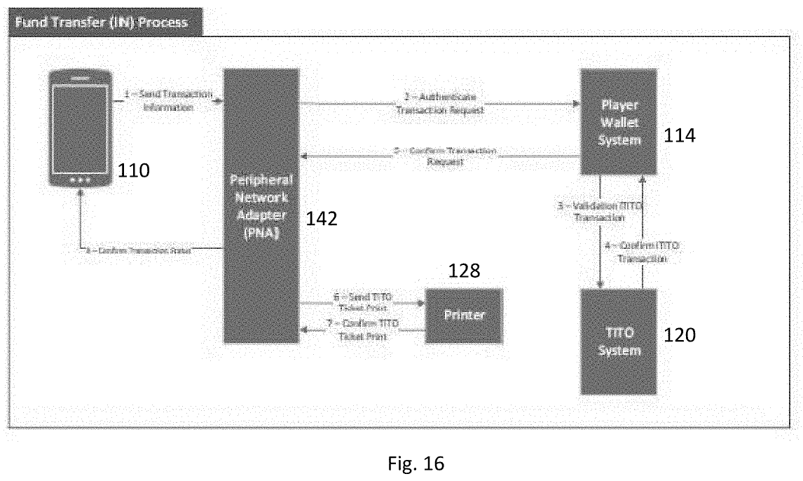

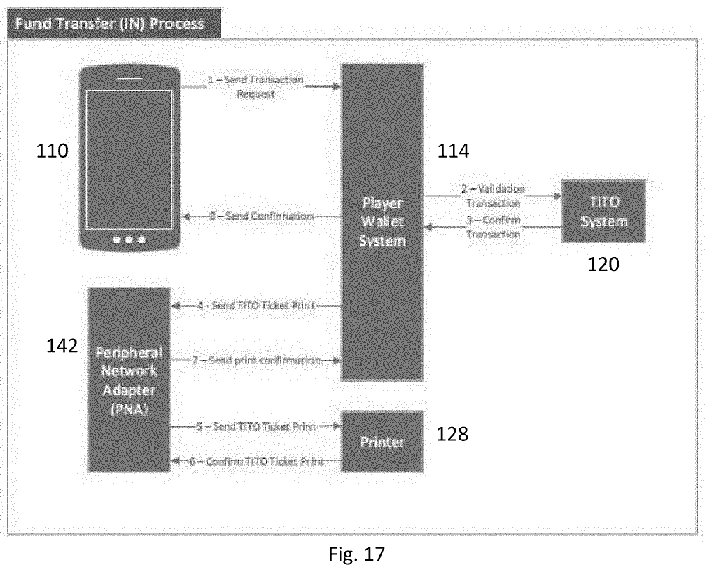

FIGS. 16 and 17 show configurations without the inclusion of the Peripheral System 130 wherein the various components and the PNA 142 communicate directly with one another to complete the process.

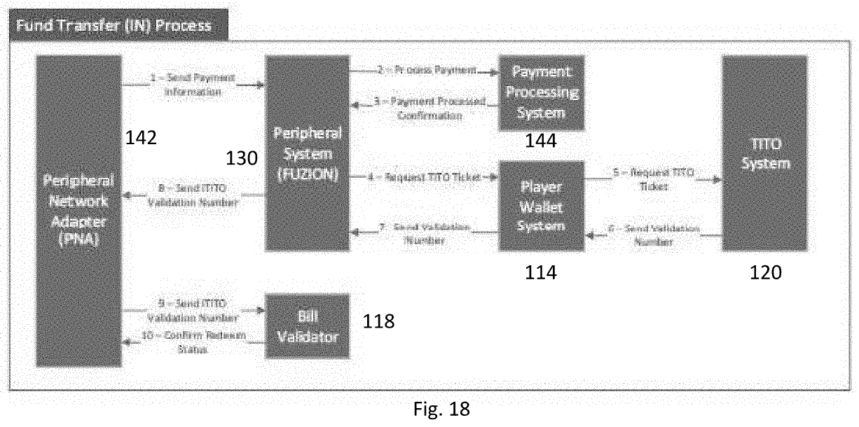

FIGS. 18-31 show enumerated sequences of steps or operations involving a bill validator 118 for funding wagers at a CTG. In these configurations, the virtual TITO tickets are processed by the bill validator 118.

FIG. 18 shows a configuration where the payment information passes from the PNA 142 to the Peripheral System 130 and then to the payment processing system 144. After the payment has been processed and the funds have been deducted, a virtual TITO ticket validation number is sent to the bill validator 118 through the PNA 142 for redemption.

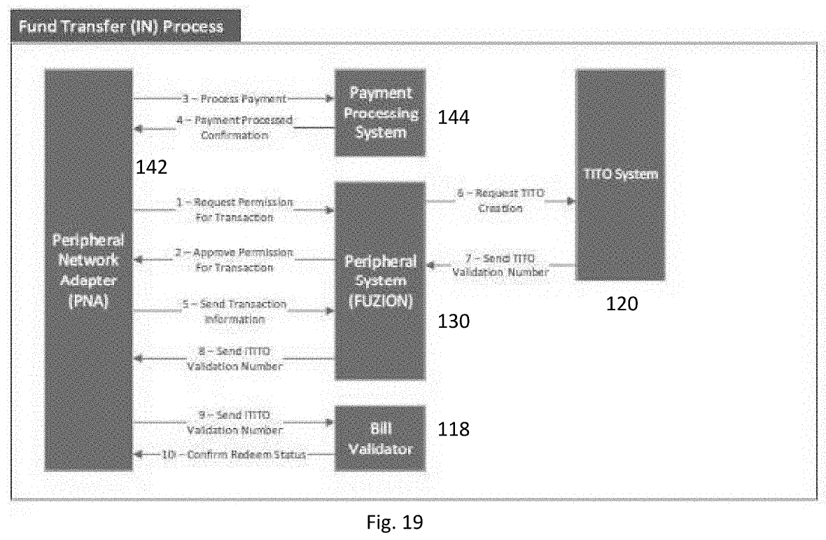

FIG. 19 shows a configuration where the payment information passes from the PNA 142 directly to the payment processing system 144. After the payment has been processed and the funds have been deducted, a virtual TITO ticket validation number is sent to the bill validator 118 through the PNA 142 for redemption.

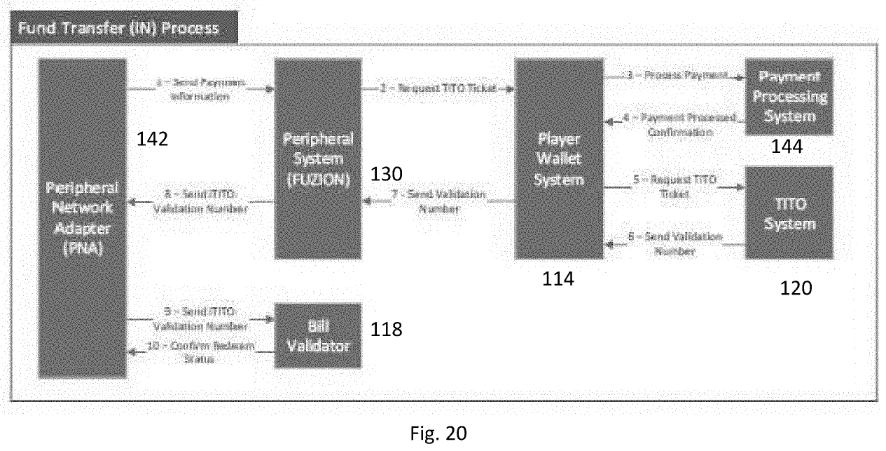

FIG. 20 shows a configuration where the mobile wallet system 114 is used instead of a card payment or mobile payment. After the payment has been processed and the funds have been deducted, a virtual TITO ticket validation number is sent to the bill validator 118 through the PNA 142 for redemption.

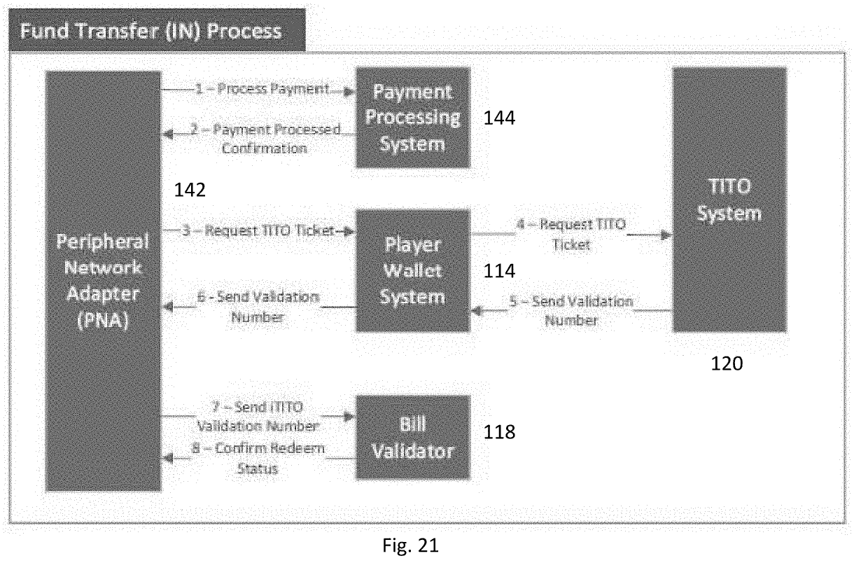

FIGS. 21-23 show configurations without the Peripheral System 130. In these embodiments, the PNA 142 connects directly to various system components to process the transactions.

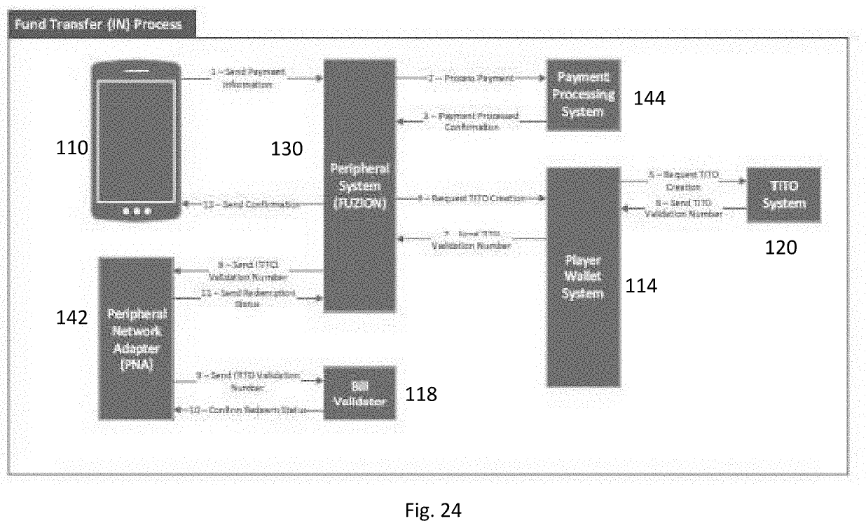

FIG. 24 show a configuration where payment information is processed using the mobile device 110 through the Peripheral System 130 to the payment processing system 144. After the payment has been processed and the funds have been deducted, a virtual TITO ticket validation number is sent to the bill validator 118 through the PNA 142 for redemption.

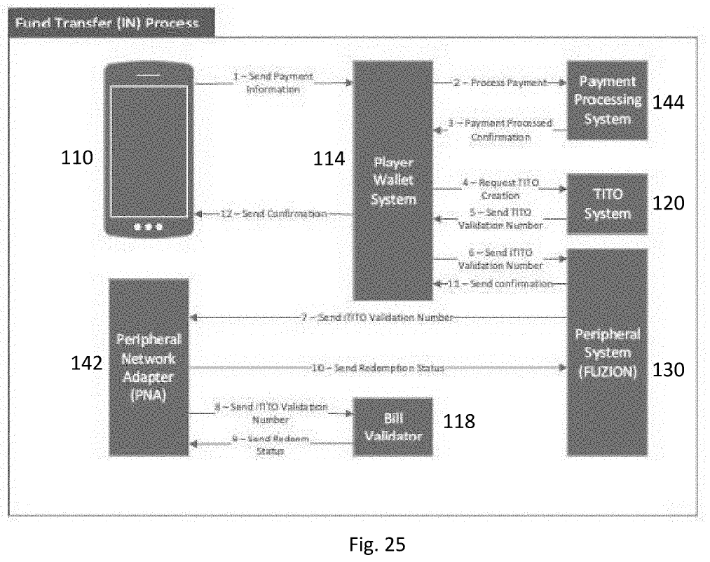

FIG. 25 shows a configuration where the payment information is processed using the mobile device 110 through the Player Wallet System 114. After the payment has been processed and the funds have been deducted, a virtual TITO ticket validation number is sent to the bill validator 118 through the PNA 142 for redemption.

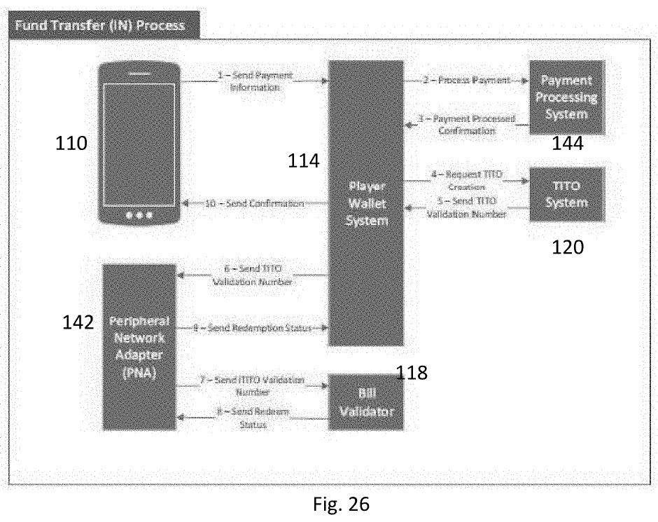

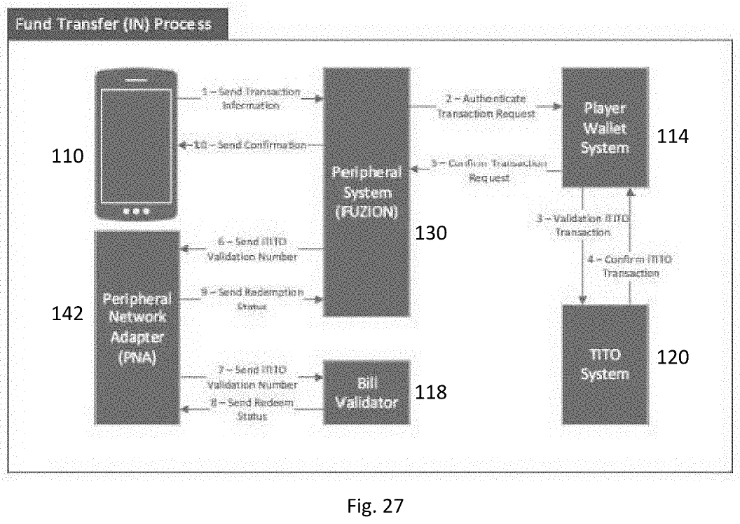

FIGS. 26 and 27 shows a configuration without the Peripheral System 130. In these embodiments, the PNA 142 connects directly to various system components to process the transactions.

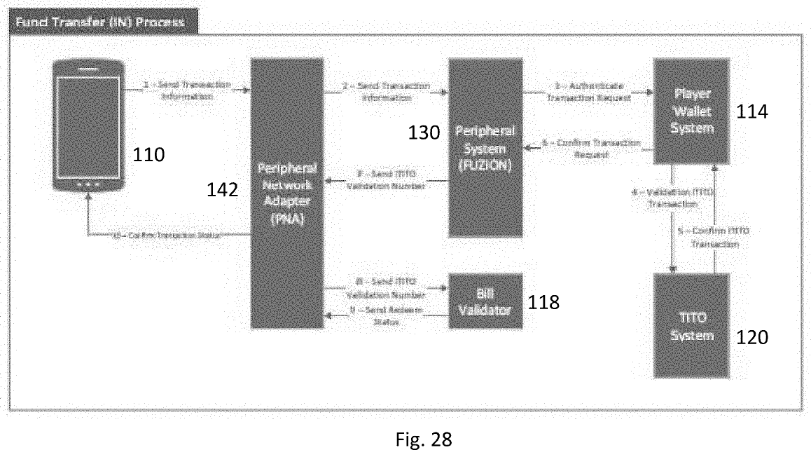

FIG. 28 shows a configuration where the mobile device 110 sends the transaction information through the PNA 142. The PNA 142 passes the transaction information to the Peripheral System 142. The Peripheral System 130 verifies the virtual TITO ticket information with the Player Wallet System 114. Once the virtual TITO ticket is verified, the PNA 142 sends a virtual TITO validation number to the bill validator 118 for redemption.

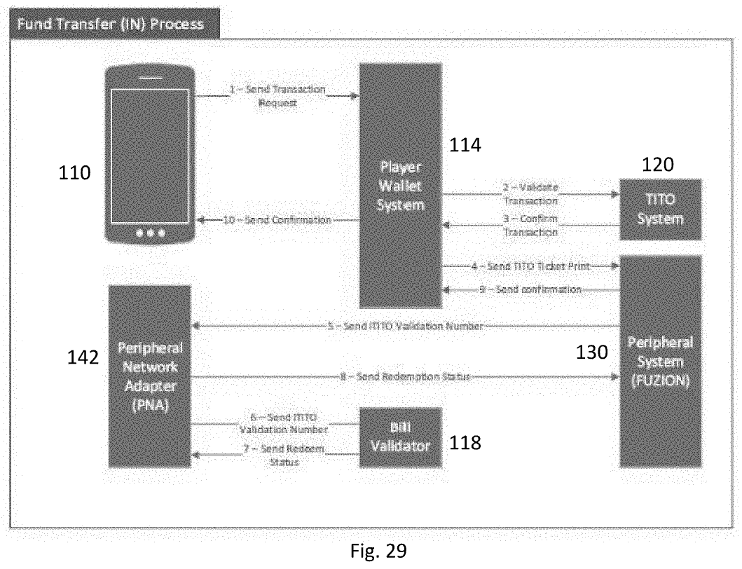

FIG. 29 shows a configuration where the mobile device 110 communicates directly with the Player Wallet System 114. The Player Wallet System 114 verifies the virtual TITO ticket information. Once the virtual TITO ticket is verified, the PNA 142 sends a virtual TITO validation number to the bill validator 118 for redemption.

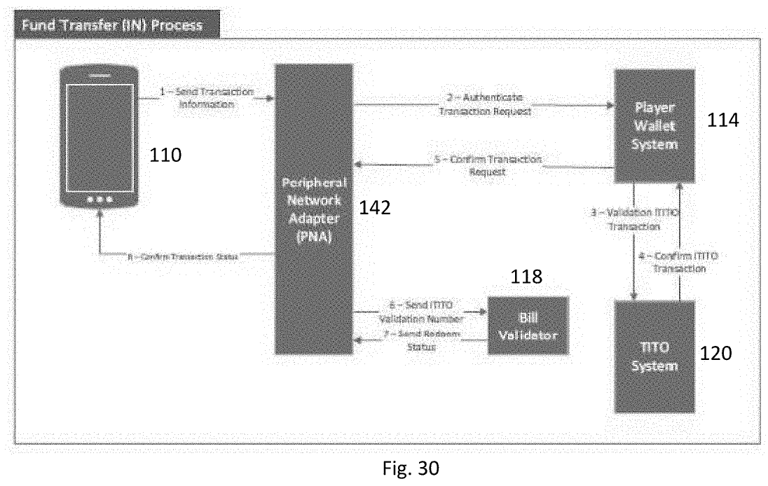

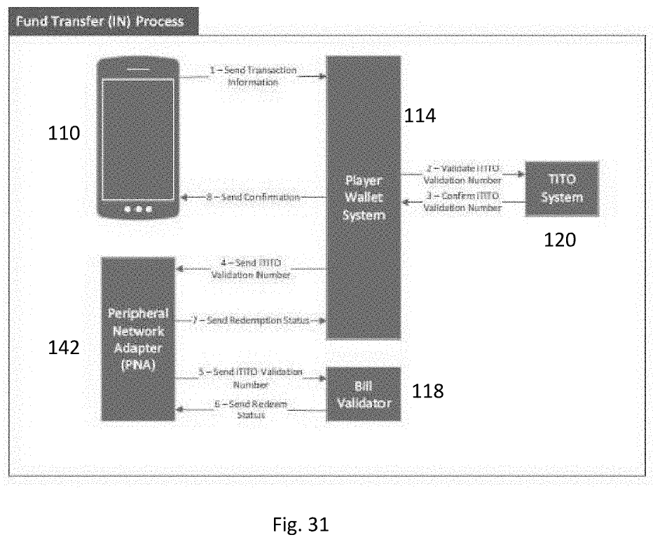

FIGS. 30 and 31 show configurations without the Peripheral System 130. In these embodiments, the PNA 142 connects directly to various system components to process the transactions.

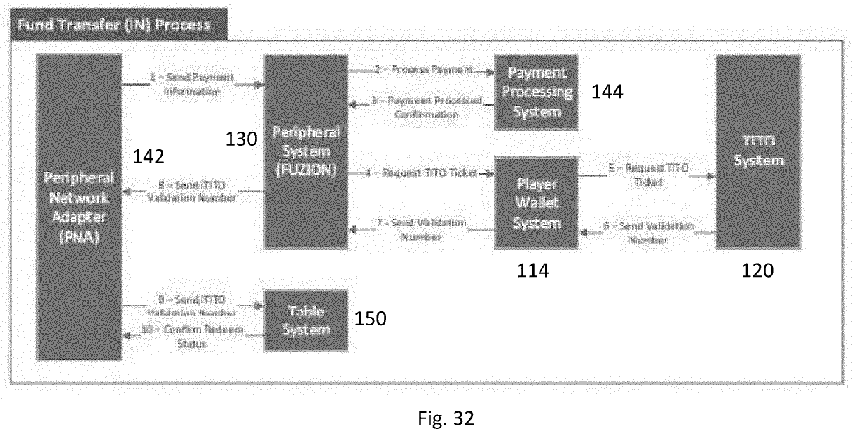

FIGS. 32-46 show enumerated sequences of steps or operations involving a CTG System 150 for redeeming virtual TITO tickets.

FIG. 32 shows a configuration where the payment information passes from the PNA 142 to the Peripheral System 130 and then to the payment processing system 144. After the payment has been processed and the funds have been deducted, the PNA 142 sends a virtual TITO validation number to the CTG System 150 for redemption.

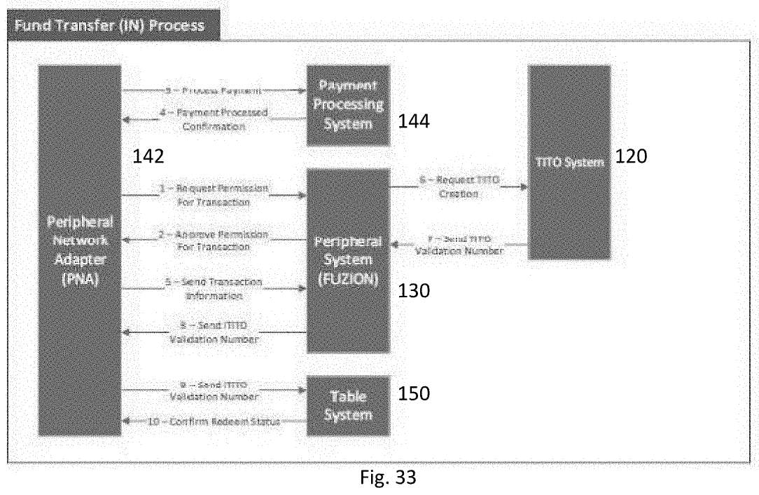

FIG. 33 shows a configuration where the payment information passes from the PNA 142 directly to the payment processing system 144. After the payment has been processed and the funds have been deducted, the PNA 142 sends a virtual TITO validation number to the CTG System 150 for redemption.

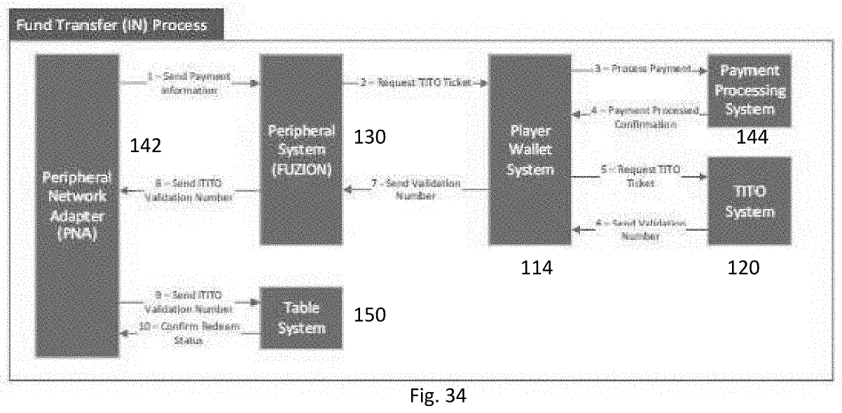

FIG. 34 shows a configuration where a Player Wallet System 114 is used instead of a card payment or mobile payment. After the payment has been processed and the funds have been deducted, the PNA 142 sends a virtual TITO validation number to the CTG System 150 for redemption.

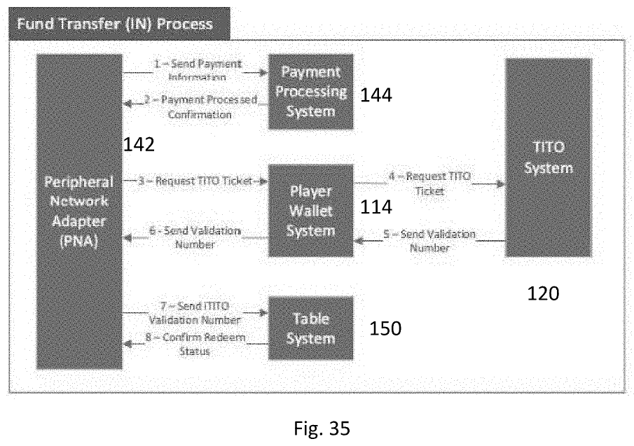

FIGS. 35 to 37 show configurations without the Peripheral System 130. In these embodiments, the PNA 142 connects directly to various system components to process the transactions.

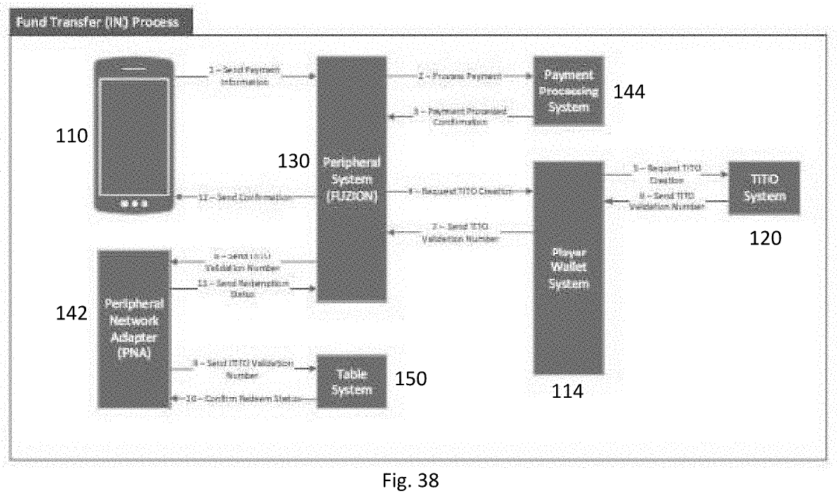

FIG. 38 shows a configuration where the payment information is processed using the mobile device through the Peripheral System 130 to the payment processing system 144. After the payment has been processed and the funds have been deducted, the PNA 142 sends a virtual TITO validation number to the CTG System 150 for redemption.

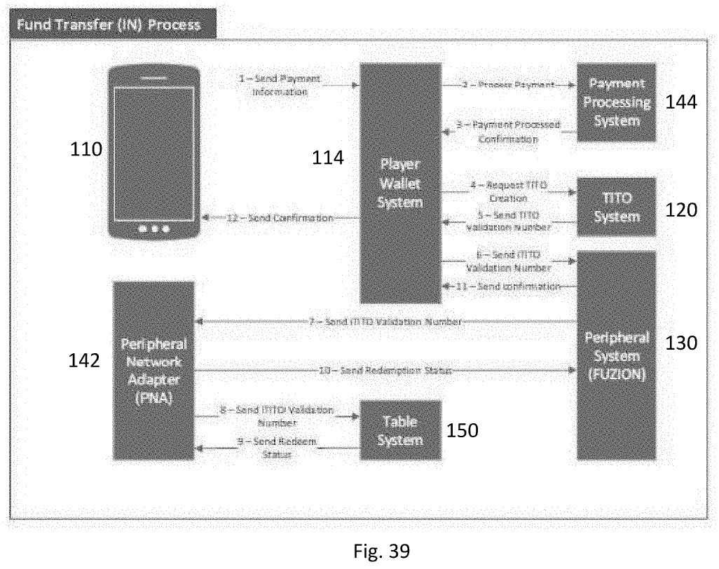

FIG. 39 shows a configuration where the payment information is processed using the mobile device 110 directly to the payment processing system 144. After the payment has been processed and the funds have been deducted, the PNA 142 sends a virtual TITO validation number to the CTG System 150 for redemption.

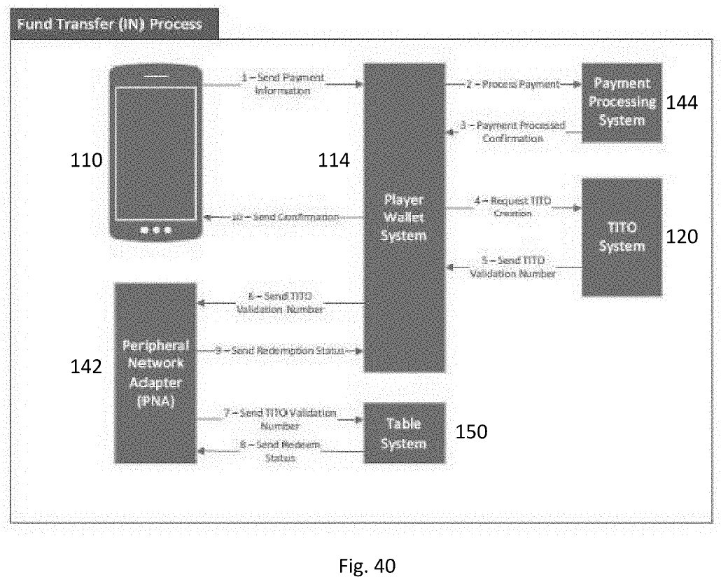

FIG. 40 shows a configuration without the Peripheral System 130. In these embodiments, the PNA 142 connects directly to various system components to process the transactions.

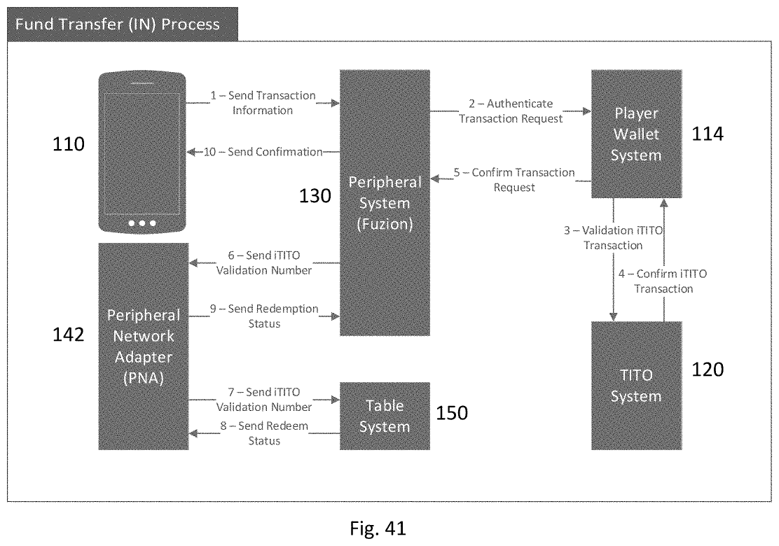

FIG. 41 shows a configuration where the transaction information is passed through Peripheral System 130. The Peripheral System 130 verifies the virtual TITO information with the Player Wallet System 114. Once the virtual TITO ticket is verified, the PNA 142 sends a virtual TITO validation number to the CTG System 150 for redemption.

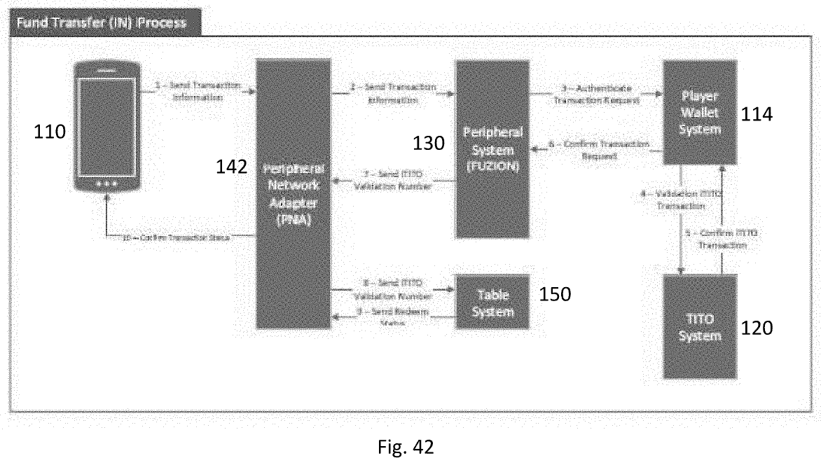

FIG. 42 shows a configuration where the mobile device 110 sends the transaction information through the PNA 142. The PNA 142 passes the transaction information to the Peripheral System 130. The Peripheral System 130 verifies the virtual TITO ticket information with the Player Wallet System 114. Once the virtual TITO ticket is verified, the PNA 142 sends the virtual TITO validation number to the CTG System 150 for redemption.

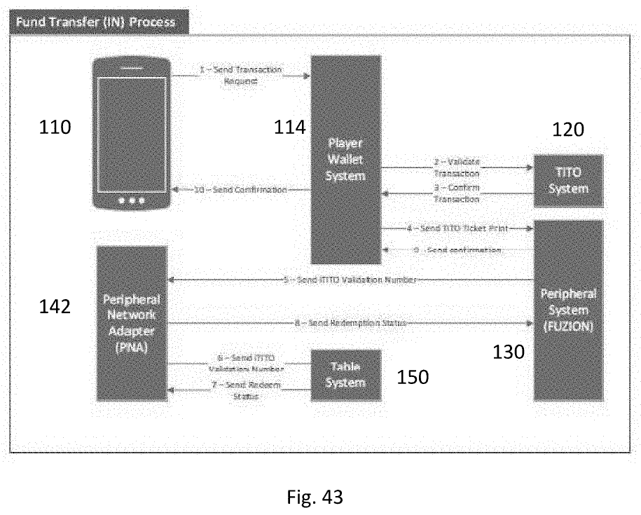

FIG. 43 shows a configuration where the mobile device 110 communicates directly with the Player Wallet System 114. The Player Wallet System 114 verifies the virtual TITO ticket information. Once the virtual TITO ticket is verified, the PNA 142 sends a virtual TITO ticket validation number to the CTG System 150 for redemption.

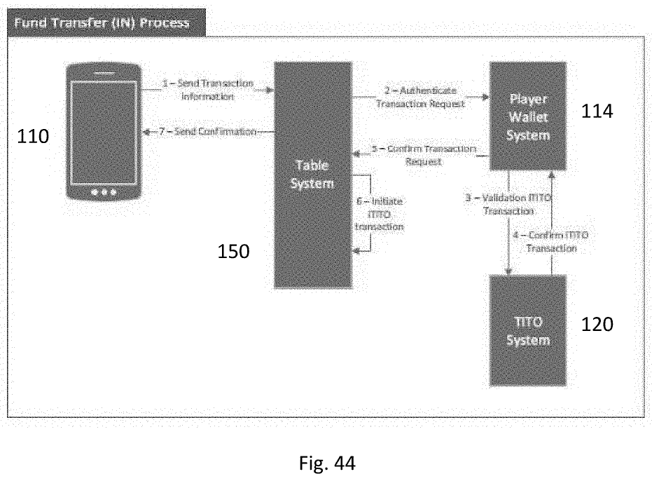

FIG. 44 shows a configuration where the mobile device 110 communicates through CTG System 150. The CTG System 150 verifies the virtual TITO ticket information with the Player Wallet System 114. Once the virtual TITO ticket is verified, the CTG System 150 performs the virtual TITO transaction and sends confirmation to the mobile device 110.

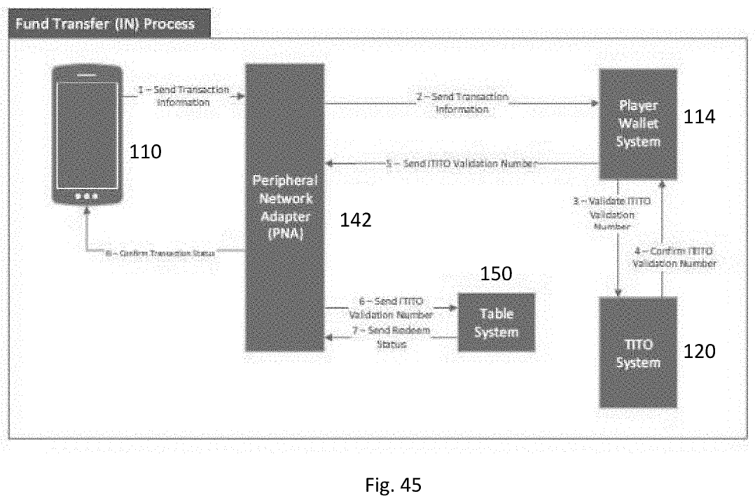

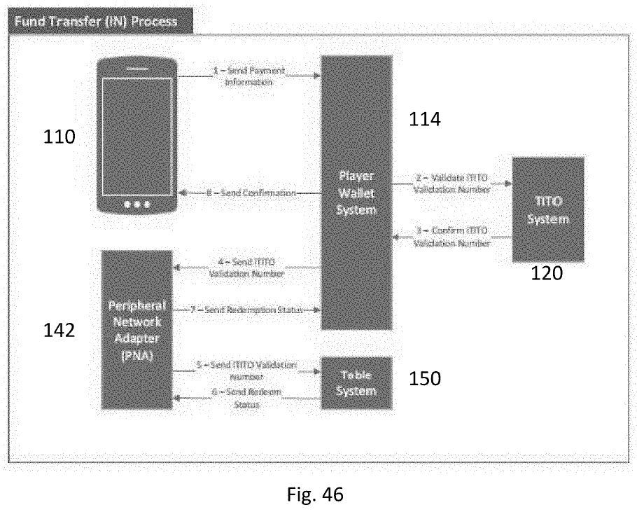

FIGS. 45 and 46 show configurations without the Peripheral System 130. In these embodiments, the PNA 142 connects directly to various system components to process the transactions.

### Buy in Options

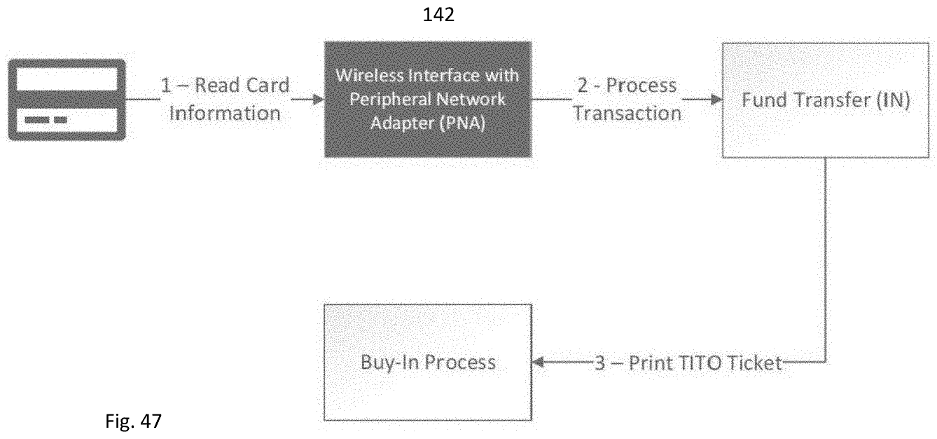

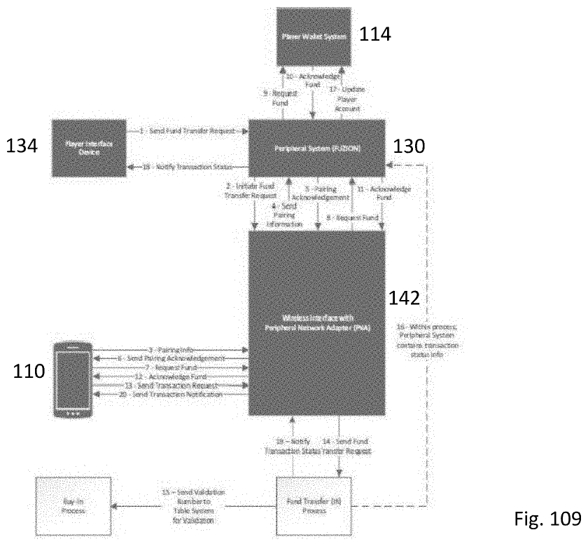

FIGS. 47-109 show system configurations for transferring funds via physical TITO tickets or virtual TITO tickets using system components for buy-in uses.

FIGS. 46-61 show preset amounts used for each fund transfer. The preset amount can be configured in the Peripheral System 130 and/or PNA 142 by the table games operator.

FIG. 47 shows a configuration where the player uses the PNA 142 transfers a preset amount of funds using a card payment with NFC, RFID, magnetic stripe, smart chip, etc.

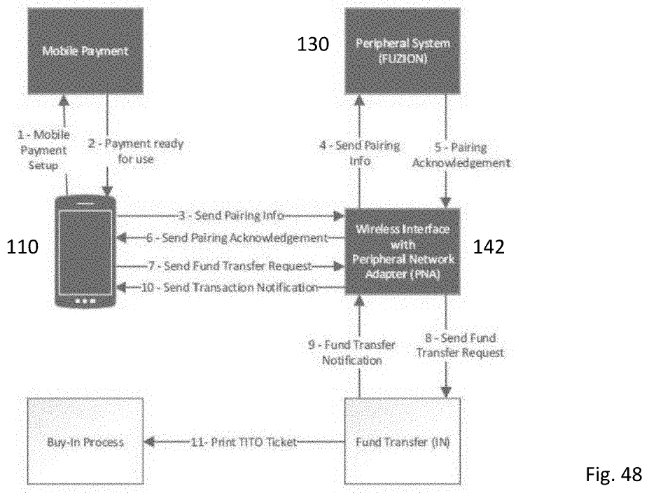

FIG. 48 shows a configuration where the player uses a contactless payment service, such as Apple Pay, Google Pay, etc., on their mobile device 110 and tap it to the PNA 142 to transfer a preset amount of funds.

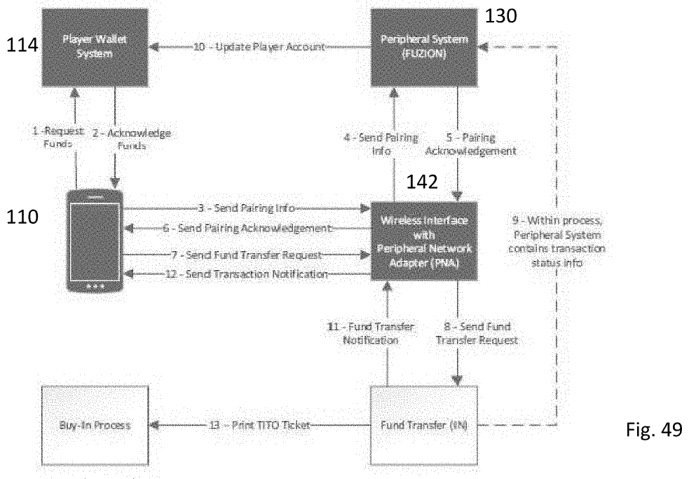

FIG. 49 shows a configuration where the mobile device 110 uses a network, such as Wi-Fi, cellular, Bluetooth, etc., to contact the Player Wallet System 114 and retrieves the player's account information including available funds.

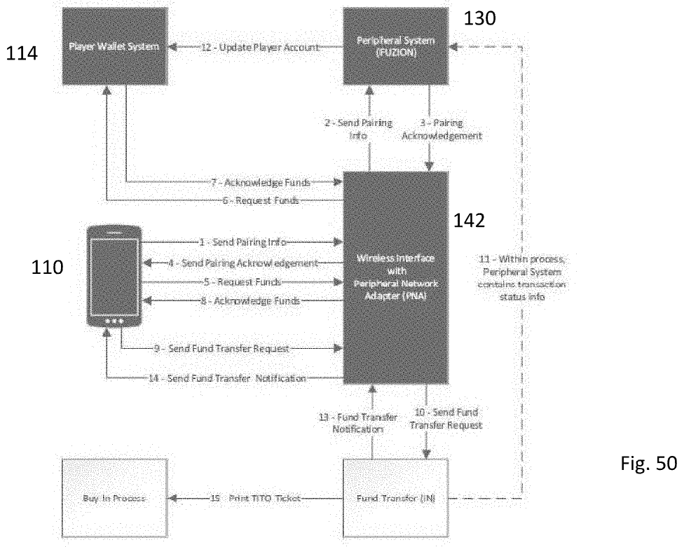

FIG. 50 shows a configuration where the mobile device 110 uses wireless communication, such as NFC, Bluetooth, or Wi-Fi, to interface with the PNA 142. The PNA 142 contacts the Player Wallet System 114 and retrieves the player's account information including a list of available funds. The PNA 142 then sends the account information to the mobile device 110 through its wireless interface, and the player can then select which funds to redeem.

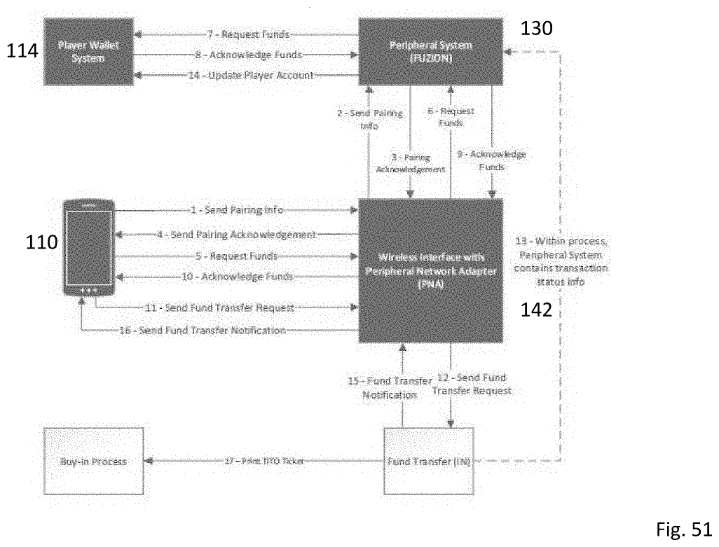

FIG. 51 shows a configuration where the mobile device 110 uses wireless communication, such as NFC, Bluetooth, or Wi-Fi, to interface with the PNA 142. The Peripheral System contacts the Player Wallet System 114 and retrieves the player's account information including a list of available funds. The Peripheral System sends the data to the PNA 142, which then sends it to the mobile device through its wireless interface, and the player can then select which funds to redeem.

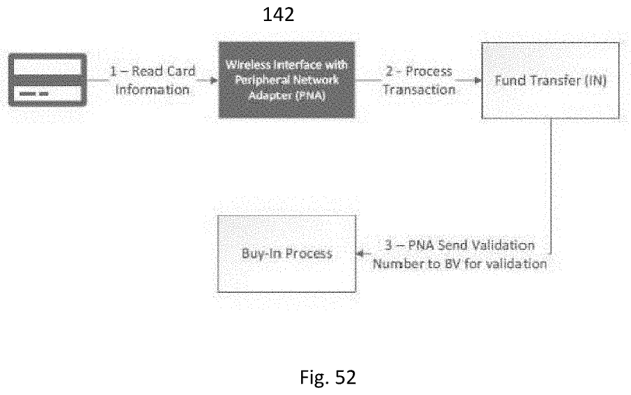

FIG. 52 shows a configuration where the player uses the wireless interface of the PNA 142 to transfer a preset amount of funds using a card payment with NFC, RFID, magnetic stripe, smart chip, etc. In one such embodiment, the PNA 142 sends the virtual TITO ticket information to the bill validator 118 for validation. The dealer will confirm the transaction on the CTG System 150 and distribute chips to the player.

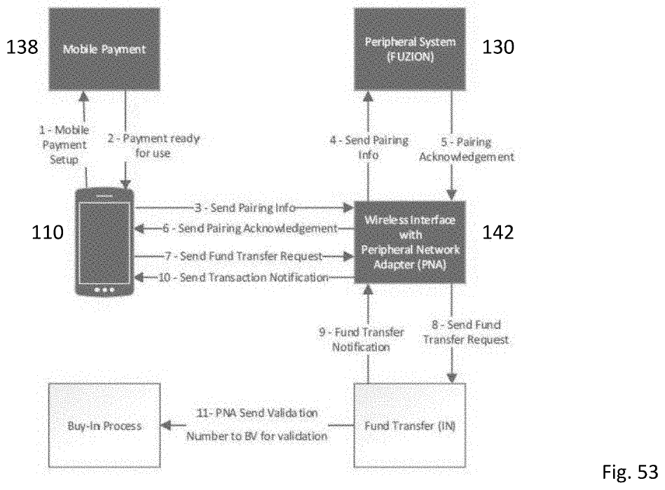

FIG. 53 shows a configuration where the player uses a contactless payment service 138, such as Apple Pay, Google Pay, etc., on their mobile device 110 and taps it to the wireless interface of the PNA 142 to transfer a preset amount of funds.

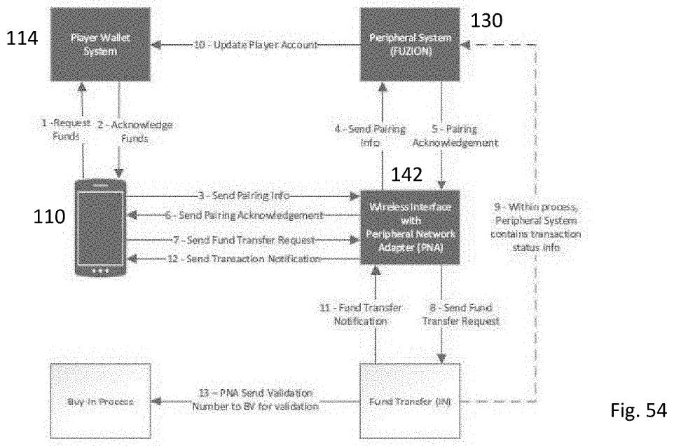

FIG. 54 shows a configuration where the mobile device 110 uses a network, such as Wi-Fi, cellular, Bluetooth, etc., to contact the Player Wallet System 114 and retrieves the player's account information including available funds. The player can then select funds from which the preset amount will be deducted. The Player Wallet System 114 can be a bank, JCM Mobile I/O, JCM virtual TITO ticket, or a 3rd party wallet.

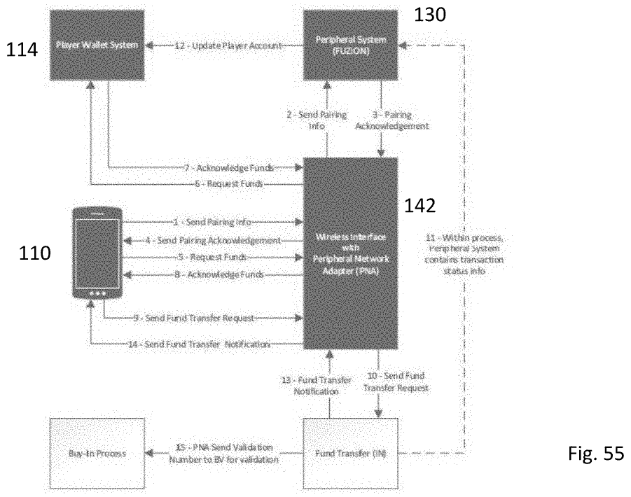

FIG. 55 shows a configuration where the mobile device 110 uses wireless communication, such as NFC, Bluetooth, or Wi-Fi, to interface with the PNA 142. The PNA 142 contacts the Player Wallet System 114 and retrieves the player's account information including a list of available funds. The PNA 142 then sends the funds to the mobile device 110 through its wireless interface, and the player can then select which funds to redeem.

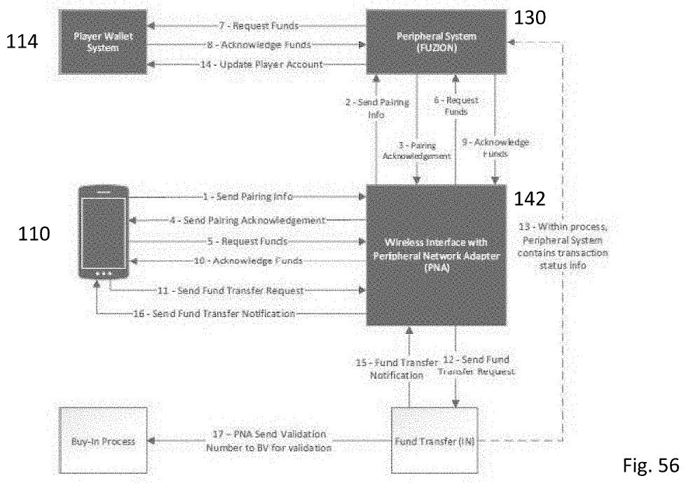

FIG. 56 shows a configuration where mobile device 110 uses wireless communication, such as NFC, Bluetooth, or Wi-Fi, to interface with the PNA 142. The PNA 142 contacts the Player Wallet System 114 and retrieves the player's account information including a list of available funds. The Peripheral System 130 sends the data to the PNA 142, which then sends it to the mobile device 110 through its wireless interface, and the player can then select which funds to redeem.

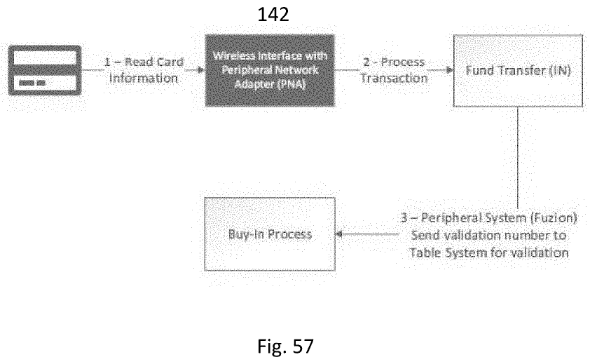

FIG. 57 shows a configuration where the player uses the wireless interface of the PNA 142 to transfer a preset amount of funds using a card payment with NFC, RFID, magnetic stripe, smart chip, etc. In one such use case, the Peripheral System 130 sends the virtual TITO information to the CTG System 150 for validation. The dealer will confirm the transaction on the virtual CTG System 150 and distribute chips to the player.

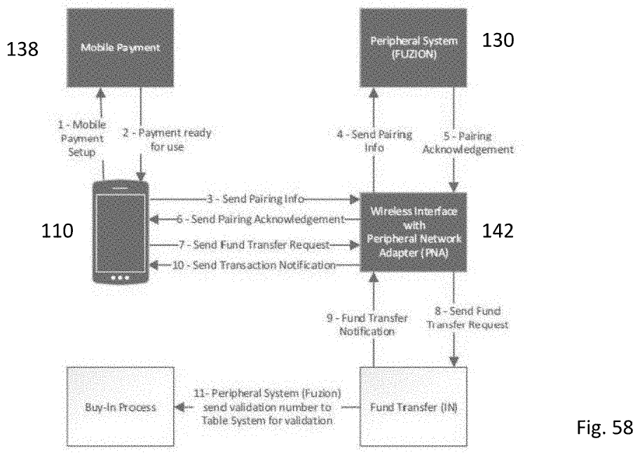

FIG. 58 shows a configuration where the player uses a contactless payment service 138, such as Apple Pay, Google Pay, etc., on their mobile device 110 and taps it to the wireless interface of the PNA 142 to transfer a preset amount of funds.

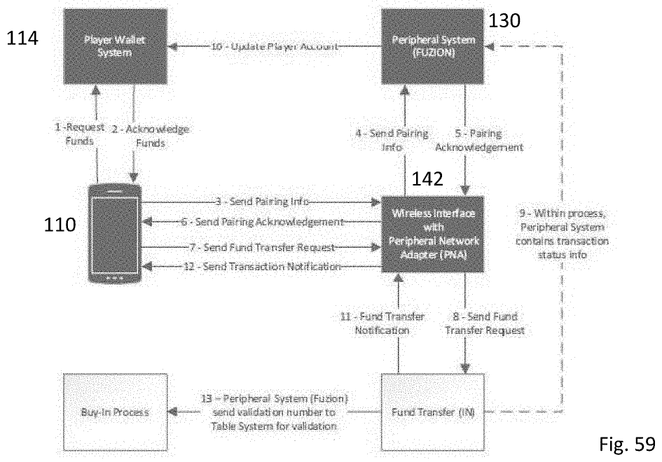

FIG. 59 shows a configuration where the mobile device 110 uses a network, such as Wi-Fi, cellular, Bluetooth, etc., to contact the Player Wallet System 114 and retrieves the player's account information including available funds. The player can then select funds from which the preset amount will be deducted.

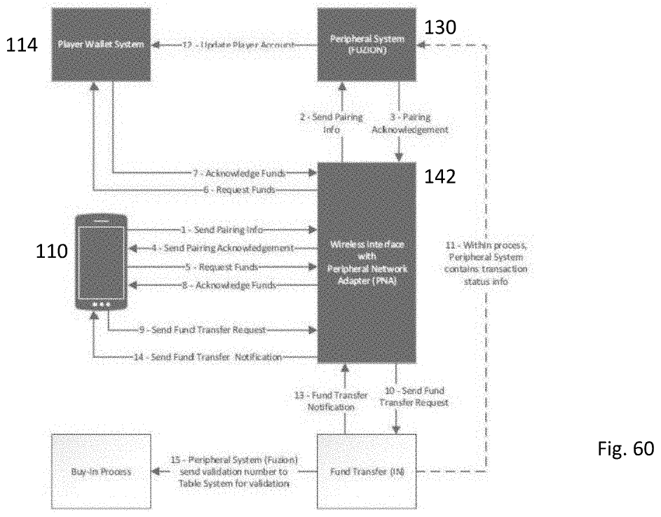

FIG. 60 shows a configuration where the mobile device 110 uses wireless communication, such as NFC, Bluetooth, or Wi-Fi, to interface with the PNA 142. The PNA 142 contacts the Player Wallet System 114 and retrieves the player's account information including a list of available funds. The PNA 142 then sends the funds to the mobile device 110 through its wireless interface, and the player can then select which funds to redeem.

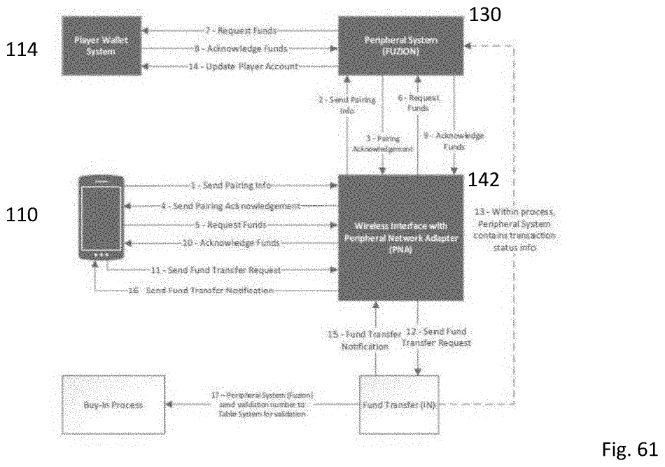

FIG. 61 shows a configuration where the mobile device 110 uses wireless communication, such as NFC, Bluetooth, or Wi-Fi, to interface with the PNA 142. The Peripheral System 130 contacts the Player Wallet System and retrieves the player's account information including a list of available funds. The Peripheral System 130 sends the data to the PNA 142, which then sends it to the mobile device through its wireless interface, and the player can then select which funds to redeem.

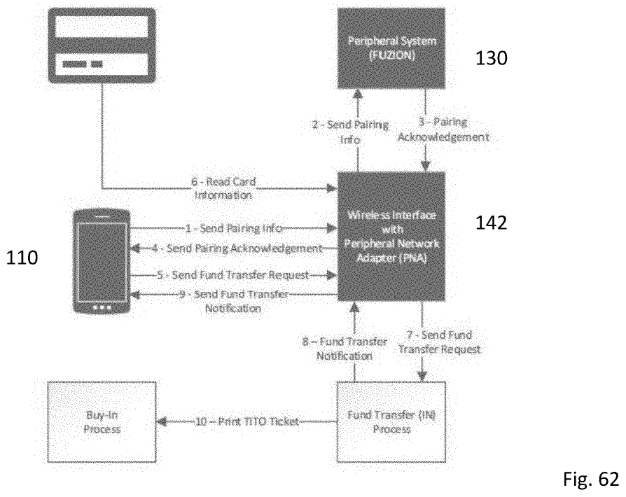

FIGS. 62-79 show instances where the player uses a mobile device 110 to select the transfer amount. The player has a choice to use one or more following payment methods including a physical TITO ticket, BV 118 or CTG System 150.

FIG. 62 shows a configuration where the player uses the wireless interface of the PNA 142 to transfer funds using a card payment with NFC, RFID, magnetic stripe, smart chip, etc.

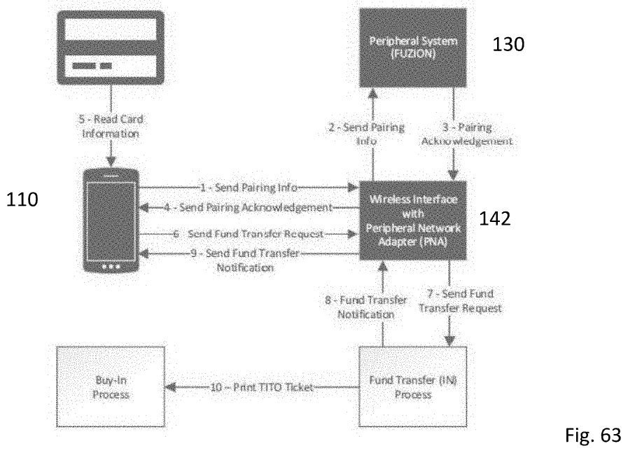

FIG. 63 shows a configuration where the player uses a mobile device 110 to read credit card data and then perform a contactless transfer to the wireless interface of the PNA 142.

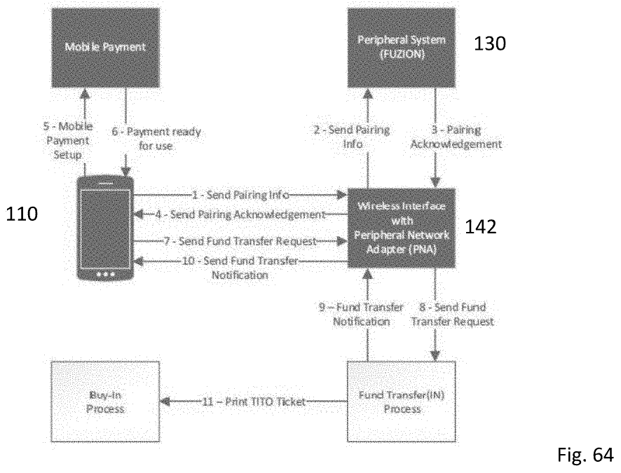

FIG. 64 shows a configuration where the player uses a contactless payment service, such as Apple Pay, Google Pay, etc., on a mobile device 110 to perform a transfer with the wireless interface of the PNA 142.

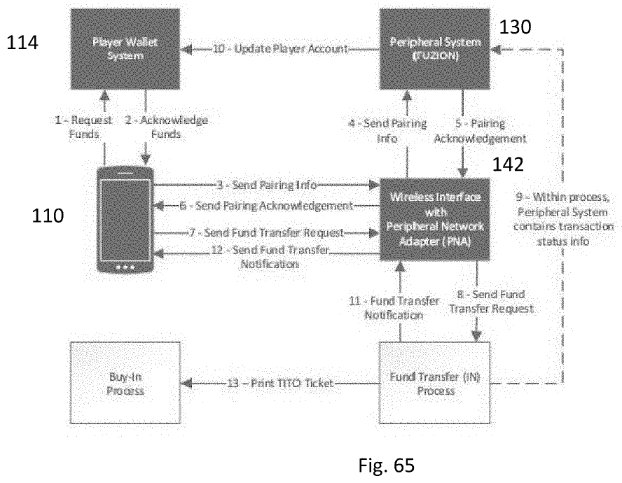

FIG. 65 shows a configuration where the mobile device 110 uses a network, such as Wi-Fi, cellular, Bluetooth, etc., to contact the Player Wallet System 114 and retrieves the player's account information including a list of available funds. The player can then select which funds to redeem.

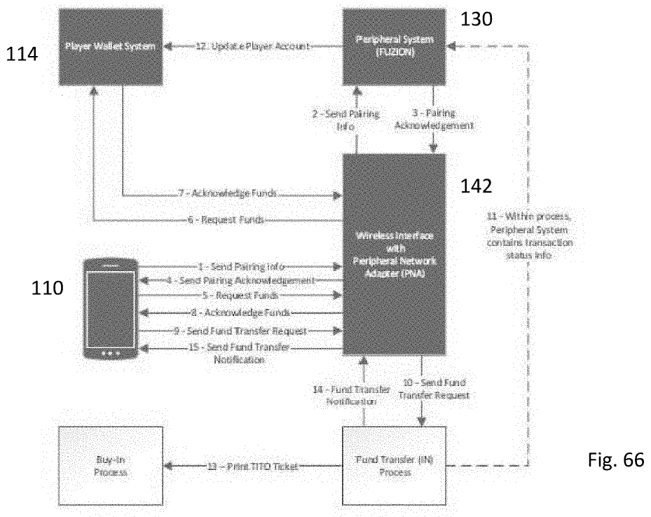

FIG. 66 shows a configuration where the mobile device 110 uses wireless communication, such as NFC, Bluetooth, or Wi-Fi, to interface with the PNA 142. The PNA 142 contacts the Player Wallet System 114 and retrieves the player's account information including a list of available funds. The PNA 114 then sends the funds to the mobile device 110 through its wireless interface, and the player can then select which funds to redeem.

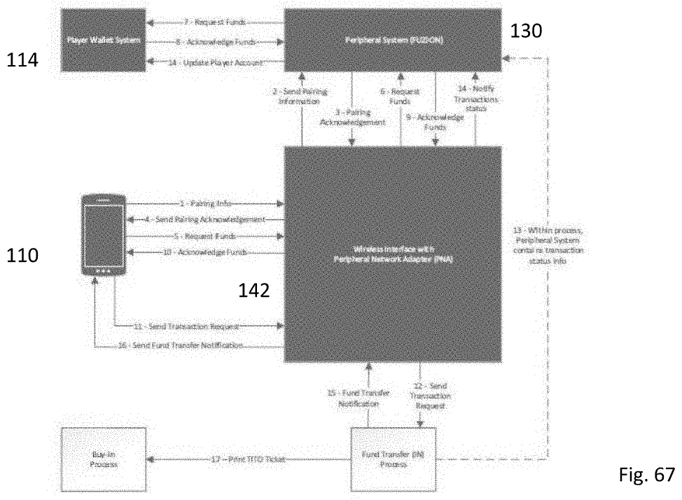

FIG. 67 shows a configuration where the mobile device 110 uses wireless communication, such as NFC, Bluetooth, or Wi-Fi, to interface with the PNA 142. The Peripheral System 130 contacts the Player Wallet System 114 and retrieves the player's account information including a list of available funds. The Peripheral System 130 sends the data to the PNA 142, which then sends it to the mobile device 110 through its wireless interface, and the player can then select which funds to redeem.

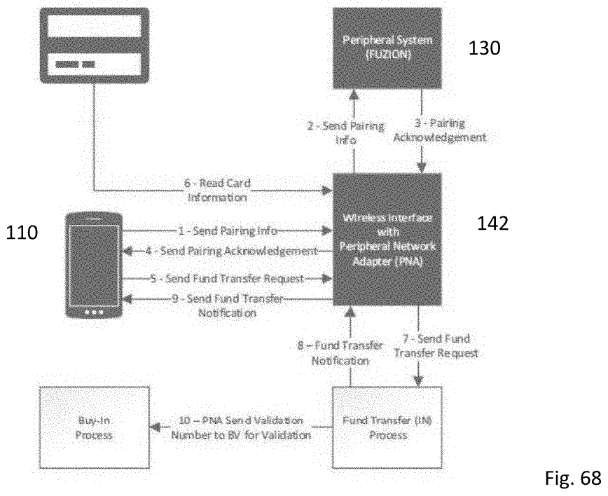

FIG. 68 shows a configuration where the player uses the wireless interface of the PNA 142 to transfer funds using a card payment with NFC, RFID, magnetic stripe, smart chip, etc. In such embodiments, the PNA 142 sends the virtual TITO ticket information to a bill validator 118 for validation. The dealer confirms the transaction on the CTG System 150 and distributes chips to the player.

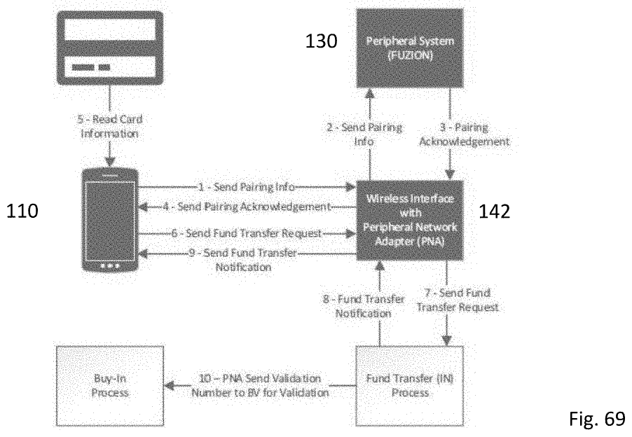

FIG. 69 shows a configuration where the player uses a mobile device 110 to read credit card data and then performs a contactless transfer to the wireless interface of the PNA 142.

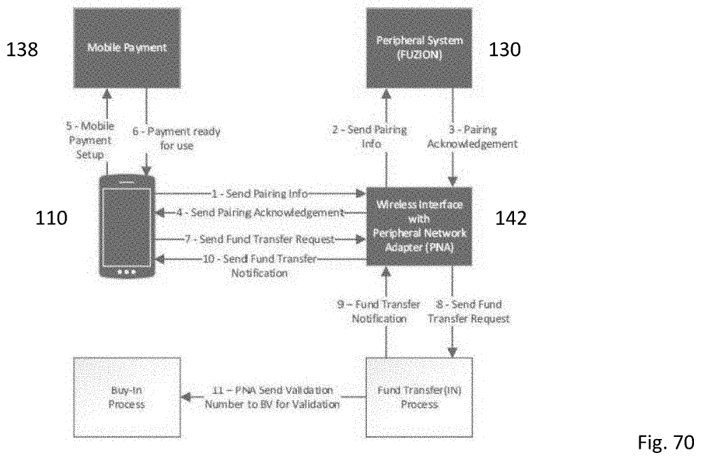

FIG. 70 shows a configuration where the player uses a contactless payment service 138, such as Apple Pay, Google Pay, etc., on a mobile device 110 to perform a transfer with the wireless interface of the PNA 142.

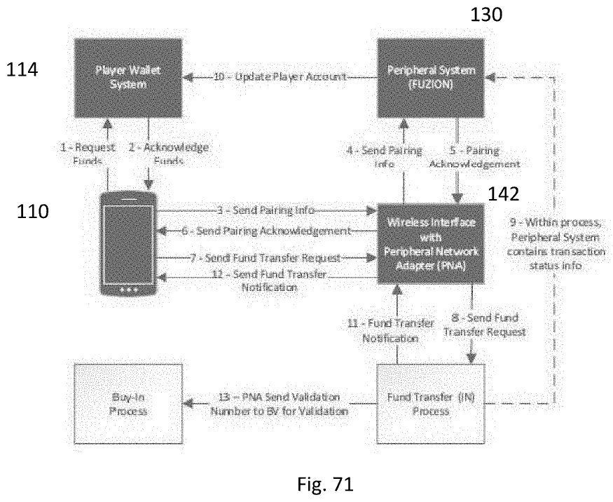

FIG. 71 shows a configuration where the mobile device 110 uses a network, such as Wi-Fi, cellular, Bluetooth, etc., to contact the Player Wallet System 114 and retrieves the player's account information including a list of available funds. The player can then select which funds to redeem.

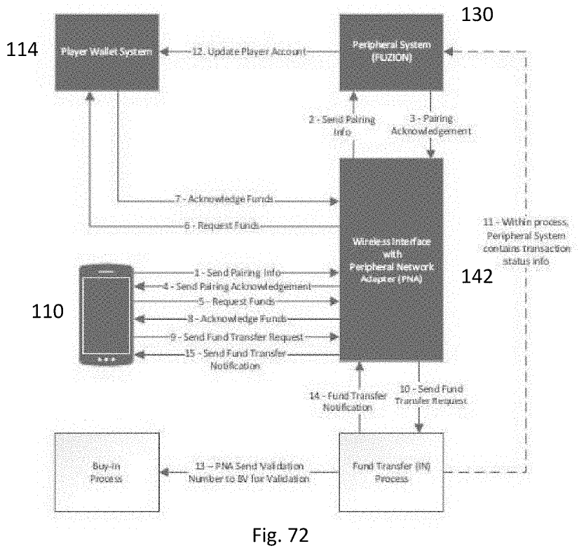

FIG. 72 shows a configuration where the mobile device 110 uses wireless communication, such as NFC, Bluetooth, or Wi-Fi, to interface with the PNA 142. The PNA 142 contacts the Player Wallet System 114 and retrieves the player's account information including a list of available funds. The PNA 142 then sends the funds to the mobile device 110 through its wireless interface, and the player can then select which funds to redeem.

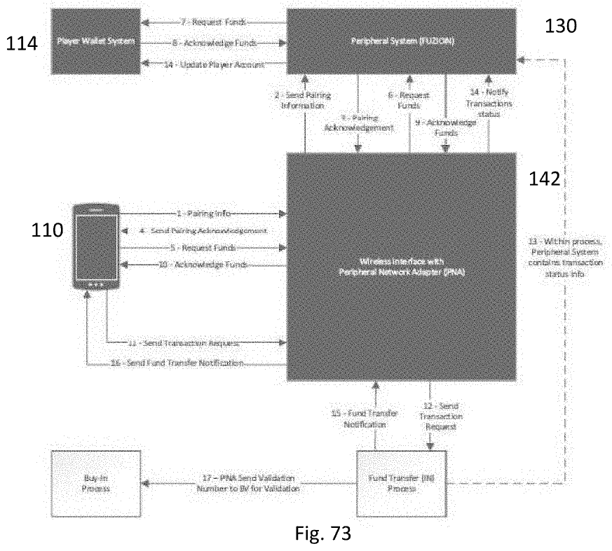

FIG. 73 shows a configuration where the mobile device 110 uses wireless communication, such as NFC, Bluetooth, or Wi-Fi, to interface with the PNA 142. The PNA 142 contacts the Player Wallet System 114 and retrieves the player's account information including a list of available funds. The Peripheral System 130 sends the data to the PNA 142, which then sends it to the mobile device through its wireless interface, and the player can then select which funds to redeem.

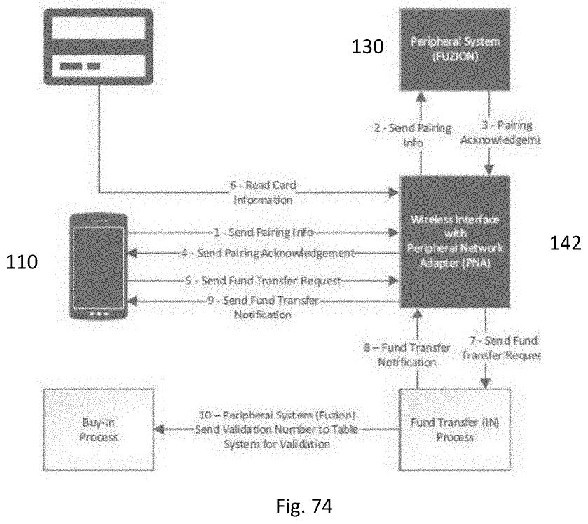

FIG. 74 shows a configuration where the player uses the wireless interface of the PNA 142 to transfer funds using a card payment with NFC, RFID, magnetic stripe, smart chip, etc.

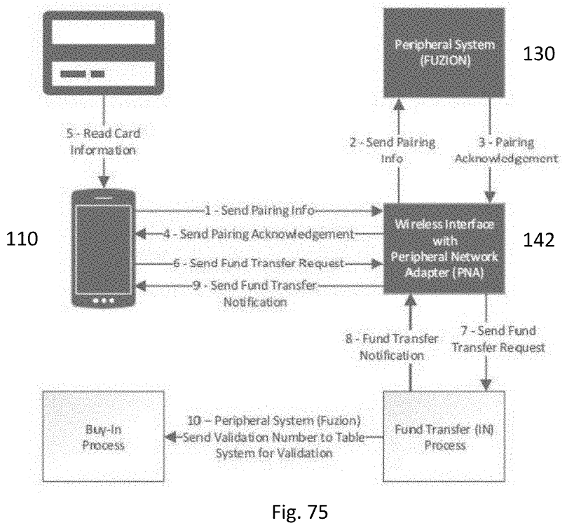

FIG. 75 shows a configuration where the player uses a mobile device 110 to read credit card data and then performs a contactless transfer to the wireless interface of the PNA 142.

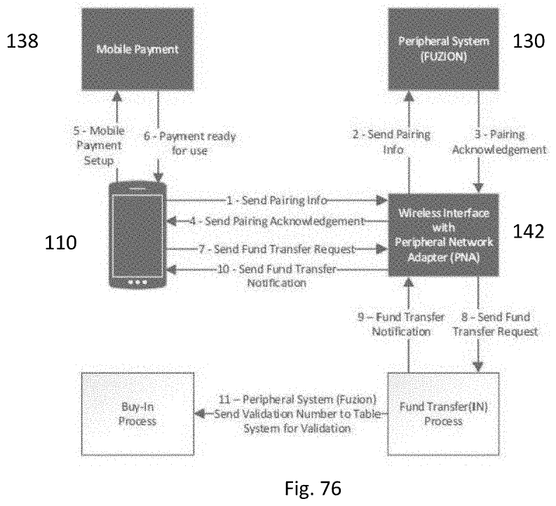

FIG. 76 shows a configuration where the player uses a contactless payment service 138, such as Apple Pay, Google Pay, etc., on a Mobile Device to perform a transfer with the wireless interface of the PNA 142.

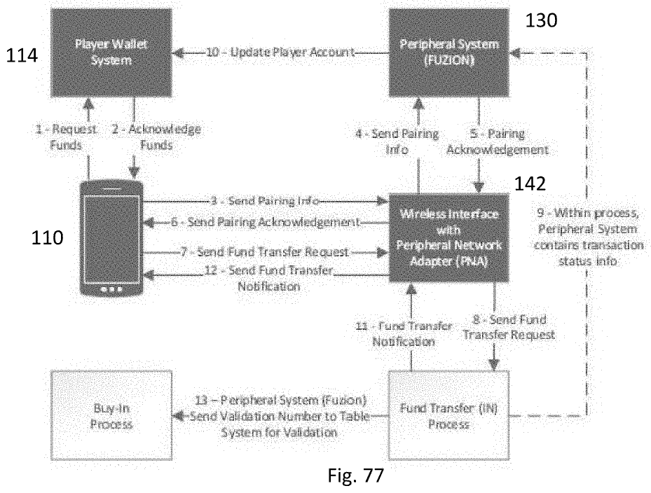

FIG. 77 shows a configuration where the mobile device 110 uses a network, such as Wi-Fi, cellular, Bluetooth, etc., to contact the Player Wallet System 114 and retrieves the player's account information including a list of available funds. The player can then select which funds to redeem.

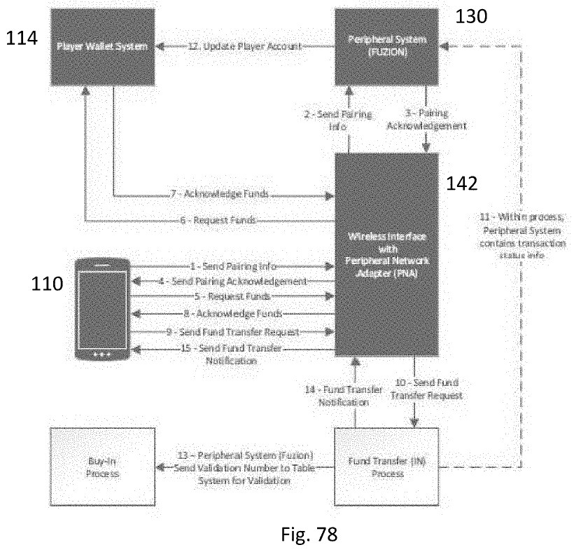

FIG. 78 shows a configuration where the mobile device 110 uses wireless communication, such as NFC, Bluetooth, or Wi-Fi, to interface with the PNA 142. The PNA 142 contacts the Player Wallet System 114 and retrieves the player's account information including a list of available funds. The PNA then sends the funds to the mobile device 110 through the wireless interface of the PNA 142, and the player can then select which funds to redeem.

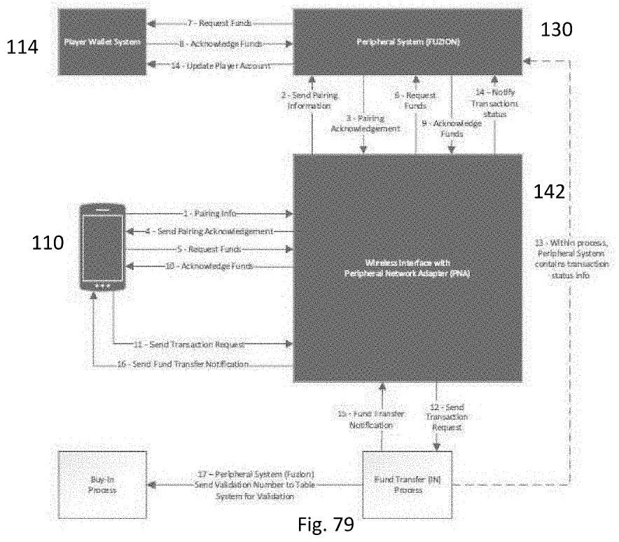

FIG. 79 shows a configuration where the mobile device 110 uses wireless communication, such as NFC, Bluetooth, or Wi-Fi, to interface with the PNA 142. The Peripheral System 130 contacts the Player Wallet System and retrieves the player's account information including a list of available funds. The Peripheral System sends the data to the PNA 142, which then sends it to the mobile device through its wireless interface, and the player can then select which funds to redeem.

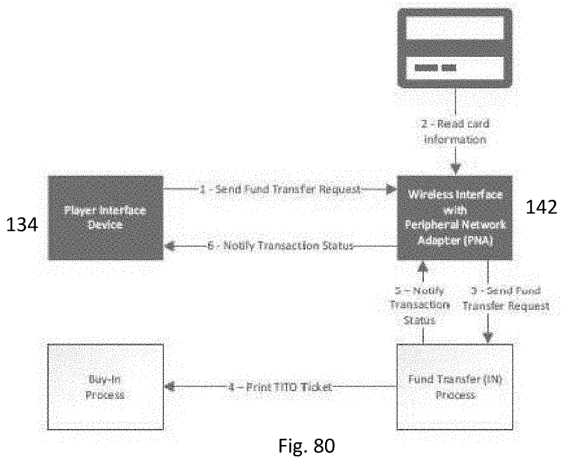

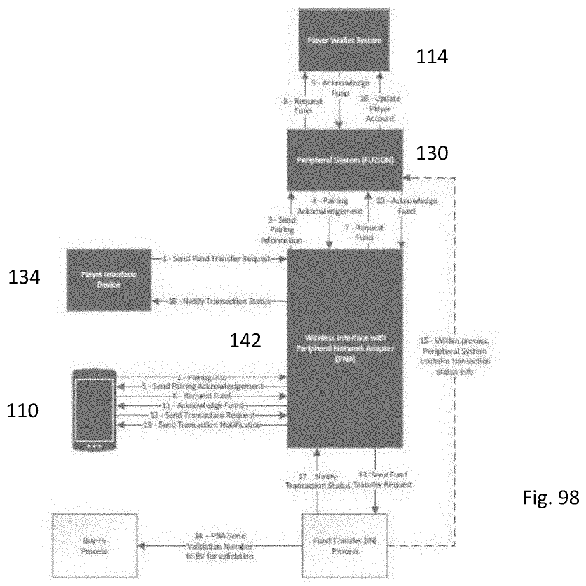

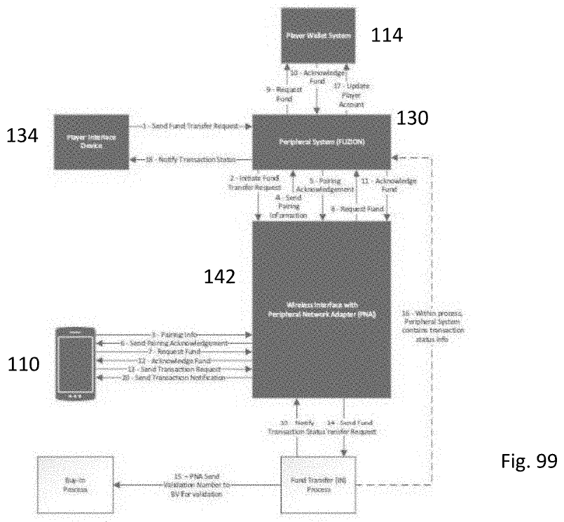

FIGS. 80-109 show instances where user initiates a fund transfer on a Player Interface Device 134, such as a touchscreen, keypad, tablet, service window, etc. After selecting the transfer amount, the player has the choice to use one or more payment methods including a physical TITO ticket, BV 118 and CTG System 150.

FIG. 80 shows a configuration where the player uses the wireless interface of the PNA 142 to transfer funds using a card payment with NFC, RFID, magnetic stripe, smart chip, etc. In this embodiment, the player interface device is connected to the PNA 142. The player interface device 134 may be a touchscreen, keypad, tablet, service window, etc.

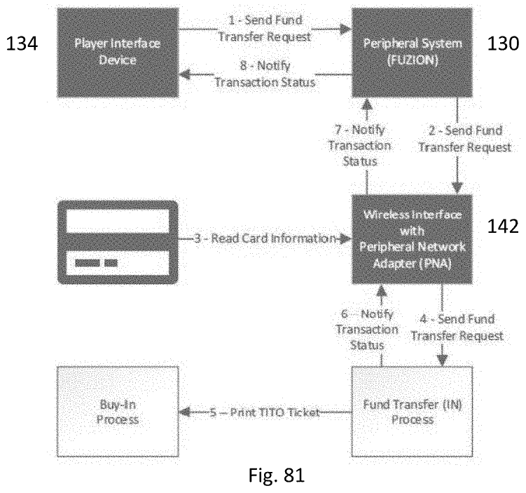

FIG. 81 shows a configuration where the player interface device 134 is connected to the peripheral system.

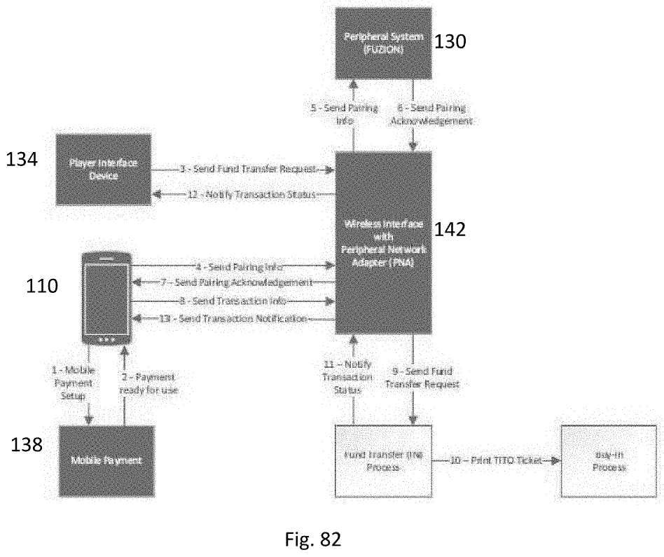

FIG. 82 shows a configuration where the player interface device 134 is connected to the PNA 142. In this embodiment, the player can use a contactless payment service 138, such as Apple Pay, Google Pay, etc., on a mobile device 110 to perform a transfer with the wireless interface of the PNA 142.

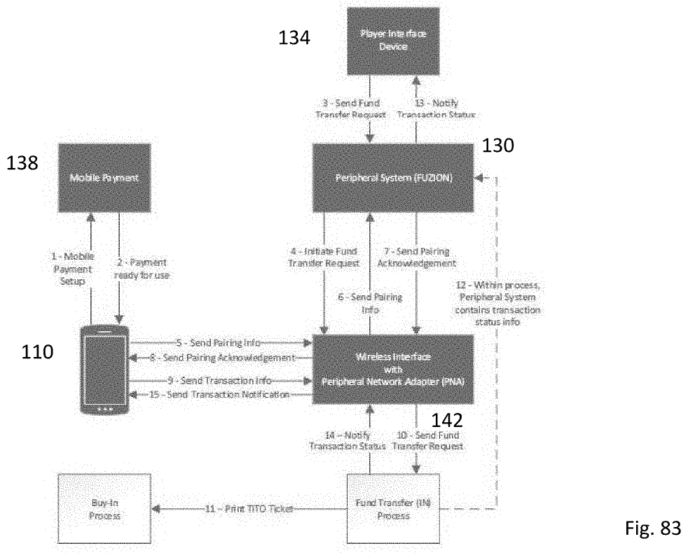

FIG. 83 shows a configuration where the player interface device 134 is connected to the Peripheral System 130.

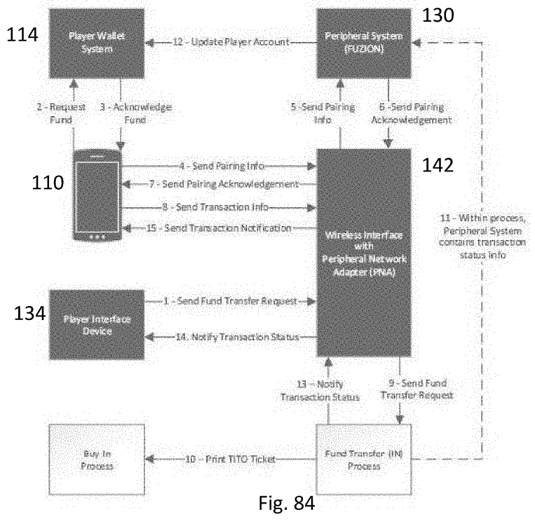

FIG. 84 shows a configuration where the player interface device 134 is connected to the PNA 142. In this embodiment, the player uses a mobile device 110 to select funds from a Player Wallet System 114. The mobile device 110 then transfers the funds to the wireless interface of the PNA 142 for redemption.

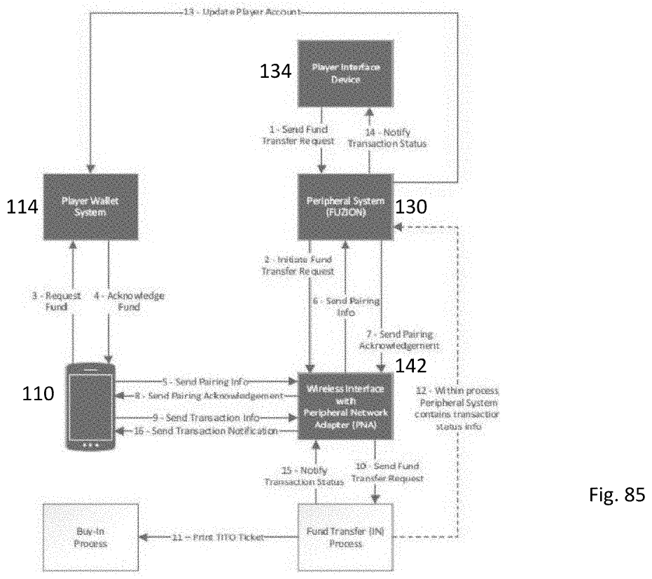

FIG. 85 shows a configuration where the player interface device 134 is connected to the Peripheral System 130.

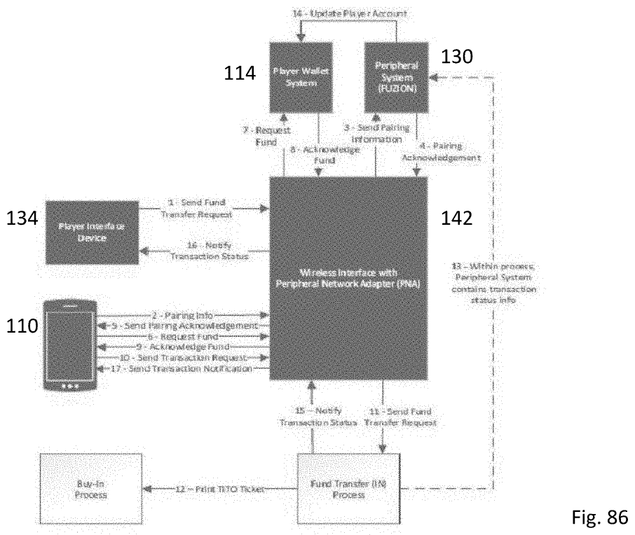

FIG. 86 shows a configuration where the PNA 142 contacts the Player Wallet System 114 and retrieves the player's account information including a list of available funds. The PNA 142 then sends the funds to the mobile device through the wireless interface of the PNA 142, and the player can then select which funds to redeem.

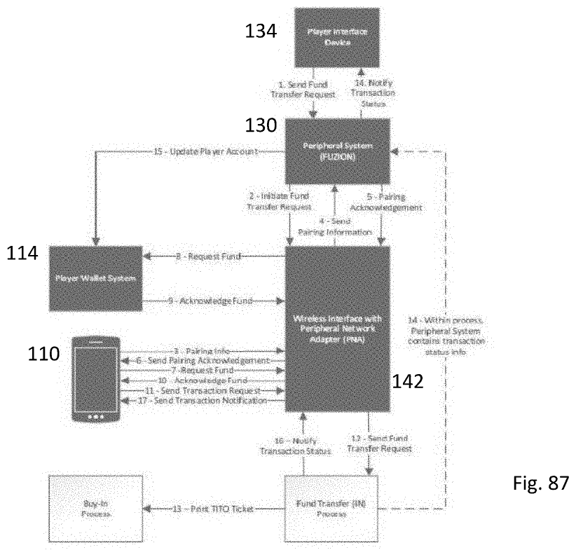

FIG. 87 shows a configuration where the player interface device 134 is connected to the Peripheral System 130.

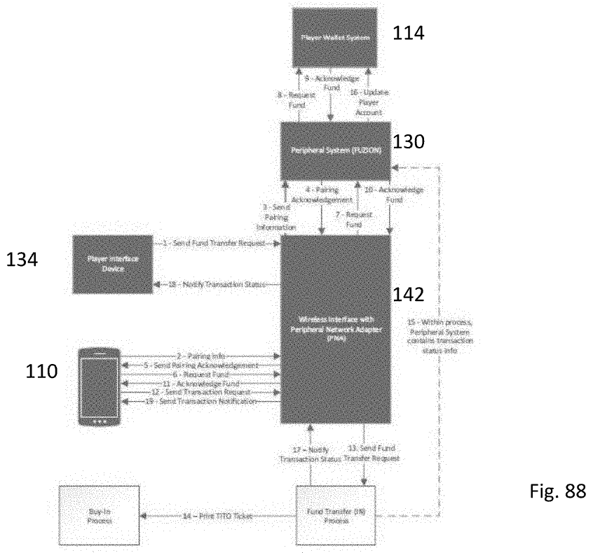

FIG. 88 shows a configuration where player interface device 134 is connected to the Peripheral System 130. The mobile device 110 transfers the funds to the wireless interface of the PNA 142 for redemption. The mobile device 110 uses wireless communication, such as NFC, Bluetooth, or Wi-Fi, to interface with the PNA 142. The Peripheral System contacts the Player Wallet System 114 and retrieves the player's account information including a list of available funds. The Peripheral System 130 sends the data to the PNA 142, which then sends it to the mobile device 110 through the wireless interface of the PNA 142, and the player can then select which funds to redeem.

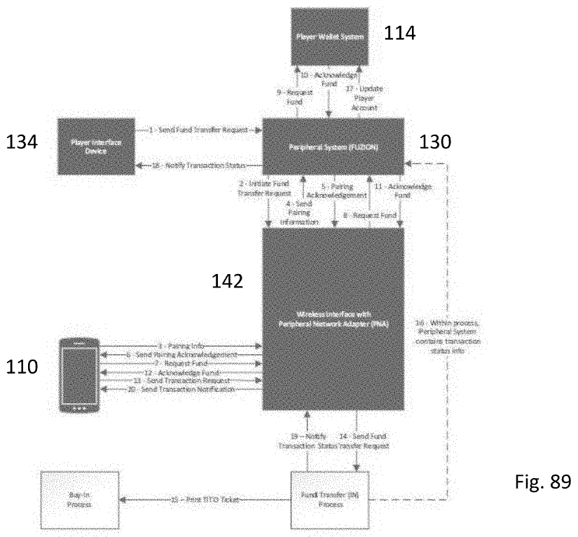

FIG. 89 shows a configuration where the player interface device 134 is connected to the Peripheral System 130.

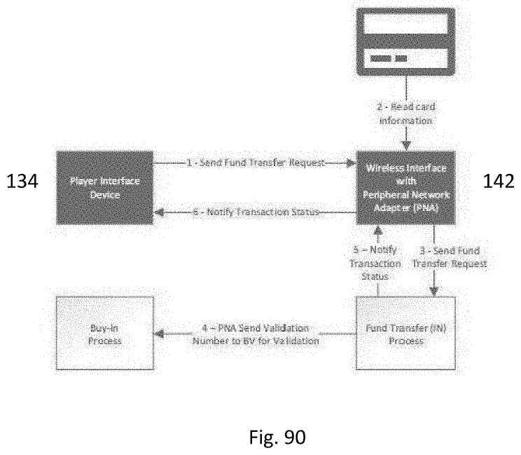

FIG. 90 shows a configuration where the player uses a mobile device 110 to select funds from a Player Wallet System 114. The mobile device 110 transfers the funds to the wireless interface of the PNA 142 for redemption. The mobile device 110 uses wireless communication, such as NFC, Bluetooth, or Wi-Fi, to interface with the PNA 142. The Peripheral System contacts the Player Wallet System 114 and retrieves the player's account information including a list of available funds. The Peripheral System 130 sends the data to the PNA 142, which then sends it to the mobile device 110 through the wireless interface of the PNA 142, and the player can then select which funds to redeem.

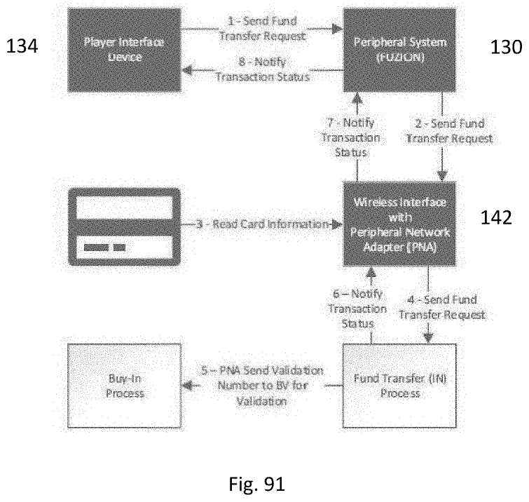

FIG. 91 shows a configuration where the player interface device 134 is connected to the Peripheral System 130.

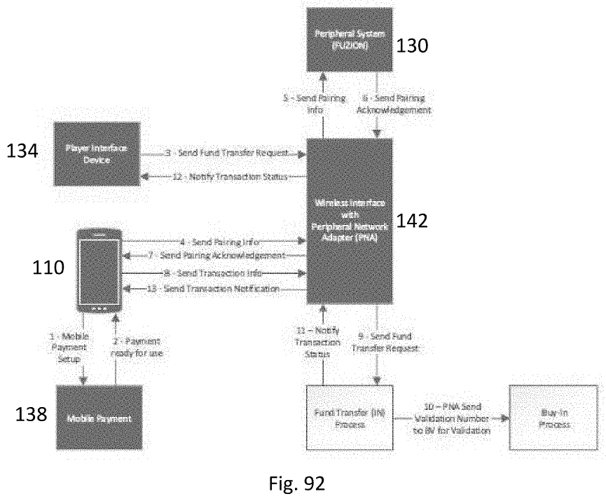

FIG. 92 shows a configuration where the player interface device 134 is connected to the PNA 142. In this embodiment, the player uses a contactless payment service 138, such as Apple Pay, Google Pay, etc., on a mobile device 110 to perform a transfer with the wireless interface of the PNA 142.

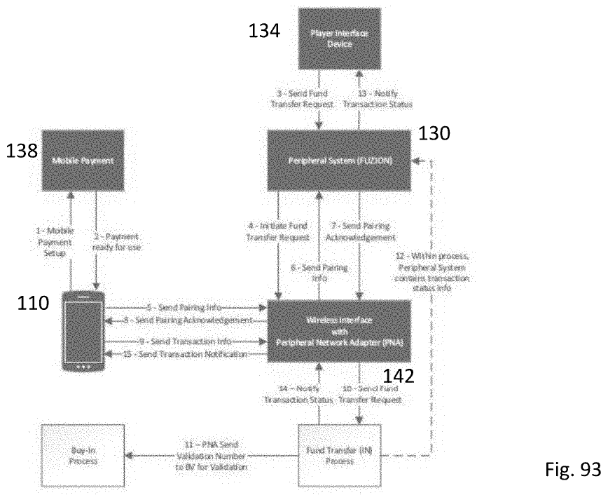

FIG. 93 shows a configuration where the player interface device 134 is connected to the Peripheral System 130.

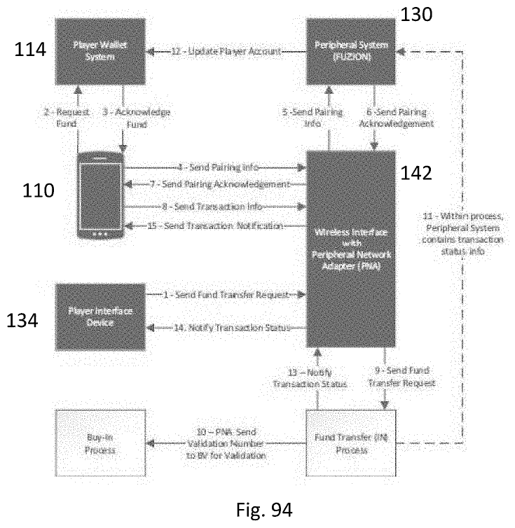

FIG. 94 shows a configuration where the player interface device 134 is connected to the PNA 142. In this embodiment, the player uses a mobile device 110 to select funds from a Player Wallet System 114. The mobile device 110 transfers the funds to the wireless interface of the PNA for redemption.

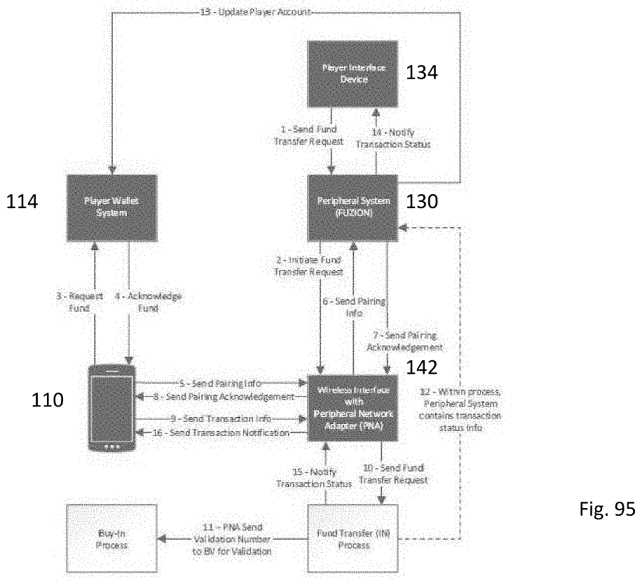

FIG. 95 shows a configuration where the player interface device 134 is connected to the Peripheral System 130.

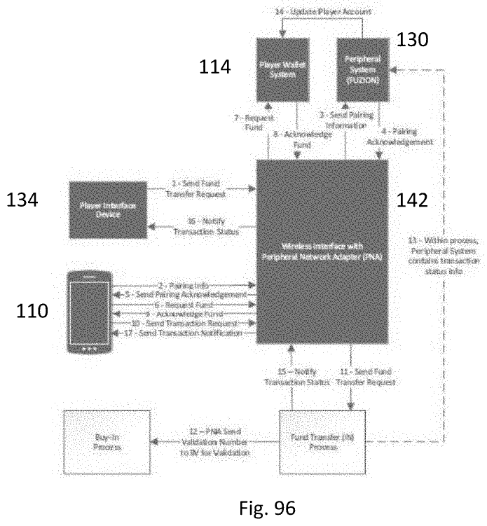

FIG. 96 shows a configuration where the player interface device 134 is connected to the Peripheral System 130. In this embodiment, the player uses a mobile device 110 to select funds from a Player Wallet System 114. The mobile device transfers the funds to the wireless interface of the PNA 142 for redemption.

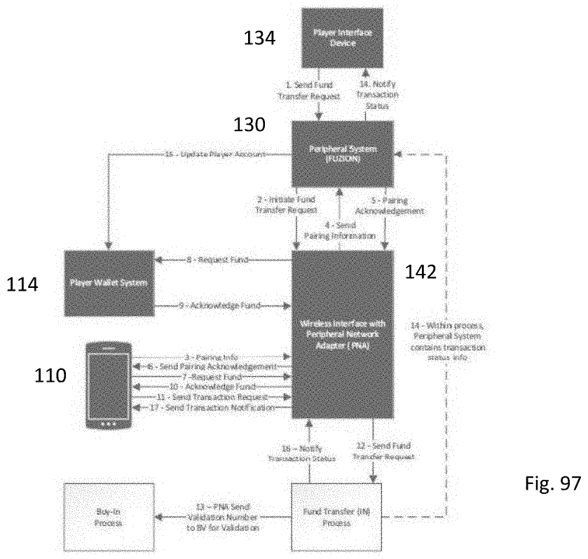

FIGS. 97-99 show configurations where the player interface device 134 is connected to the Peripheral System 130.

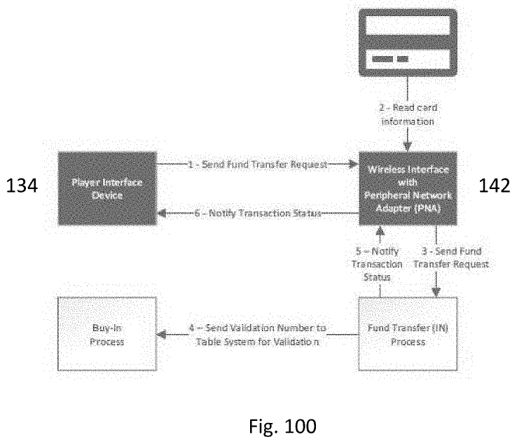

FIG. 100 shows a configuration where the player interface device 134 is connected to the PNA 142. In this embodiment, the player uses the wireless interface of the PNA 142 to transfer funds using a card payment with NFC, RFID, magnetic stripe, smart chip, etc. As shown, the Peripheral System 130 sends the virtual TITO ticket information to the CTG System 150 for validation. The dealer then confirms the transaction on the CTG System 150 and distributes gaming chips to the player.

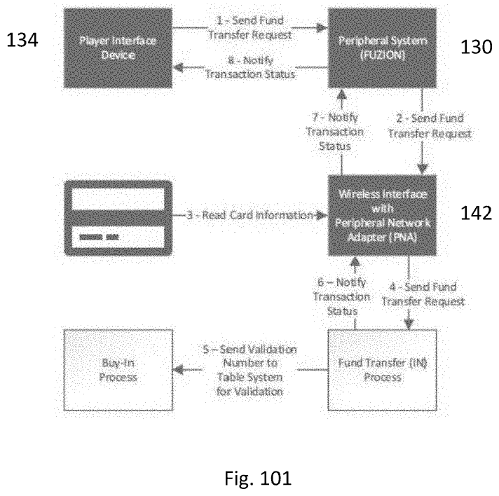

FIG. 101 shows a configuration where the player interface device 134 is connected to the Peripheral System 130.

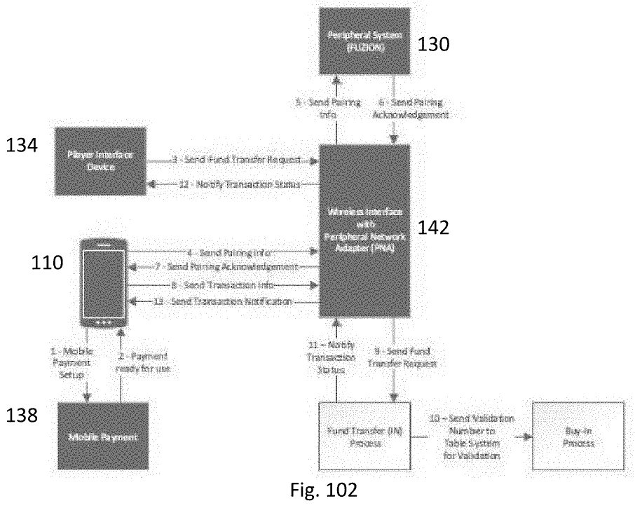

FIG. 102 shows a configuration where the player interface device 134 is connected to the PNA 142. In this embodiment, the player uses a contactless payment service 138, such as Apple Pay, Google Pay, etc., on a mobile device 110 to perform a transfer with the wireless interface of the PNA 142.

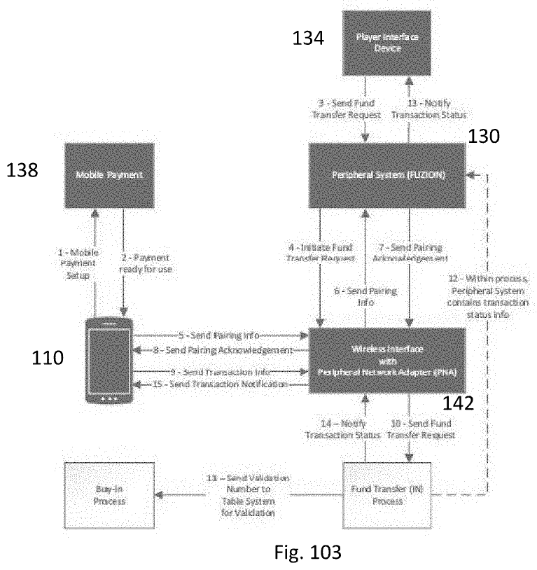

FIG. 103 shows a configuration where the player interface device 134 is connected to the Peripheral System 130.

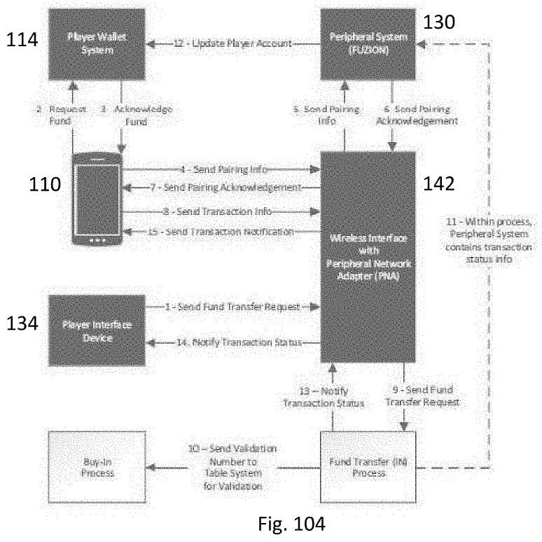

FIG. 104 shows a configuration where the player interface device 134 is connected to the PNA 142. In this embodiment, the player uses a mobile device 110 to select funds from a Player Wallet System 114. The mobile device 110 transfers the funds to the wireless interface of the PNA 142 for redemption. The mobile device 110 uses a network, such as Wi-Fi, cellular, Bluetooth, etc., to contact the Player Wallet System 114 and retrieve the player's account information including a list of available funds. The player can then select which funds to redeem.

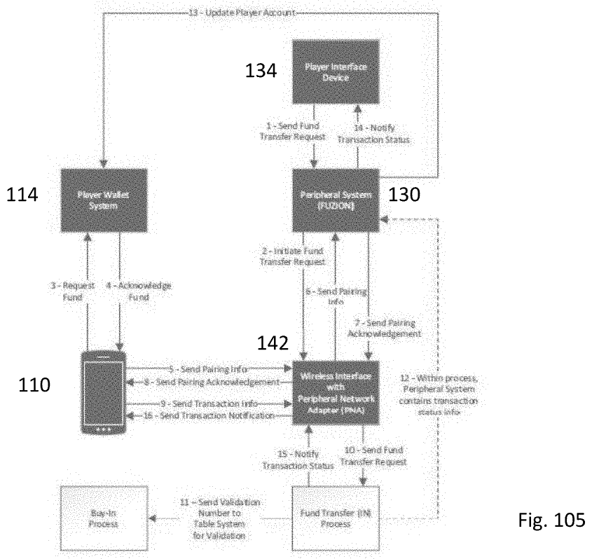

FIG. 105 shows a configuration where the player interface device 134 is connected to the Peripheral System 130.

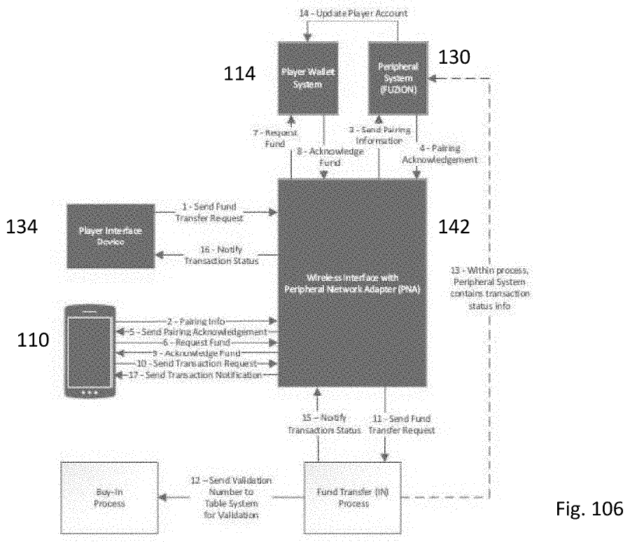

FIG. 106 shows a configuration where the player interface device 134 is connected to the PNA 142. In this embodiment, the player uses a mobile device to select funds from a Player Wallet System. The mobile device transfers the funds to the wireless interface of the PNA 142 for redemption. The mobile device 110 uses wireless communication, such as NFC, Bluetooth, or Wi-Fi, to interface with the PNA 142.

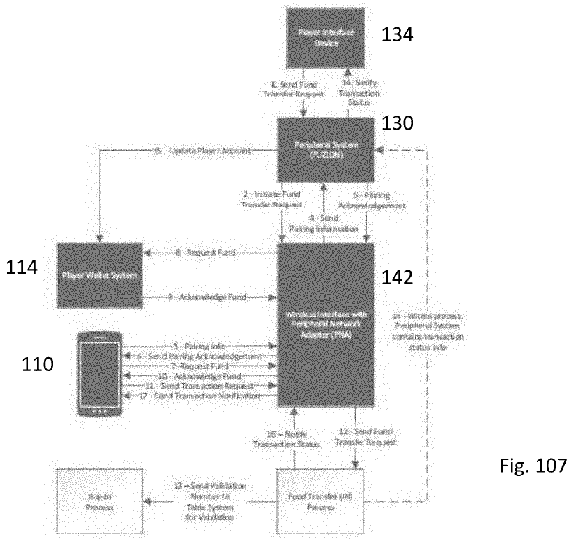

FIG. 107 shows a configuration where the player interface device 134 is connected to the Peripheral System 130.

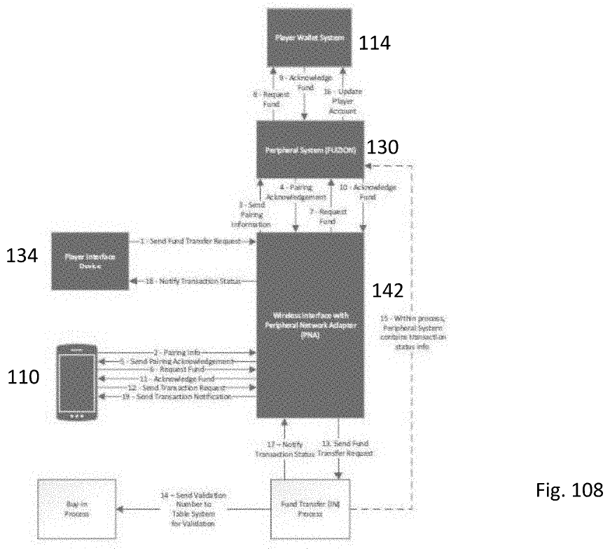

FIG. 108 shows a configuration where the player interface device 134 is connected to the PNA 142. In this embodiment, the player uses a mobile device to select funds from a Player Wallet System 114. The mobile device 110 transfers the funds to the wireless interface of the PNA 142 for redemption. The mobile device 142 uses wireless communication, such as NFC, Bluetooth, or Wi-Fi, to interface with the PNA 142.

FIG. 109 shows a configuration where the player interface device 134 is connected to the Peripheral System 130.

### Buy-In Process Options

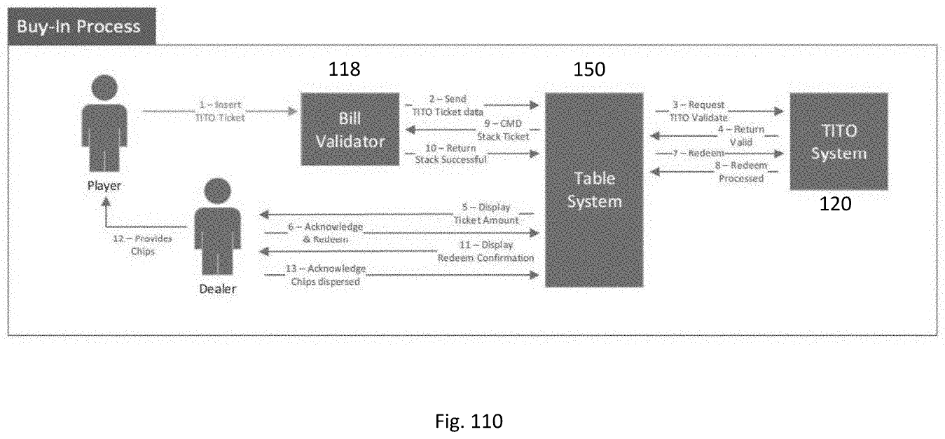

FIGS. 110-144 show system configurations for the buy-in process.

FIGS. 110-127 show instances where a physical TITO ticket is processed through the BV 118 and where the dealer confirms and allocates the correct amount of gaming chips to the player.

FIG. 110 shows a process where the CTG System 150 is connected directly to the TITO System 120 to verify the TITO ticket. In this embodiment, there is no Player Wallet System 114 to handle a virtual TITO ticket, so a dealer must cash out the entire ticket.

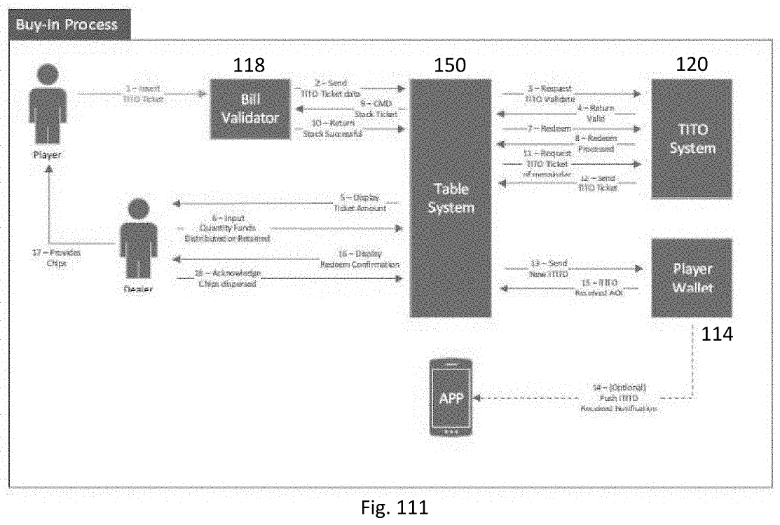

FIG. 111 shows a process where the CTG System 150 is connected directly to the TITO System 120 and the Player Wallet System 114, to accept a virtual TITO ticket. The virtual TITO ticket may be made up of the difference between the value of gaming chips taken by the player and the value of the player's TITO ticket.

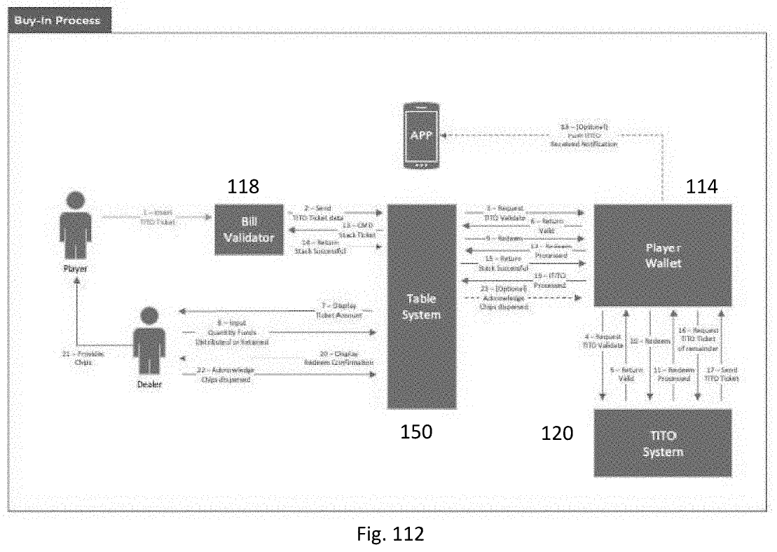

FIG. 112 shows a process where the CTG System 150 is not connected directly to the TITO System 120. Instead, the CTG System 150 communicates with the TITO System 120 through the Player Wallet System 114. Accordingly, the Player Wallet System 114 allows the player to buy in using a physical TITO ticket even when the dealer does not have exact change.

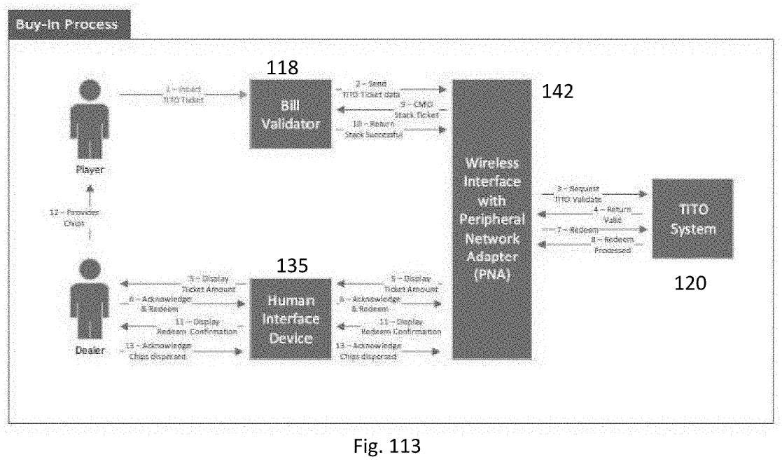

FIG. 113 shows a process where the PNA 142 is connected to the TITO System 120 directly. There is no Player Wallet System 114 to handle virtual TITO tickets such that the dealer must have exact change or accept TITO tickets with an appropriate table denomination.

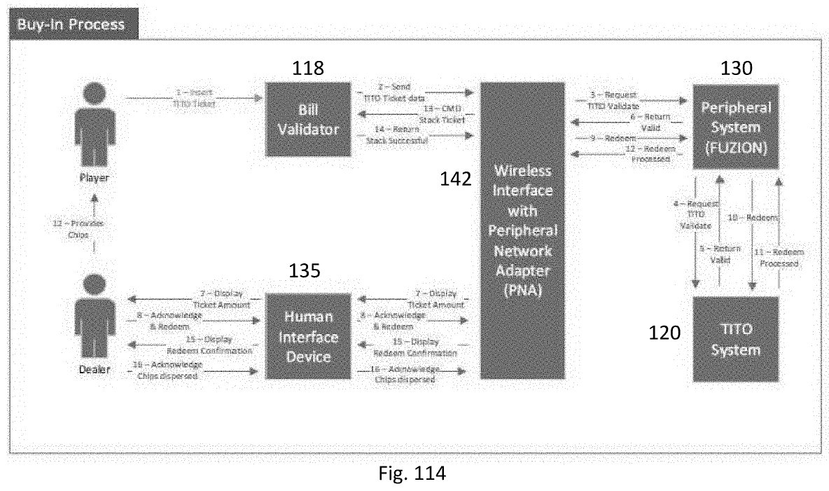

FIG. 114 shows a process where the PNA 142 is not connected directly to the TITO System 120. Instead, the PNA 142 communicates with the TITO System 120 through the Peripheral System 130. This process does not have a connection to a Player Wallet System so the dealer must have exact change or only receive TITO tickets with an appropriate denomination for the table.

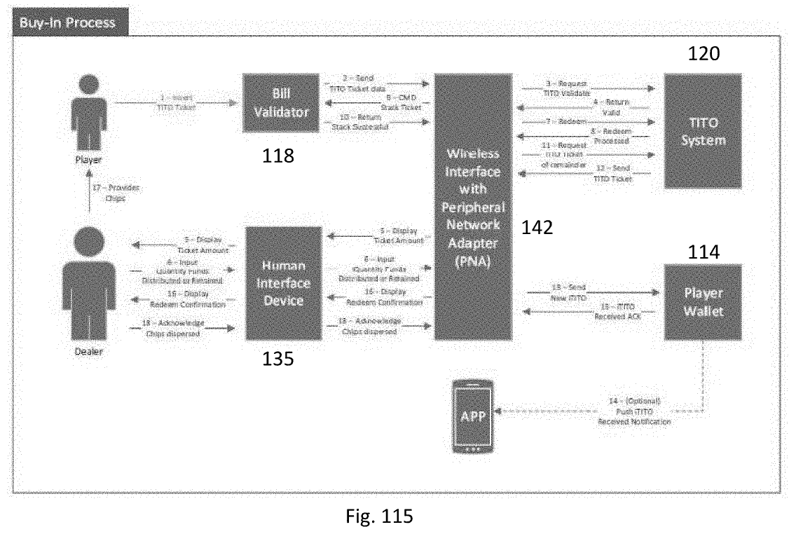

FIG. 115 shows a process where the PNA 142 is connected directly to the TITO System 120 in parallel with a Player Wallet System 114. The Player Wallet System 114 allows for partial redemption of a physical TITO ticket, with any excess being stored as a virtual TITO ticket in the player's mobile wallet.

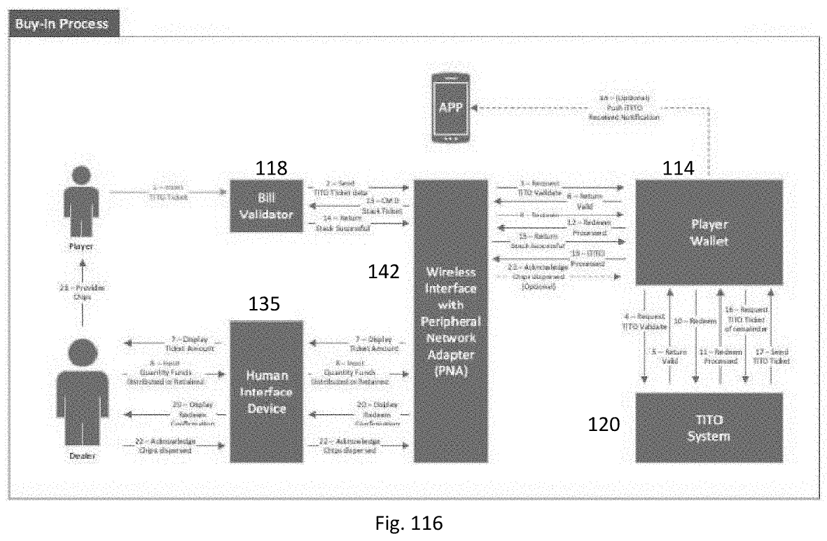

FIG. 116 shows a process where the PNA 142 communicates with the TITO System 120 through the Player Wallet System 114.

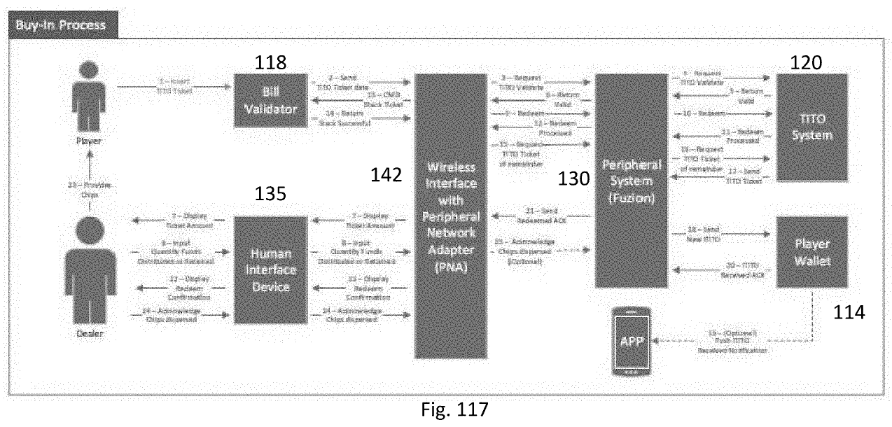

FIG. 117 shows a process where the PNA 142 communicates with a Peripheral System 130 that then communicates with the TITO System 120 and the Player Wallet System 114.

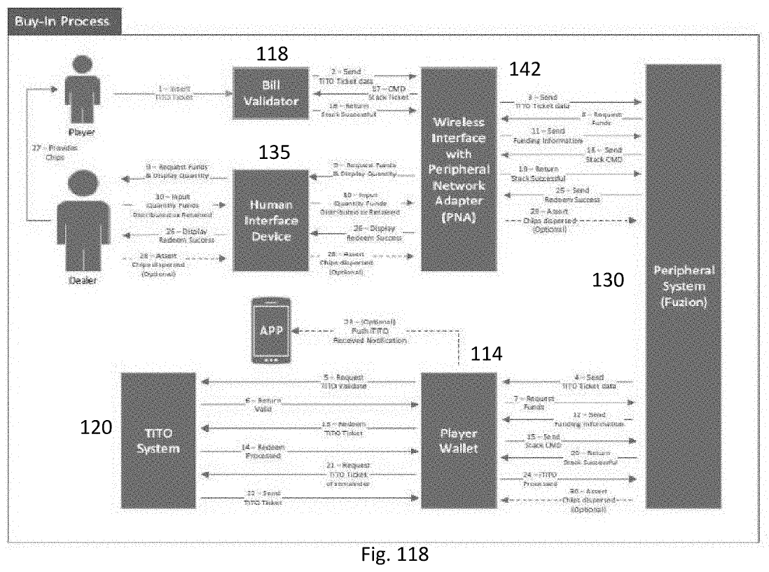

FIG. 118 shows a process where communication with the TITO System 120 from the BV 118 goes through the PNA 142 to the Peripheral System 130 and then through a Player Wallet System 114.

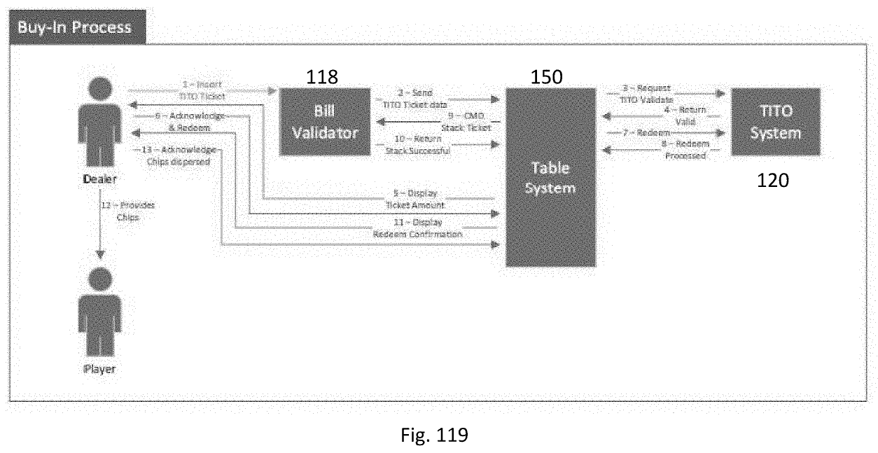

FIG. 119 shows a process where the dealer needs to insert the physical TITO ticket into the BV 118 for verification, and upon verification, allocates the total value of the ticket to the player. Either the dealer has change for making up any difference, or the value of the ticket can be provided with only the available gaming chips at the gaming table. All validation is done through the BV 118 and CTG System 150 communicating with the TITO System 120.

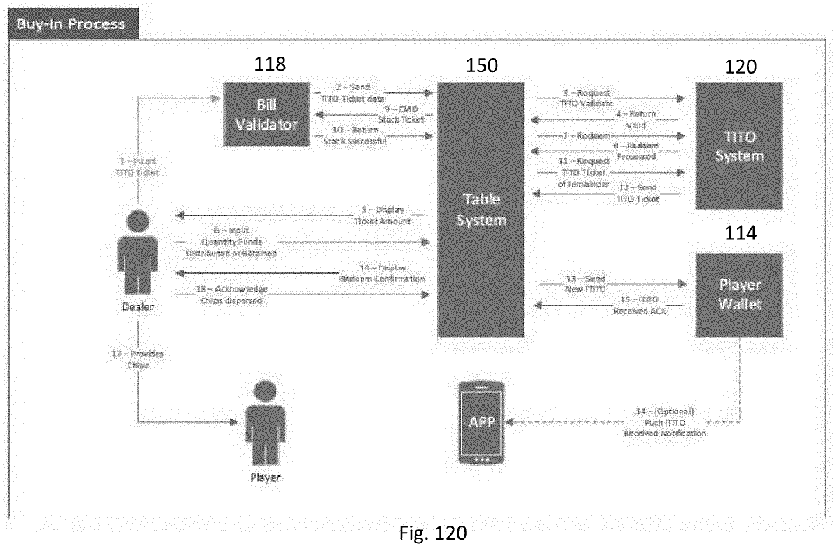

FIG. 120 shows a process where the dealer inserts the TITO ticket into the BV 118. The inclusion of the Player Wallet System 114 allows a buy-in involving portions of the TITO ticket whereby any remaining value is transmitted to the Player Wallet System 114 in the form of a virtual TITO ticket. This process shows the Player Wallet System 114 and the TITO System 120 in direct communication with the CTG System 150.

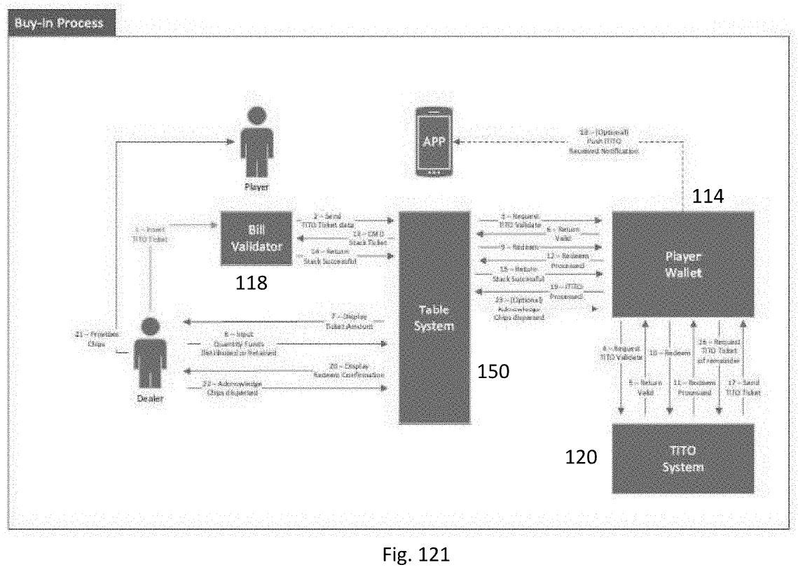

FIG. 121 shows a process where the CTG System 150 communicates with the TITO System 120 through the Player Wallet System 114. This reduces the number of places a virtual TITO ticket is held before being placed into the Player Wallet System 114.

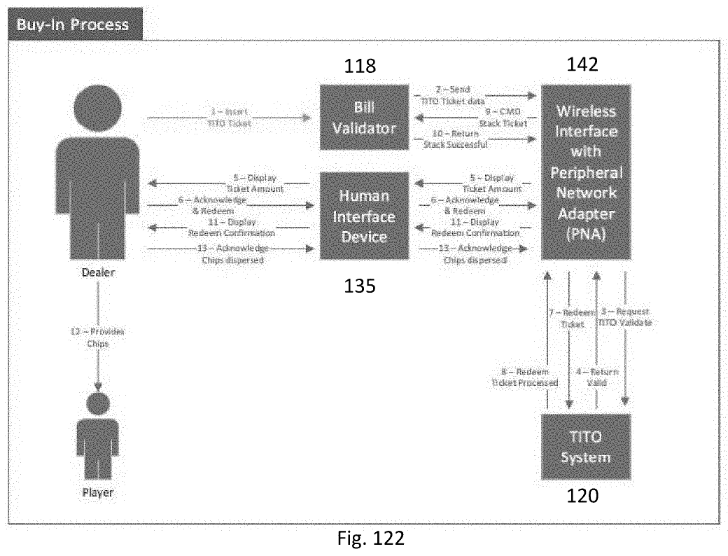

FIG. 122 shows a process where the dealer inserts the TITO ticket into the BV 118 and allocates the exact value of the TITO ticket to the player. Either the dealer has change for making up the difference or the value of the TITO ticket is redeemed using available gaming chips at the table. All validation is done through the BV 118 and a PNA 142 in communication with the TITO System 120.

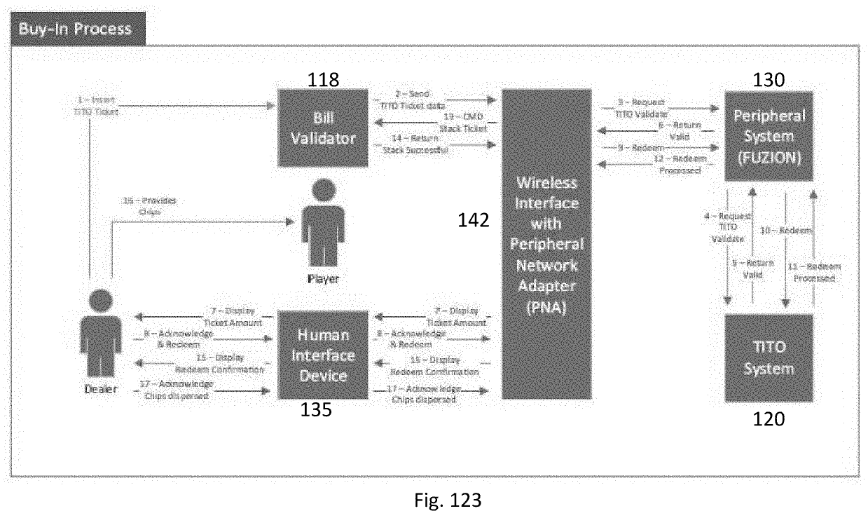

FIG. 123 shows a process similar to that shown in FIG. 122 expect the PNA 142 acts as a bridge to the Peripheral System 130 which acts as a host for the BV 118 with all communications accomplished through the Peripheral System 130.

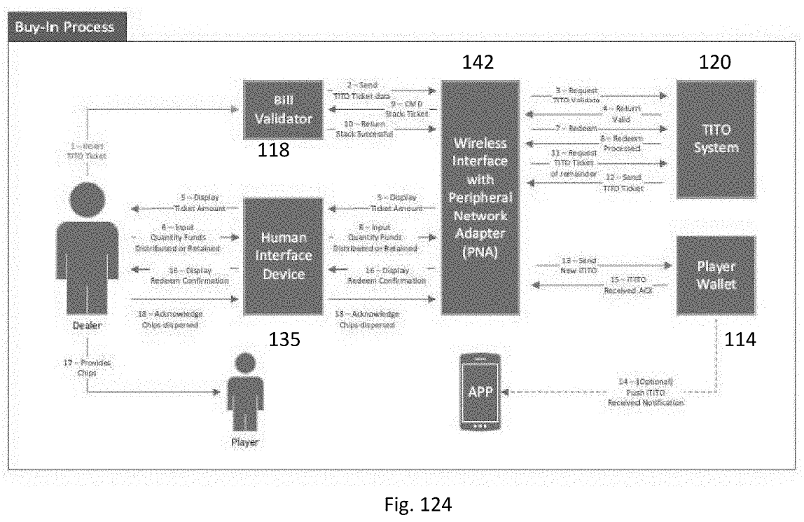

FIG. 124 shows a process where the Player Wallet System 114 handles partial TITO ticket redemptions. The Player Wallet System 114 and the TITO System 120 are both connected directly to the PNA 142 with the PNA 142 acting as the host for the BV 118.

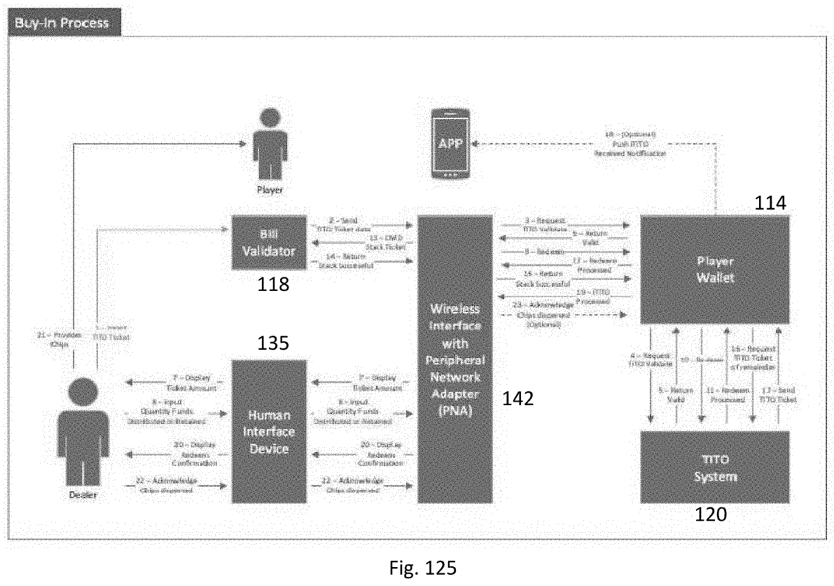

FIG. 125 shows a process where the PNA 142 and the TITO System 120 communicate through the Player Wallet System 114. The host for the BV 118 may be the PNA 142 or Player Wallet System 114 through the PNA 142.

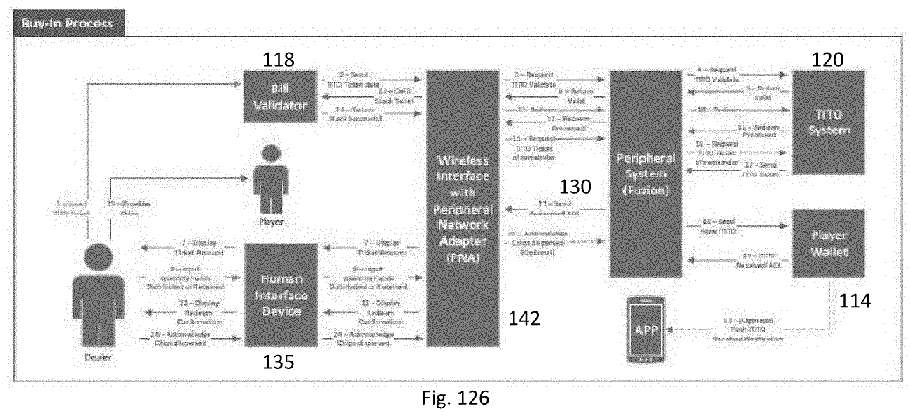

FIG. 126 shows a process where the TITO System 120 and the Player Wallet System 114 are in parallel with the Peripheral System 130 between them and the PNA 142.

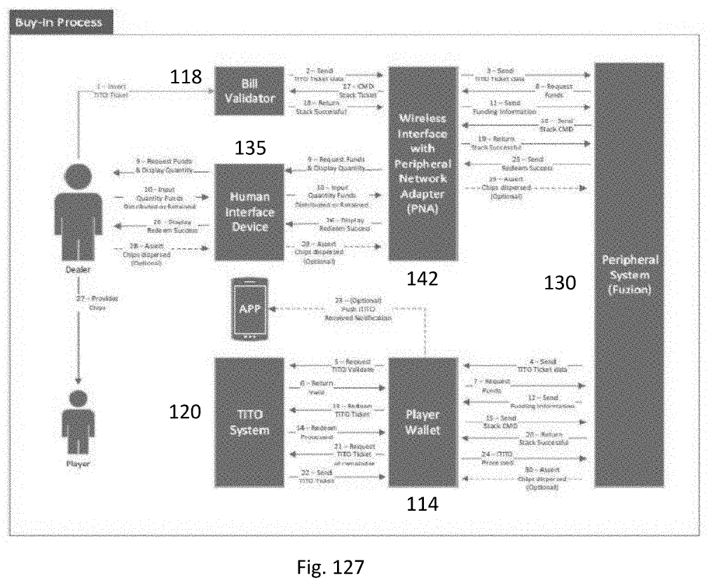

FIG. 127 shows a process where the PNA 142 facilitates communication between the BV 118, the dealer and the Peripheral System 130. In this embodiment, the Peripheral System 130 acts as the bridge to the Player Wallet System 114 and the Player Wallet System 114 a bridge to the TITO System 120. All tickets get inserted into the BV 118 and passed to Peripheral System 130 through the PNA 142 where the Peripheral System 130 then requests that the Player Wallet System 114 communicates with the TITO System 120.

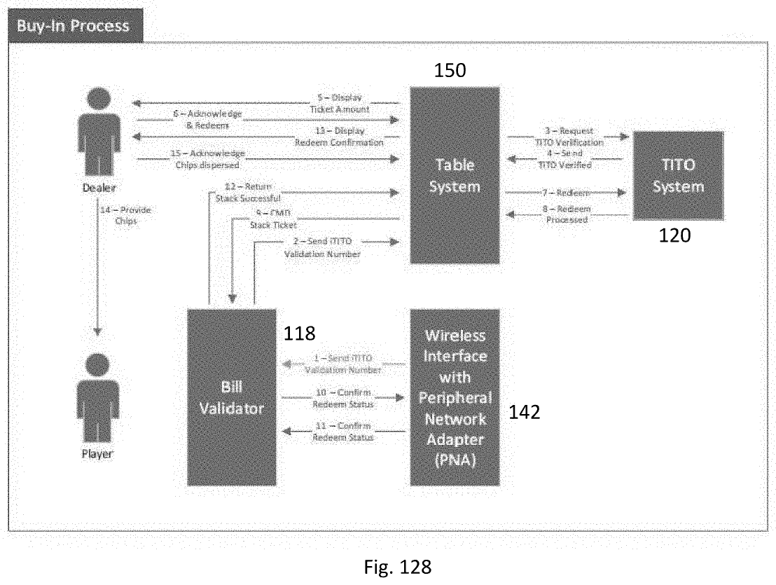

FIGS. 128-136 show instances where the PNA 142 sends a virtual TITO ticket (virtual validation number) to the BV 118. The BV 118 communicates with the CTG System 150 in a manner so that the CTG System 150 is not able to distinguish between a physical TITO ticket being inserted into the BV 118 and the virtual TITO ticket (virtual validation number).

FIG. 128 shows a process where the TITO System 120 is connected directly to the CTG System 150.

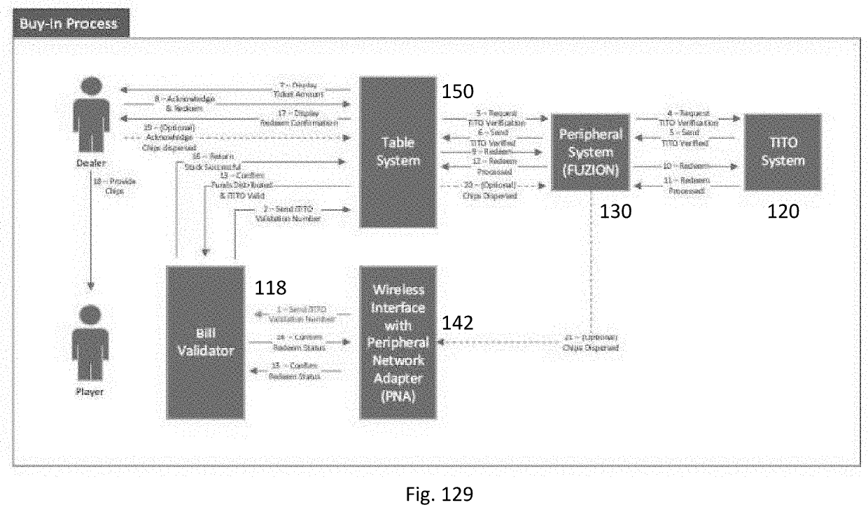

FIG. 129 shows a process where the CTG System 150 is connected to the Peripheral System 130 and that Peripheral System 130 communicates with the TITO System 150.

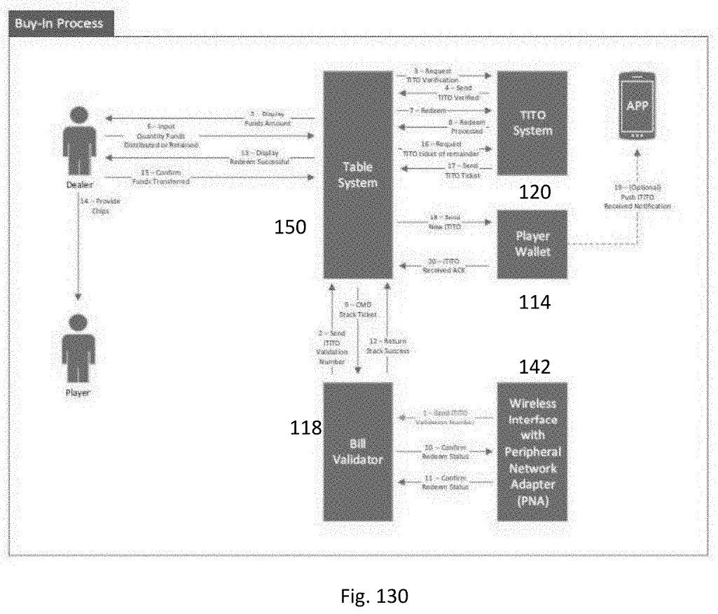

FIG. 130 shows a process where the gaming chips are distributed prior to the virtual TITO ticket being processed. As shown, the TITO System 120 and the Player Wallet System 114 are connected to the CTG System 150 either directly, or through one another, but not through the Peripheral System 130. When the TITO System 120 and the Player Wallet System 114 are connected to the CTG System in parallel, each has direct communication to the CTG System 15, but when connected in serial, the Player Wallet System 114 resides between the TITO System 120 and the CTG System 150.

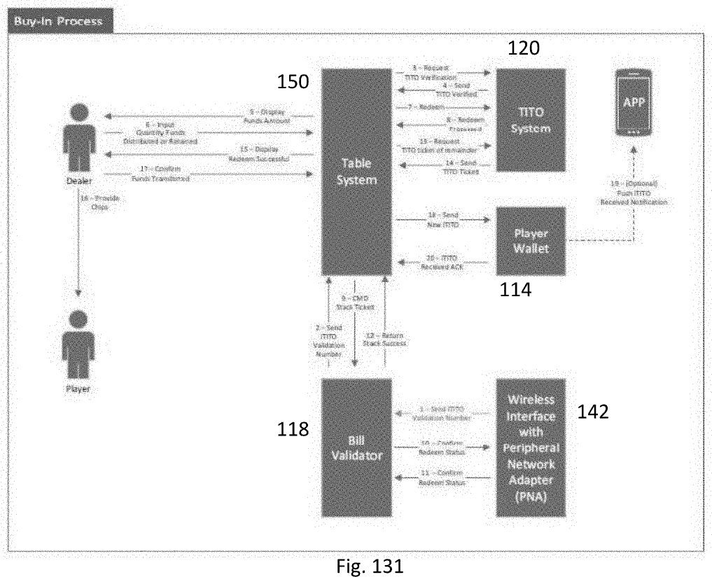

FIG. 131 shows a process where the gaming chips are distributed during the processing of the virtual TITO ticket. The TITO system 120 passes the virtual TITO ticket information to the CTG System 150, the CTG System 150 informs the dealer to provide gaming chips, and once the dealer has provided the gaming chips, the CTG System 150 passes the virtual TITO ticket to the Player Wallet System 114.

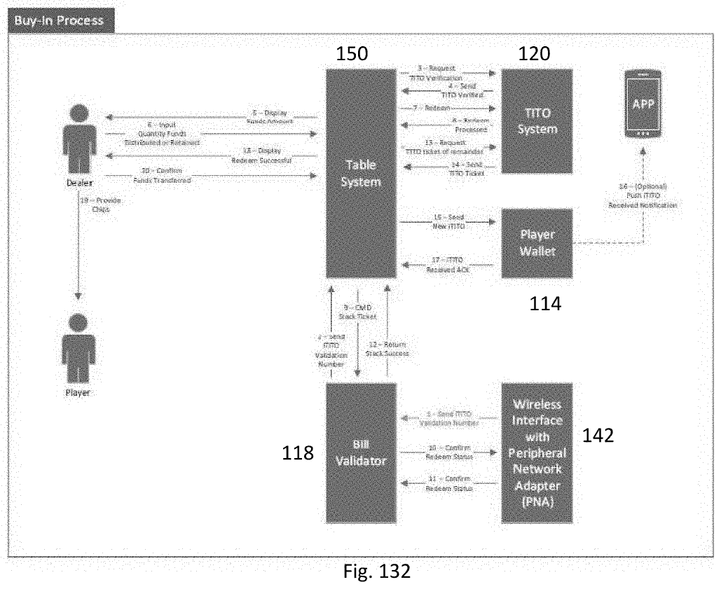

FIG. 132 shows a process where the CTG System 150 requests a virtual TITO ticket for any remaining value after redeeming the original virtual TITO ticket. Before instructing the dealer to distribute the gaming chips, the CTG System 150 passes the virtual TITO ticket for any remaining value to the Player Wallet System 114. Only once the virtual TITO ticket has been accepted by the Player Wallet System 114 does the CTG System 150 instruct the dealer to distribute gaming chips to the player.

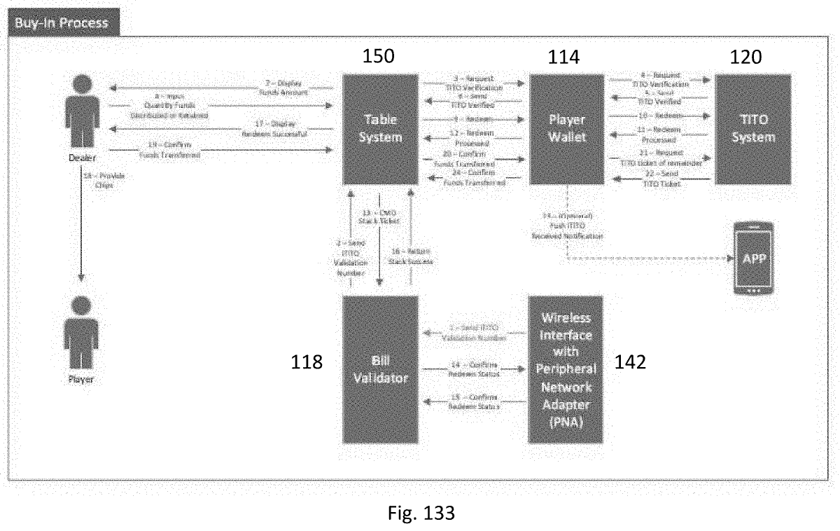

FIG. 133 shows a process where the gaming chips are distributed before the CTG System 150 requests a virtual TITO ticket for any remaining value.

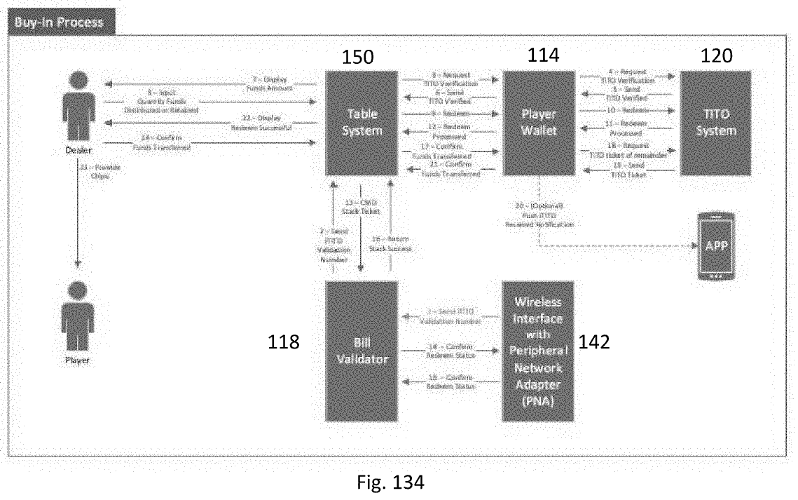

FIG. 134 shows a process where the gaming chips are distributed only after the Player Wallet System 114 receives a virtual TITO ticket for any remaining value.

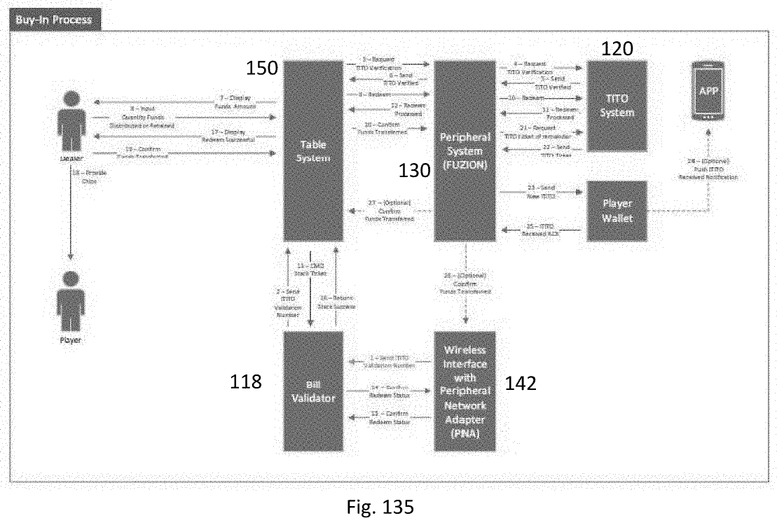

FIG. 135 shows a process where the TITO System 120 and the Player Wallet System 114 are connected to the Peripheral System 130 in parallel. All communications between the CTG System 150 and the TITO System 120 and Player Wallet System 120 is accomplished through the Peripheral System 130.

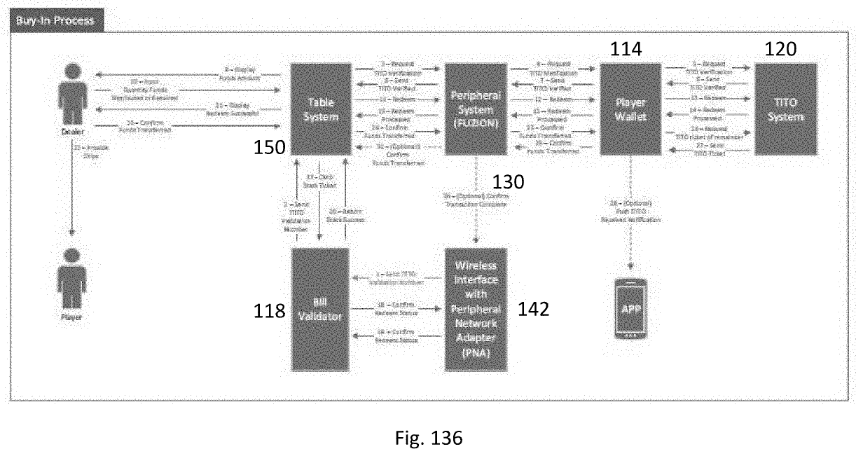

FIG. 136 shows a process where the TITO System 120 and the Player Wallet System 114 are connected to the Peripheral System 130 in series. All communication between the CTG System 150 and the TITO System 120 must therefore go through both the Player Wallet System 114 and the Peripheral System 130.

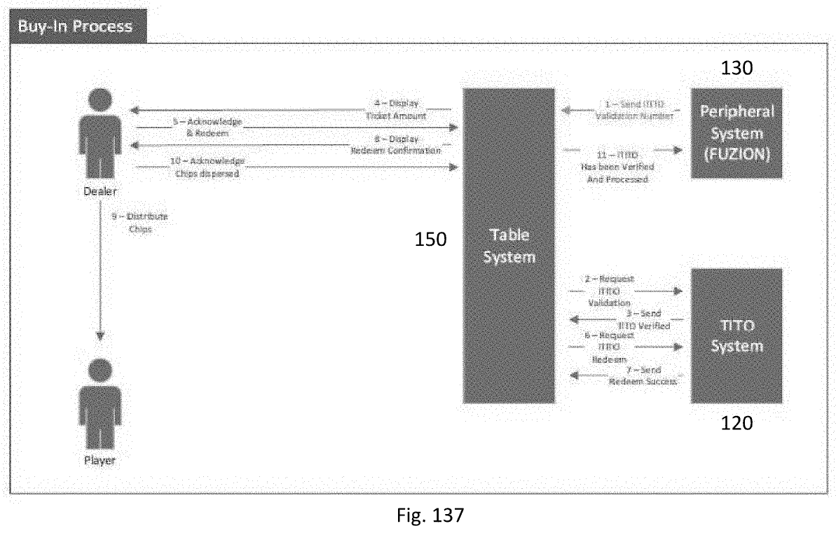

FIGS. 137-144 show instances where the virtual TITO ticket validation number is given to the CTG System 150 for verification by the Peripheral System 130.

FIG. 137 shows a process where a virtual TITO ticket validation number is provided to the CTG System 150 for verification by the Peripheral System 130.

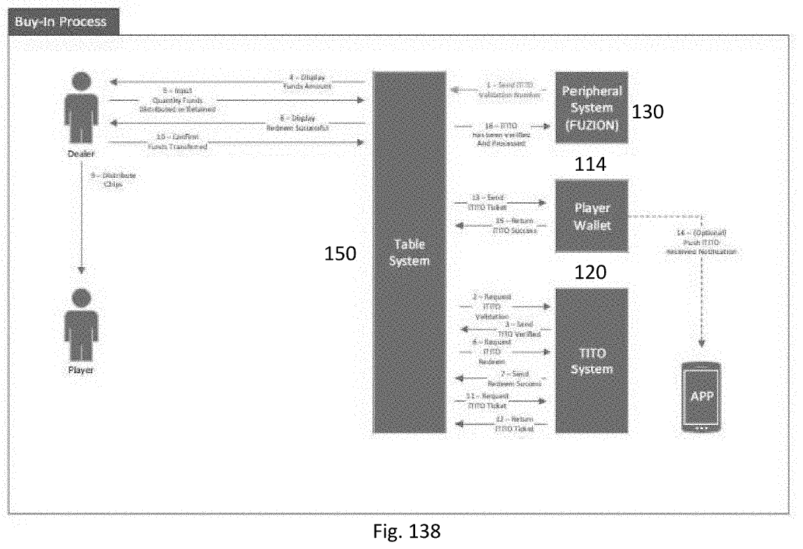

FIG. 138 shows a process where the CTG System 150 instructs the dealer to distribute the gaming chips before the virtual TITO ticket for any remaining value is requested from the TITO System 120.

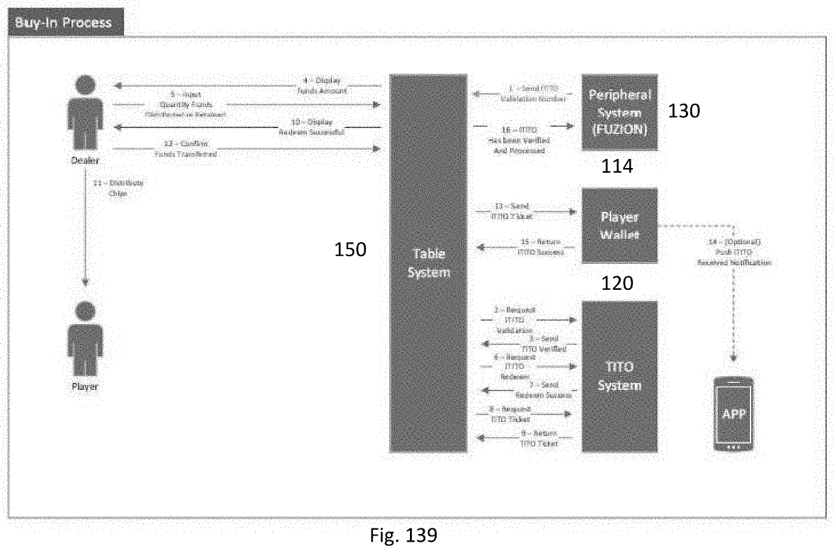

FIG. 139 shows a process where the CTG System 150 instructs the dealer to distribute the gaming chips before the virtual TITO ticket for the remaining value is transmitted to the Player Wallet System 114.

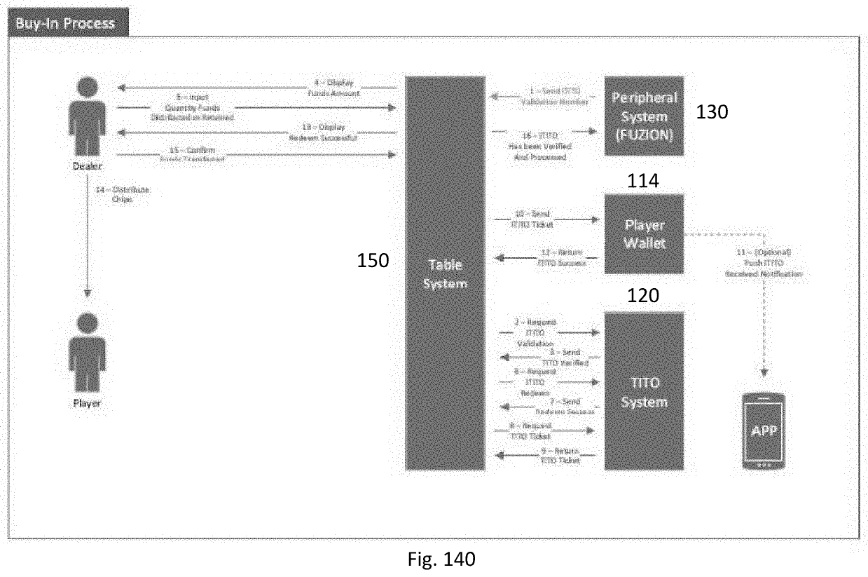

FIG. 140 shows a process where the CTG System 150 instructs the dealer to distribute the gaming chips only once the virtual TITO ticket for the remaining value has been transmitted to the Player Wallet System 114.

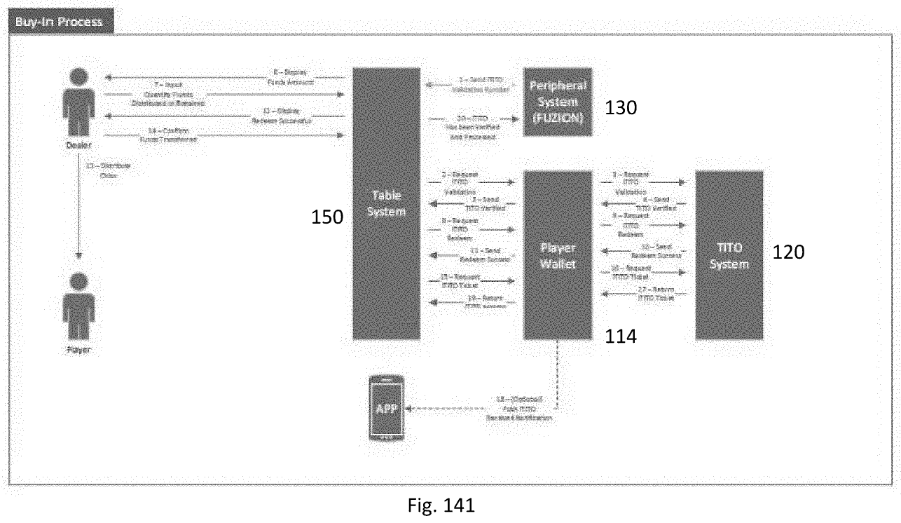

FIG. 141 shows a process where the virtual TITO ticket with any remaining value from an original TITO ticket is not requested until after the gaming chips have been distributed to the player.

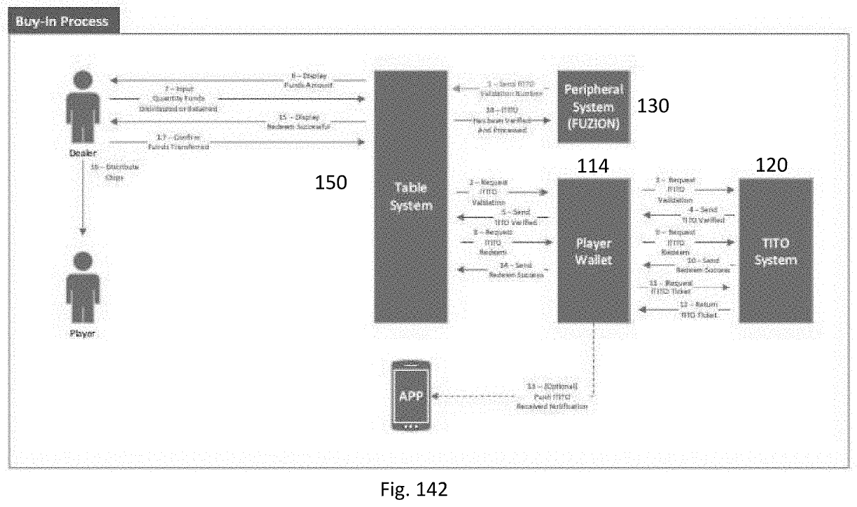

FIG. 142 shows a process where the virtual TITO ticket with any remaining value from a TITO ticket is requested by the Player Wallet System 114 before a redeem response for the original TITO ticket is returned to the CTG System 150.

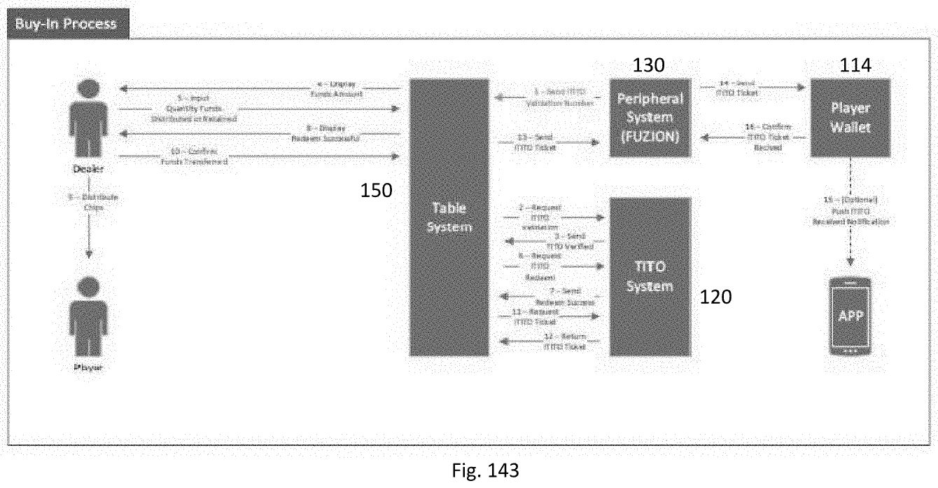

FIG. 143 shows a process where the virtual TITO ticket with any remaining balance from an original TITO ticket is transmitted to the Player Wallet System 114 only once the gaming chips have been distributed to the player.

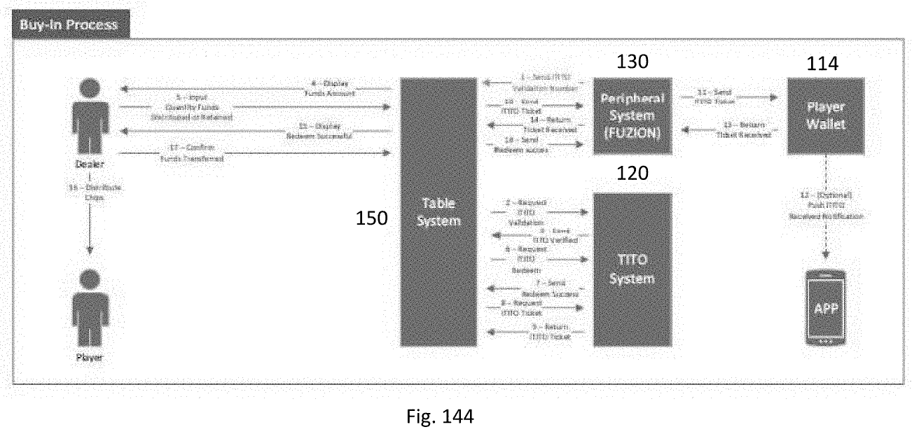

FIG. 144 shows a process where the virtual TITO ticket with any remaining value from the original TITO ticket is transmitted to the Player Wallet System 114 before the gaming chips have been distributed to the player.

### Cash Out Options

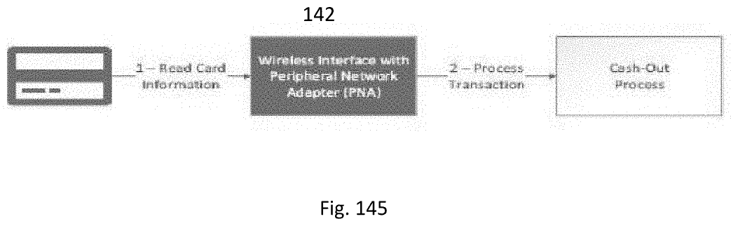

FIGS. 145-165 illustrate block diagrams of various cash out use cases according to the embodiments of the present invention.

FIGS. 145-149 show instances where a preset amount is used for each fund transfer. The preset amount can be configured in the Peripheral System 130 and/or PNA 142 by the table games operator.

FIG. 145 shows a system configuration where the player uses the wireless interface of the PNA 142 to transfer a preset amount of funds using a card payment with NFC, RFID, magnetic stripe, smart chip, etc.

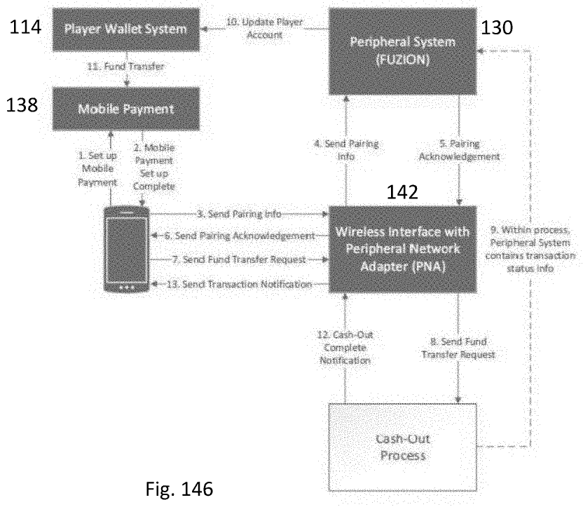

FIG. 146 shows a system configuration where the player uses a contactless payment service 138, such as Apple Pay, Google Pay, etc., on their mobile device 110 and tap it to the Wireless Interface to transfer a preset amount of funds.

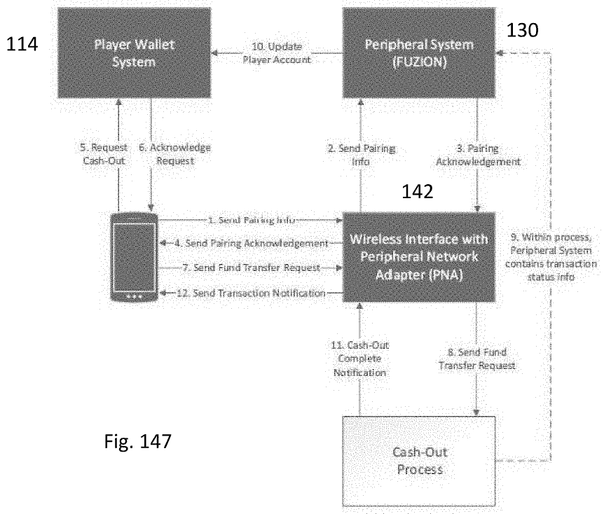

FIG. 147 shows a system configuration where the mobile device 110 uses a network, such as Wi-Fi, cellular, Bluetooth, etc., to contact the Player Wallet System 114 and retrieve the player's account information. The player can then connect to the Peripheral System 130 via a wireless interface of the PNA 142 to initiate the deposit of funds into the Player Wallet System 114.

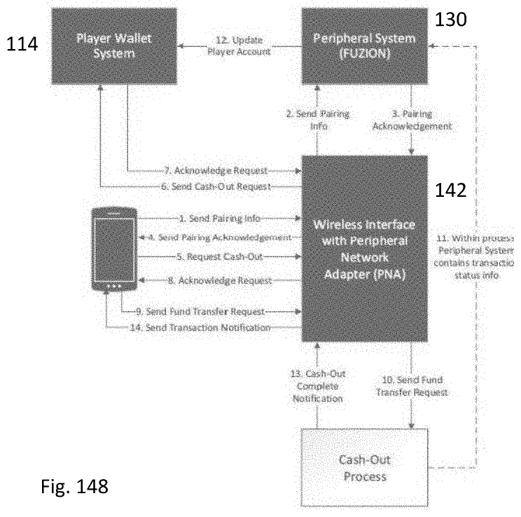

FIG. 148 shows a system configuration where the mobile device 110 uses wireless communication, such as NFC, Bluetooth, or Wi-Fi, to interface with the PNA 142. The PNA 142 contacts the Player Wallet System 114 and retrieves the player's account information. The PNA 142 then transmits the player's account information to the mobile device 110 through the wireless interface of the PNA 142 such that the player can then initiate the deposit of funds into the Player Wallet System 114.

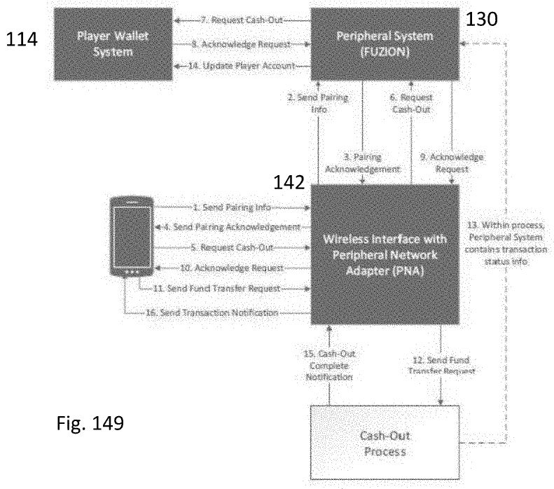

FIG. 149 shows a system configuration where the mobile device 110 uses wireless communication, such as NFC, Bluetooth, or Wi-Fi, to interface with the PNA 142. The Peripheral System 130 contacts the Player Wallet System 114 and retrieves the player's account information. The Peripheral System 130 transmits the data to the PNA 142 which then transmits it to the mobile device 110 through the wireless interface of the PNA 142, and the player can then initiate the deposit of funds into the Player Wallet System 114.

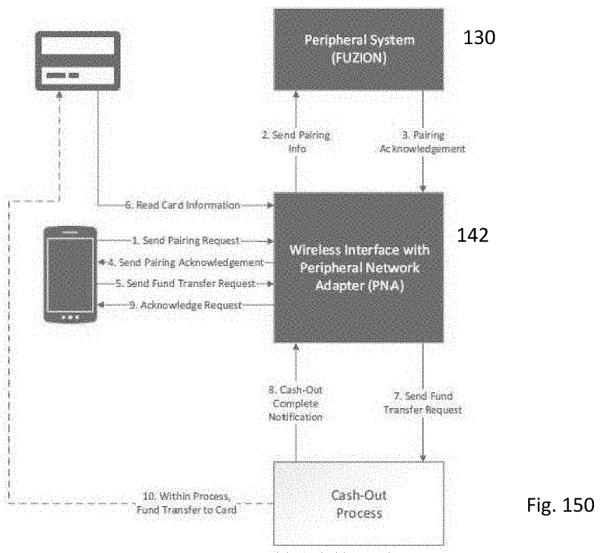

FIGS. 150-155 show instances where the player uses the mobile device 110 to select the transfer amount. The player then has a choice to use one or more payment methods including a card payment, phone configured to collect and transmit contactless card data, mobile payment and player wallet system.

FIG. 150 shows a system configuration where the player uses the wireless interface device of the PNA 142 to transfer funds using a card payment with NFC, RFID, magnetic stripe, smart chip, etc.

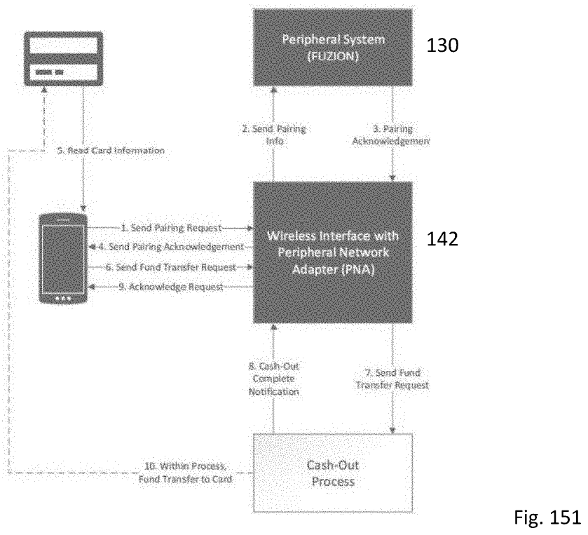

FIG. 151 shows a system configuration where the player uses a mobile device 110 to read credit card data and then perform a contactless transfer to the wireless interface of the PNA 142.

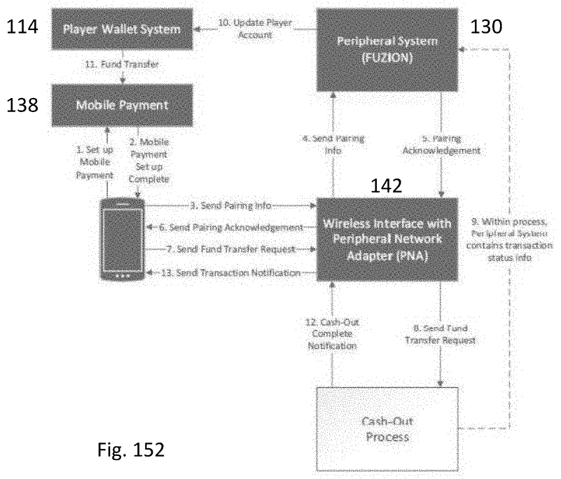

FIG. 152 shows a system configuration where the player uses a contactless payment service 138, such as Apple Pay, Google Pay, etc., on a mobile device 110 to perform a transfer with the wireless interface of the PNA 142.

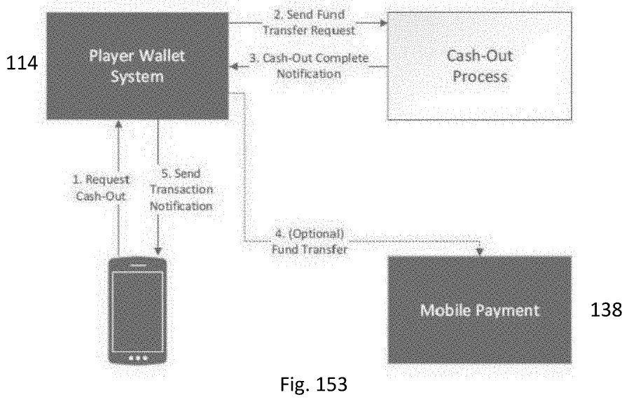

FIG. 153 shows a system configuration where the mobile device 110 uses a network, such as Wi-Fi, cellular, Bluetooth, etc., to contact the Player Wallet System 114 and retrieve the player's account information. The player can then select which funds to deposit.

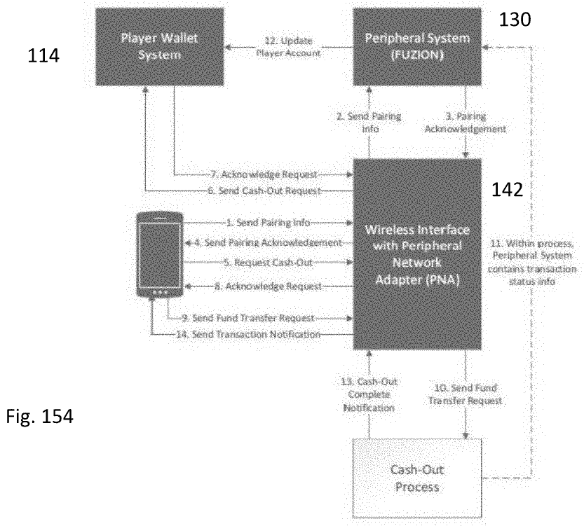

FIG. 154 shows a system configuration where the mobile device 110 uses wireless communication, such as NFC, Bluetooth, or Wi-Fi, to interface with the PNA 142. The PNA 142 contacts the Player Wallet System 114 and retrieves the player's account information. The PNA 142 then transmits the funds to the Player Wallet System 114 through the wireless interface of the PNA 142 so that the player can then select which funds to deposit.

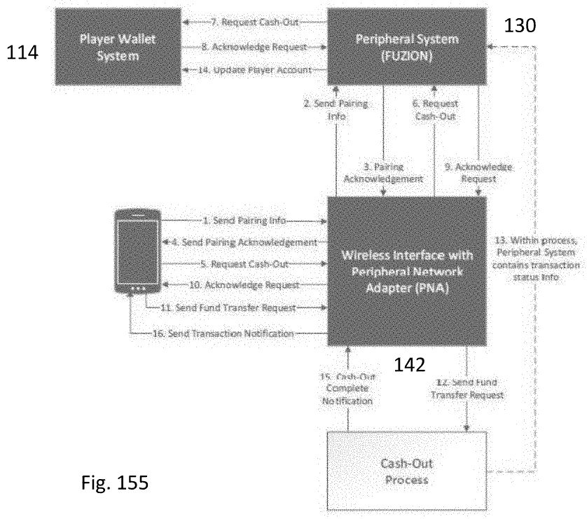

FIG. 155 shows a system configuration where the mobile device 110 uses wireless communication, such as NFC, Bluetooth, or Wi-Fi, to interface with the PNA 142. The Peripheral System 130 contacts the Player Wallet System 114 and retrieves the player's account information. The Peripheral System 130 transmits the data to the PNA 142 which then transmits it to the mobile device 110 through the wireless interface of the PNA 142 so that the player can then select which funds to deposit.

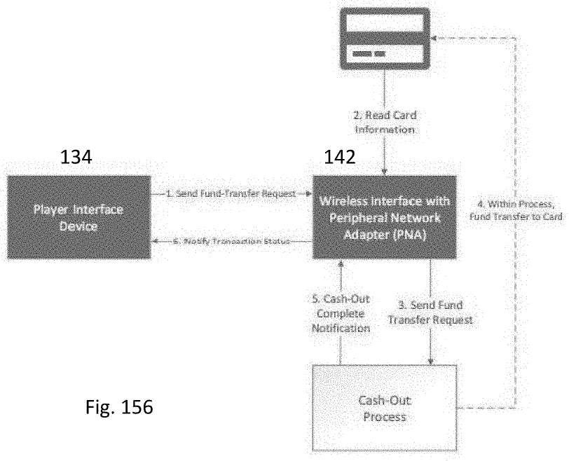

FIGS. 156-165 show instances where the user initiates a fund transfer on the Player Interface Device 134, such as a touchscreen, keypad, tablet, service window, etc. After selecting the fund transfer amount, the player has the choice to use one or more payment methods including card payment, mobile payment and player wallet system.

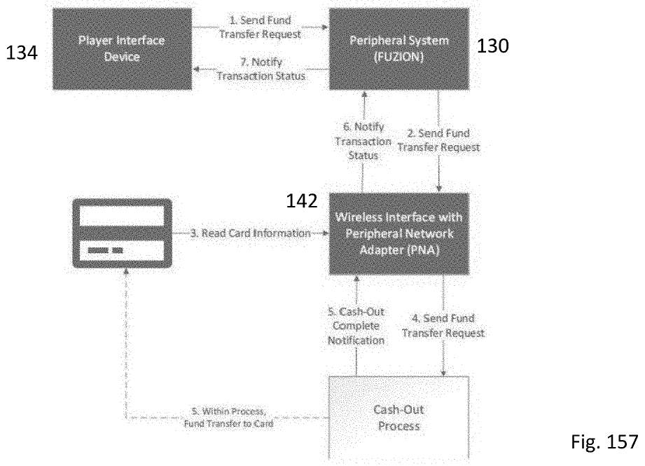

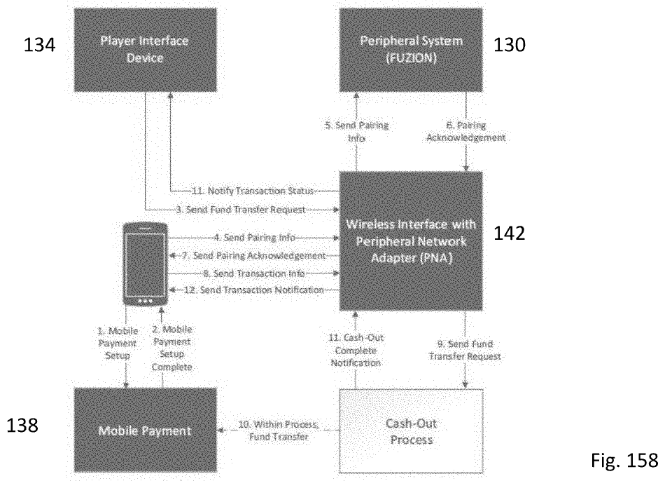

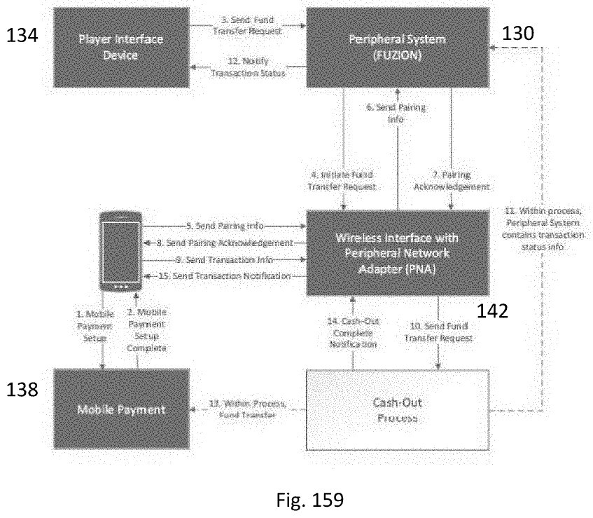

FIGS. 156 and 158 show a system configuration whereby the Player Interface Device 134 connected to the PNA 142. FIGS. 157 and 159 show the Player Interface Device 134 connected to the Peripheral System 130.

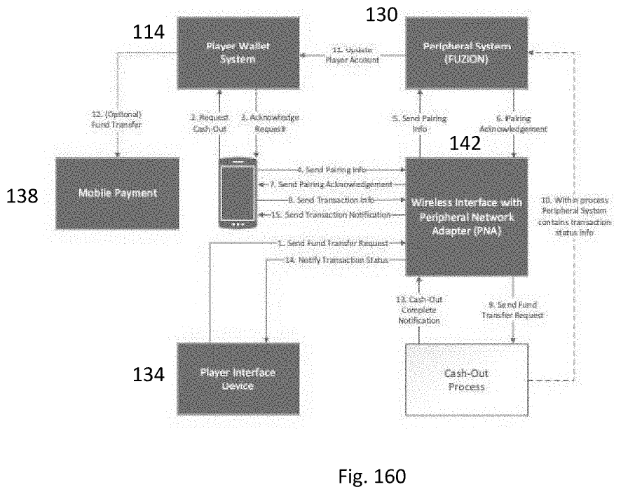

FIG. 160 shows a system configuration whereby the player uses the Player Interface Device 134 to select funds to deposit into a Player Wallet System 114 with the Player Interface Device 134 connected to the PNA 142.

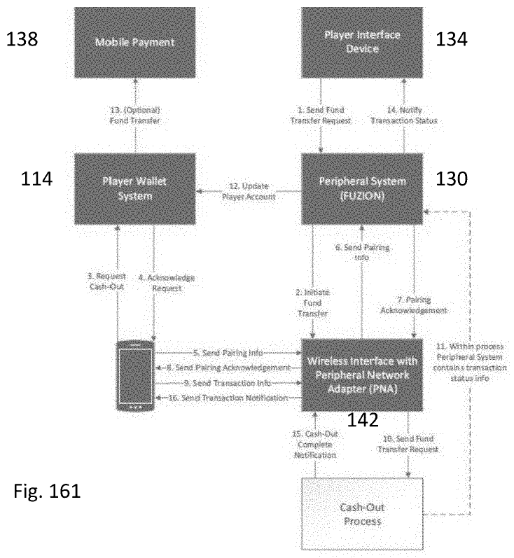

FIG. 161 shows a system configuration whereby the player uses the Player Interface Device 134 to select funds to deposit into a Player Wallet System 114 with the Player Interface Device 134 connected to the Peripheral System 130.

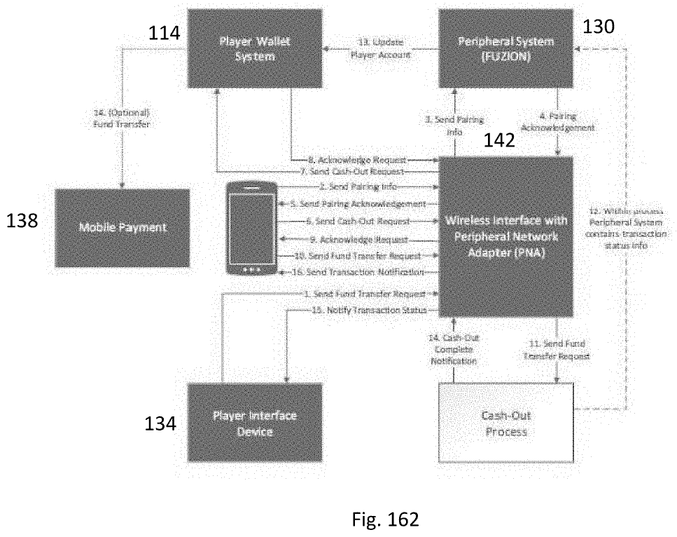

FIG. 162 shows a system configuration whereby the player uses a Player Interface Device 134 to select funds to deposit into a Player Wallet System 114. The mobile device 110 initiates the transfer of funds from the wireless interface of the PNA 142.

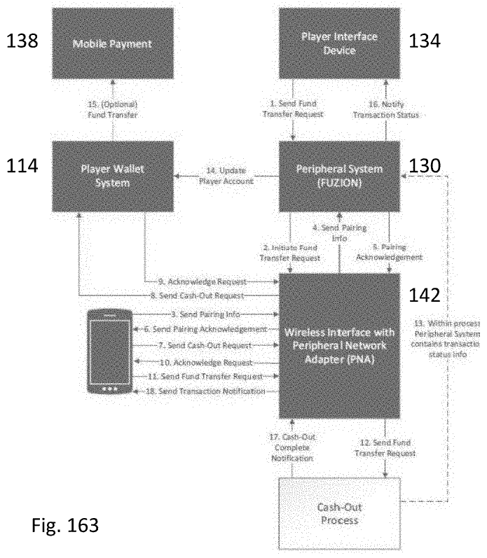

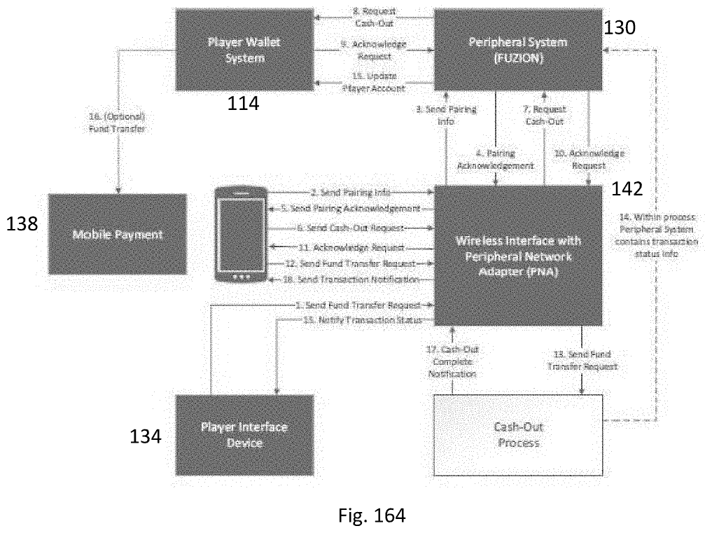

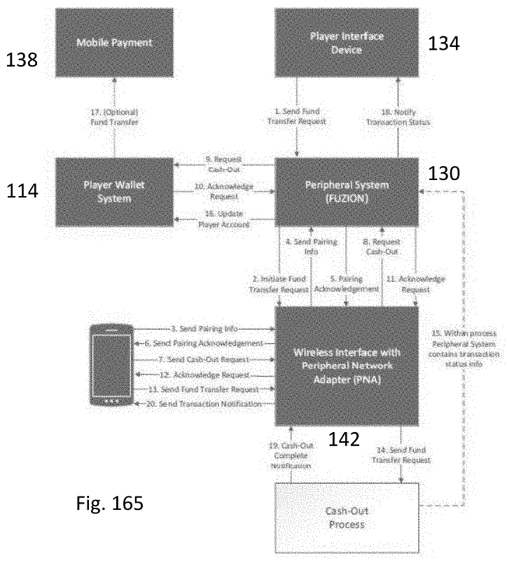

FIGS. 163 and 165 show a system configuration whereby the Player Interface Device 134 is connected to the Peripheral System 130. FIG. 164 shows the Player Interface Device 134 connected to the PNA 142.

### Transfer Out Options

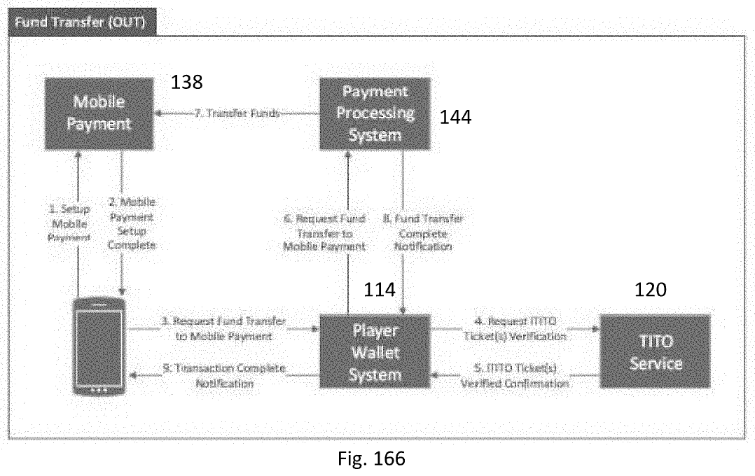

FIGS. 166-175 illustrate block diagrams of various fund transfer out systems according to the embodiments of the present invention.

FIGS. 166-169 shows instances where a virtual TITO ticket stored in the Player Wallet System 114 is validated by the TITO System, then the confirmed fund amount is transferred to the player's desired form of Mobile Payment (ex. Apple Pay, Google Pay, etc.). The fund transfer can be initiated in a variety of ways including using the Player Wallet System 114 directly, Peripheral System 130 or PNA 142.

FIG. 166 shows a system configuration whereby the player uses a mobile device 110 to directly access the Player Wallet System 114 and initiate the transfer of funds to the player's Mobile Payment 138 (e.g., Apple Pay, Google Pay, etc.). In this embodiment, the virtual TITO ticket stored in the Player Wallet System 114 is validated by the TITO system 120, then the confirmed fund amount is transferred to the player's desired form of Mobile Payment.

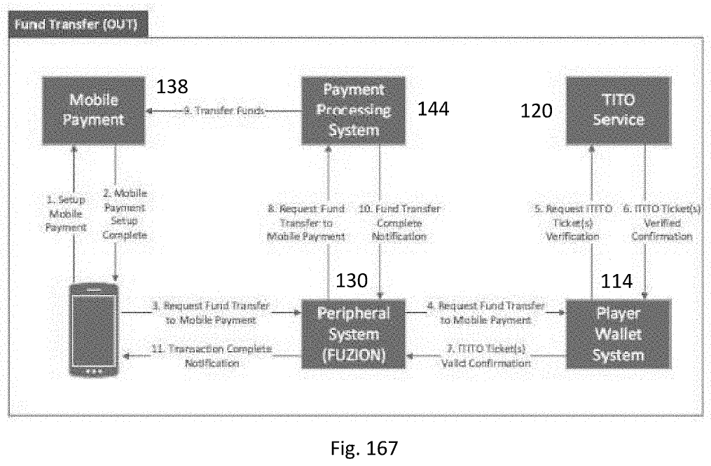

FIG. 167 shows a system configuration whereby the player uses a mobile device 110 to access the Peripheral System 130 and initiate the transfer of funds to the player's Mobile Payment 138.

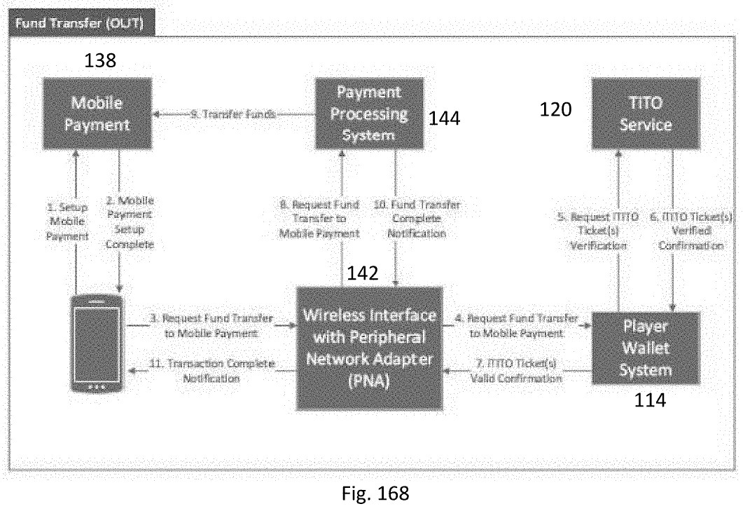

FIG. 168 shows a system configuration whereby the player uses a mobile device 110 to connect to the PNA 142 and initiate the transfer of funds to the player's Mobile Payment. In this embodiment, the PNA 142 communicates directly with the Player Wallet System 114 in order to initiate the transfer of funds to the player's Mobile Payment 138.

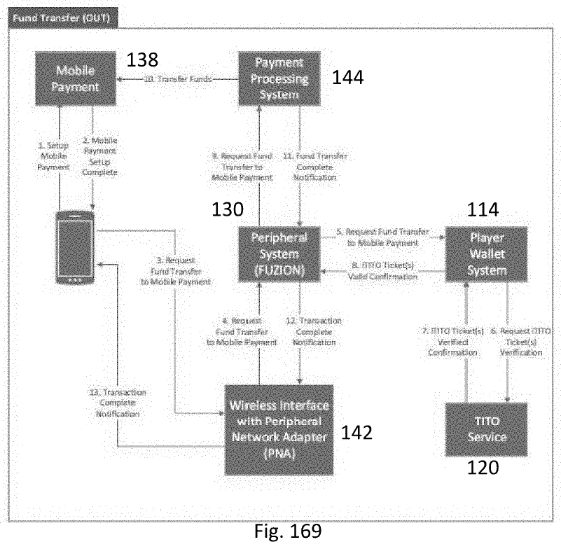

FIG. 169 shows a system configuration whereby the PNA 142 communicates with the Peripheral System 130 to initiate the transfer of funds to the player's Mobile Payment 138.

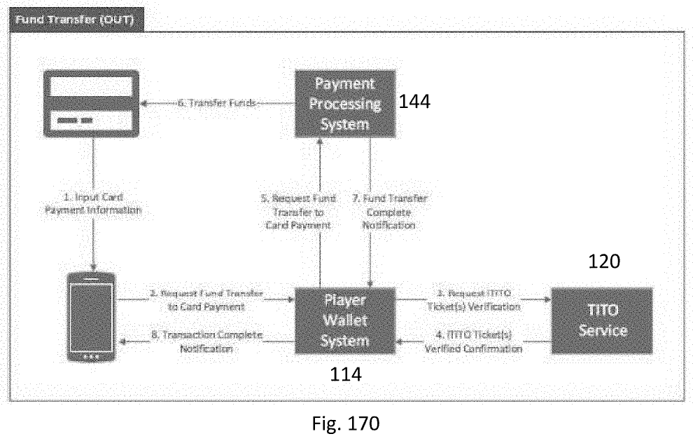

FIGS. 170-175 show instances where the virtual TITO ticket stored in the Player Wallet System 114 is validated by the TITO System 120, then the confirmed fund amount is transferred to the player's desired form of card payment (e.g., debit card, casino card, etc.), The fund transfer can be initiated in a variety of ways including using Player Wallet System 114 directly, Peripheral System 130 or PNA 142.

FIG. 170 shows a system configuration whereby the virtual TITO ticket stored in the Player Wallet System 114 is validated by the TITO System 120, then the confirmed fund amount is transferred to the player's desired form of card payment (e.g., debit card, casino card, etc.). As shown, in this embodiment, the player uses a mobile device 110 to directly access the Player Wallet System 114 and initiate the transfer of funds to the player's card payment.

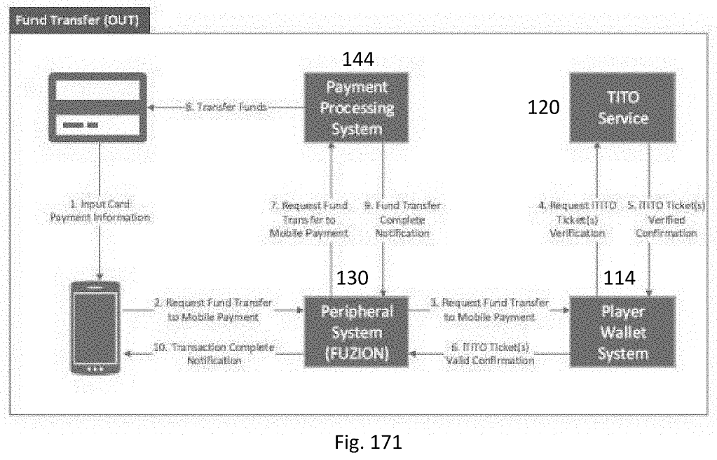

FIG. 171 shows a system configuration whereby the player uses a mobile device 110 to access the Peripheral System 130 and initiate the transfer of funds to the player's card payment.

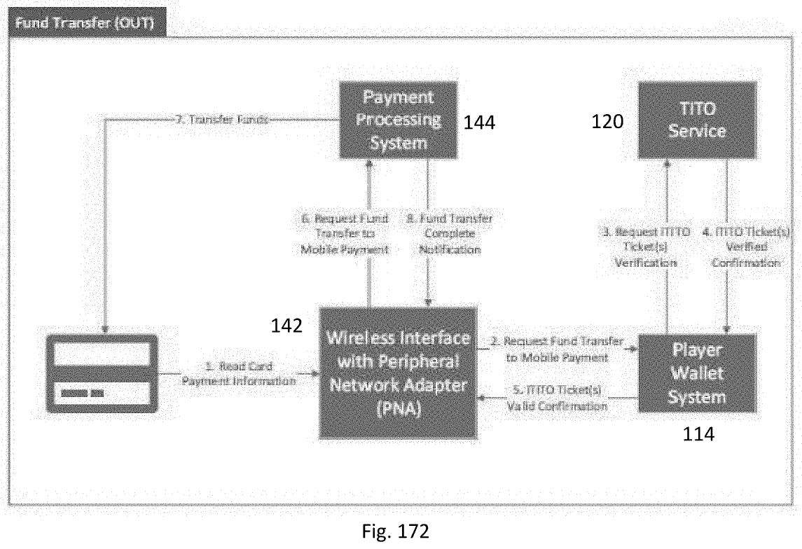

FIG. 172 shows a system configuration whereby the card payment information is provided to the PNA 142 directly through the wireless interface of the PNA 142. The PNA 142 then initiates the transfer of funds to the player's card payment.

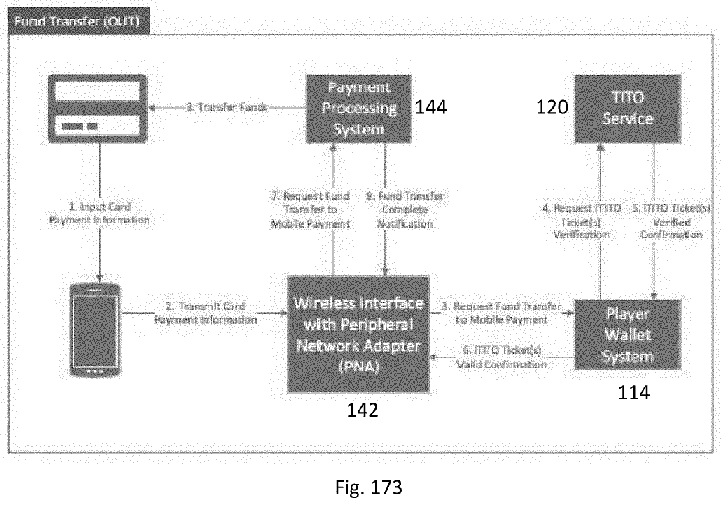

FIG. 173 shows a system configuration whereby the card payment information is provided to the mobile device 110 which then is transmitted to the PNA 142 through the wireless Interface of the PNA 142. The PNA 142 then initiates the transfer of funds to the player's Card Payment.

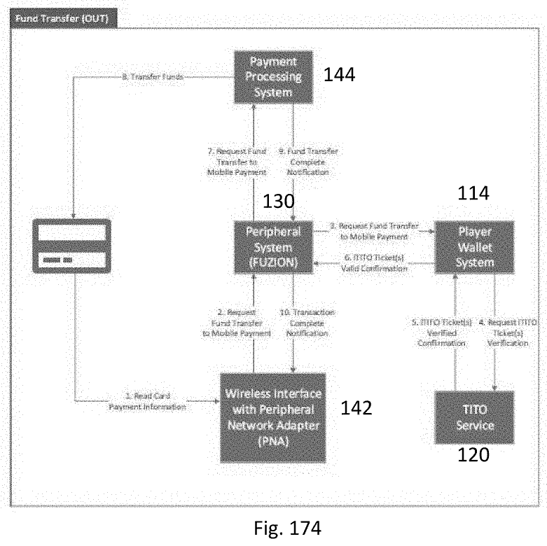

FIG. 174 shows a system configuration whereby the card payment information is provided to the PNA 142 directly through the wireless interface of the PNA 142. The PNA then initiates the transfer of funds to the player's card payment via the Peripheral System 130.

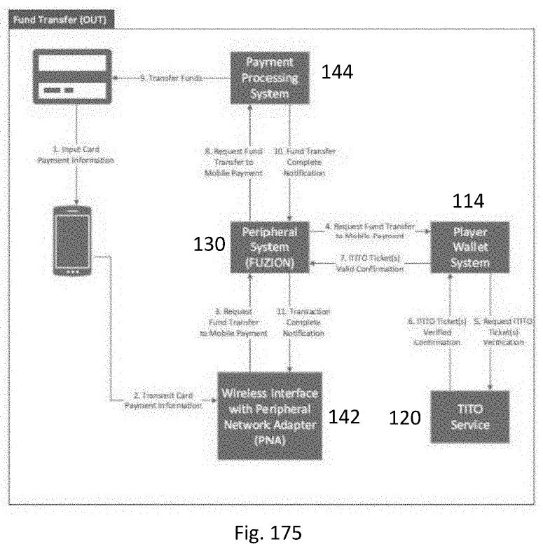

FIG. 175 shows a system configuration whereby the card payment information is provided to the mobile device 110 which then transmits to the PNA 142 through its wireless interface. The PNA 142 then initiates the transfer of funds to the player's card payment by contacting the Peripheral System 130.

### Cash Out Process Options

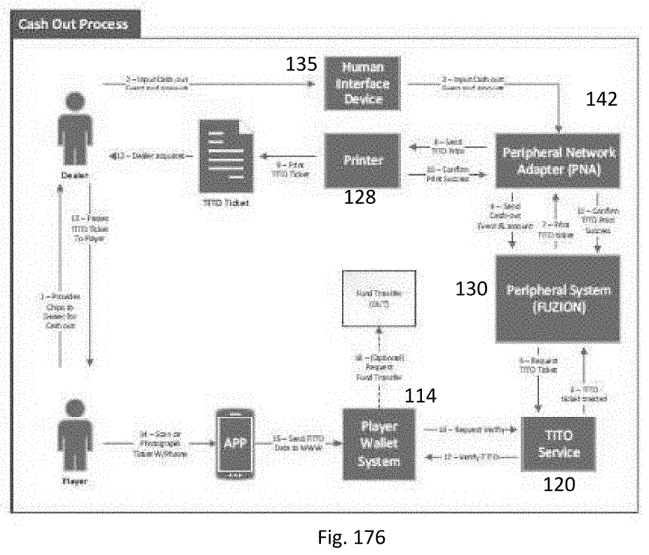

FIGS. 176-196 illustrate block diagrams of various cash out processes according to the embodiments of the present invention.

FIGS. 176-185 show instances where a TITO ticket is converted to a virtual TITO ticket that is stored in a Player Wallet System 114. A TITO ticket can be converted to a virtual TITO ticket and deposited into the Player Wallet System in a variety of ways including player deposits into the Player Wallet System 114 or the dealer may deposit the funds into the Player Wallet System 14.

FIG. 176 shows a process where the dealer enters a gaming chip value into a human interface device 135 connected to the PNA 142. The PNA communicates with the Peripheral System 130 which communicates with the TITO System 120 to create a TITO ticket that the player deposits into Player Wallet System 114.

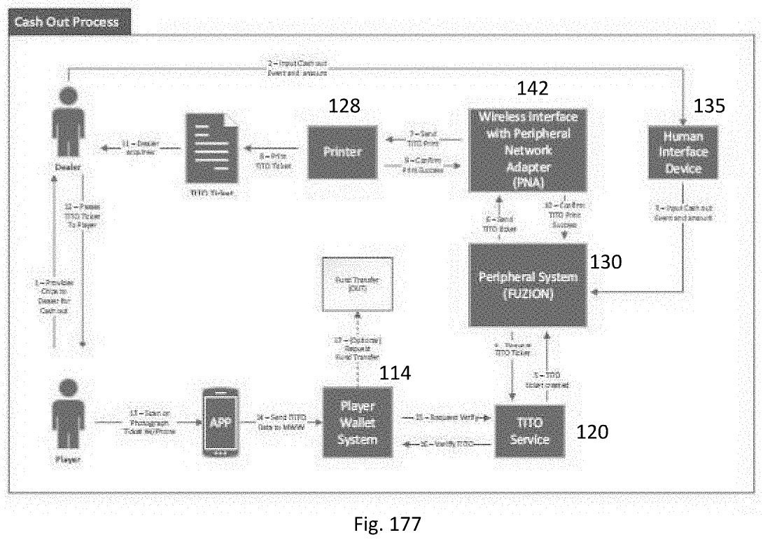

FIG. 177 shows a process where the dealer enters player's gaming chip value into a human interface device 135 connected to the Peripheral System 130. The Peripheral System 130 communicates with the TITO System 120 to create a TITO ticket that the player submits to a Player Wallet System 114.

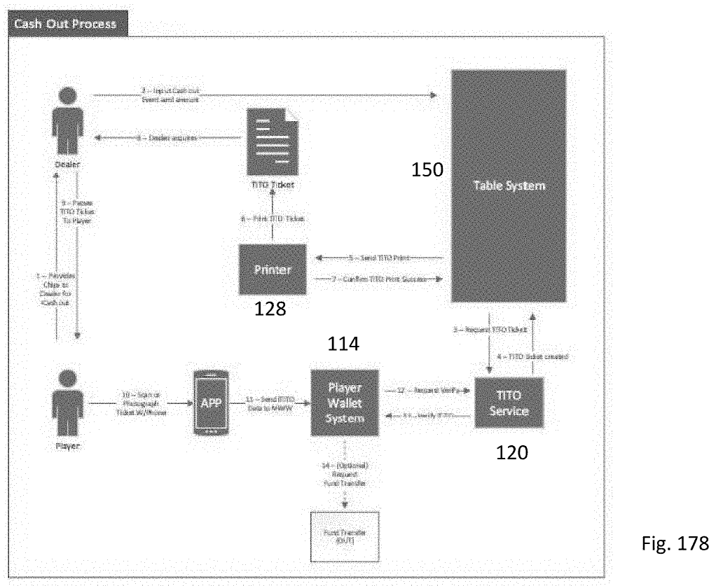

FIG. 178 shows a process where the transaction is processed through the CTG System 150. As shown, the CTG System 150 communicates with the TITO System 120 to create a TITO ticket that the player submits to their Player Wallet System 114.

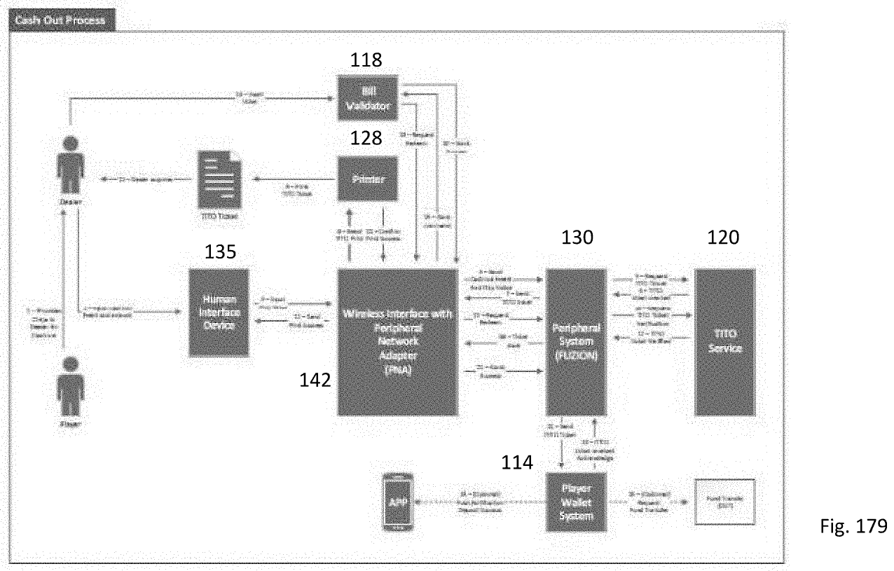

FIG. 179 shows a process where the dealer uses a BV 118 to begin the process of verifying and depositing the TITO ticket into a Player Wallet System 114. The Peripheral System 130 communicates with the TITO System 120 to verify the TITO ticket. As shown, the Peripheral System 130 communicates directly with the Player Wallet System 114.

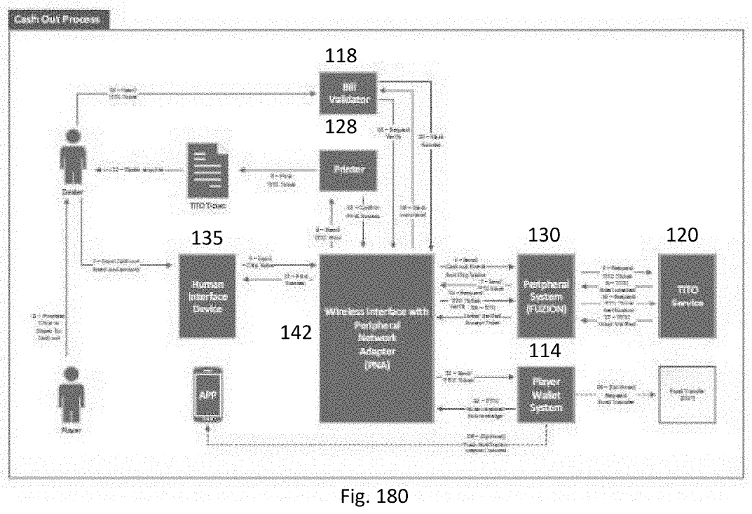

FIG. 180 shows a process where the PNA 142 communicates directly with the Player Wallet System 114.

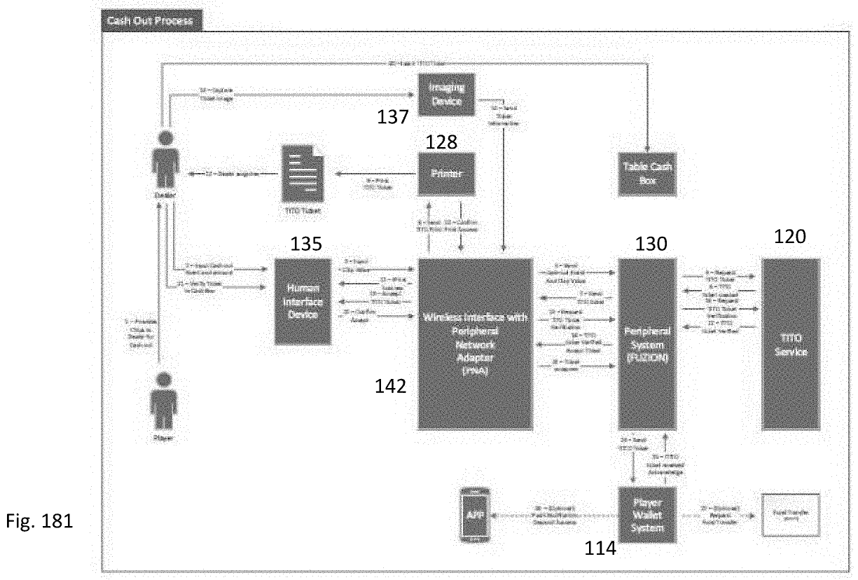

FIG. 181 shows a process where the dealer uses an imaging device 137 to begin the process of verifying and depositing the TITO ticket into a Player Wallet System 114. The Peripheral System 130 communicates with the TITO System 120 to verify the TITO ticket.

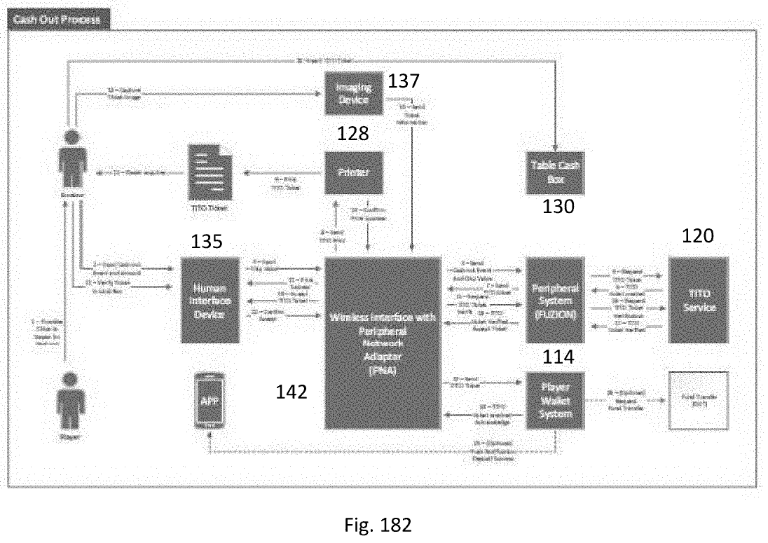

FIG. 182 shows a process where the PNA 142 communicates directly with the Player Wallet System 114.

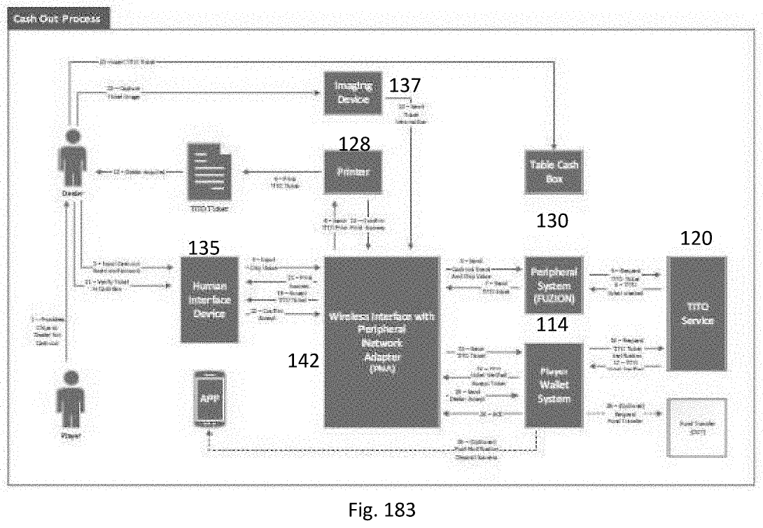

FIG. 183 shows a process where the Player Wallet System 114 communicates directly with the PNA 142 and TITO System 120.

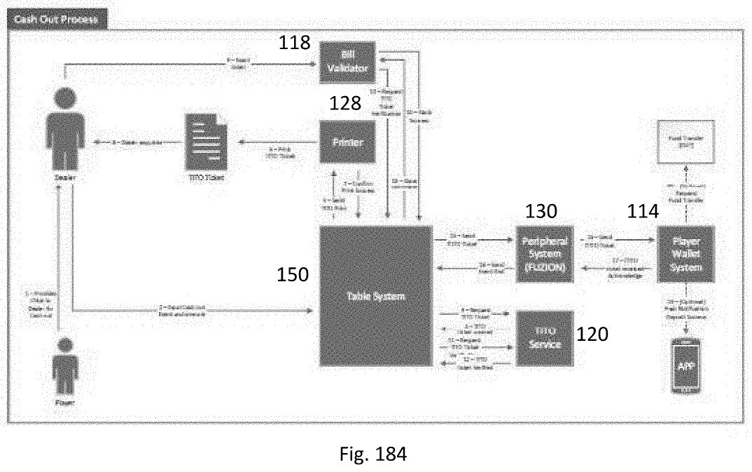

FIG. 184 shows a process where the dealer uses the CTG System 150 to verify and deposit the TITO ticket into a player's Player Wallet System 114. The CTG System 150 is connected to the Peripheral System 130 and the Player Wallet System 114. The Peripheral System 130 is connected to the TITO System 120. The BV 118 is used to retrieve TITO ticket information and provide it to the CTG System 150.

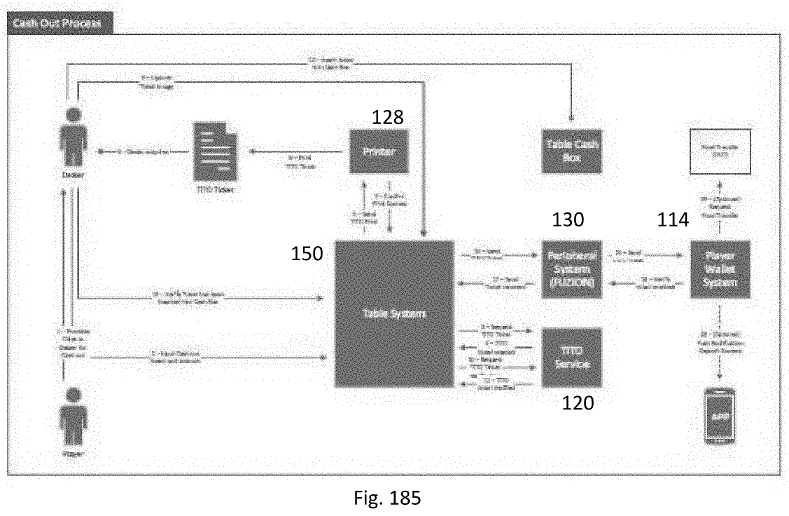

FIG. 185 shows a process where an imaging device 137 is used to retrieve TITO ticket information and provide it to the CTG System 114. A secure drop-box is used to store the TITO tickets after they are successfully scanned.

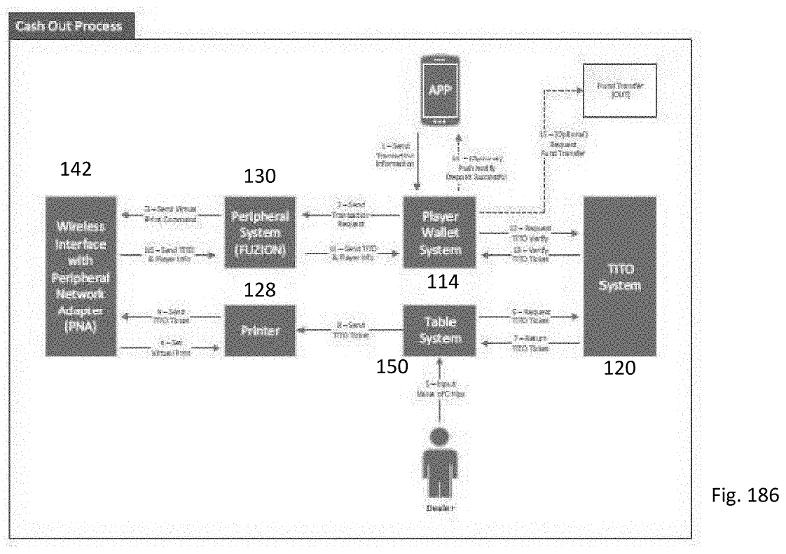

FIGS. 186-189 show instances where a virtual TITO ticket is created and stored in the Player Wallet System 114 without printing a TITO ticket. The printer is in virtual print mode and sends the virtual TITO ticket to the PNA 142 for processing instead of printing a physical TITO ticket.

FIG. 186 shows a process where a virtual TITO ticket is created and stored in a Player Wallet System 114 without printing a TITO ticket. The printer is still part of the process, but it is put in virtual print mode to transmit virtual TITO ticket information to the PNA 142 for processing instead of printing a TITO ticket. As shown, the Peripheral System 130 receives a request from the Player Wallet System 114 to cash out via virtual print. The Peripheral System 130 commands the PNA 142 to set the printer to virtual print mode. Once the Player Wallet System 114 receives a virtual TITO ticket, it verifies its authenticity with the TITO System 120 before storing in the player's Player Wallet System 114.

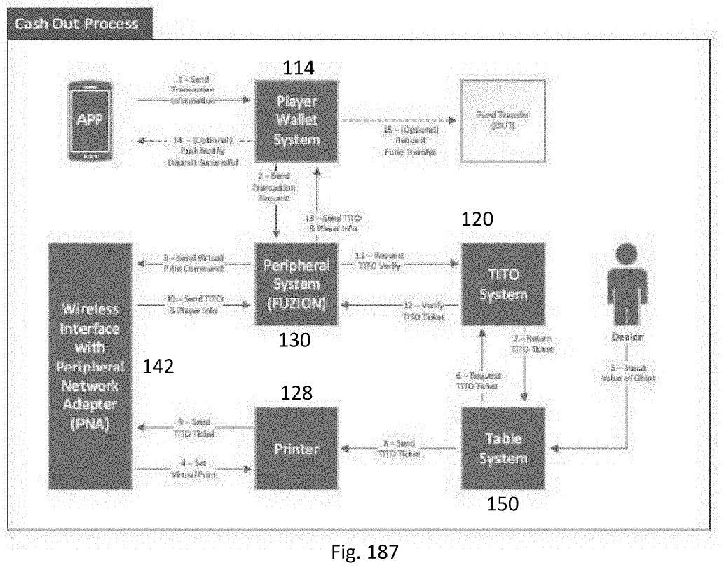

FIG. 187 shows a process where the Peripheral System 130 verifies the authenticity of the virtual TITO ticket prior to storing it in the player's Player Wallet System 114.

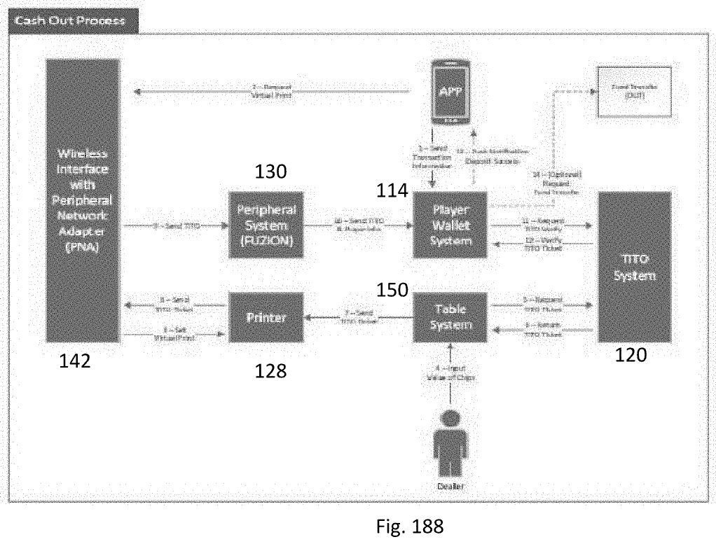

FIG. 188 shows a process where the PNA 142 receives a request from the mobile device 110 to cash out via virtual print. The PNA 142 then sets the printer to virtual print mode. Once the Player Wallet System 114 receives a virtual TITO ticket, it verifies its authenticity with the TITO System 120 before storing in the player's Player Wallet System 114.

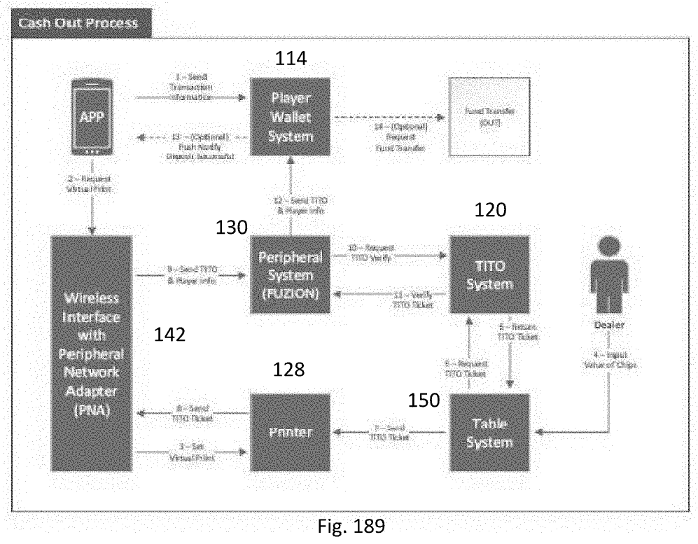

FIG. 189 shows a process where the Peripheral System 130 verifies the authenticity of the virtual TITO ticket prior to storing it in the player's Player Wallet System 114.

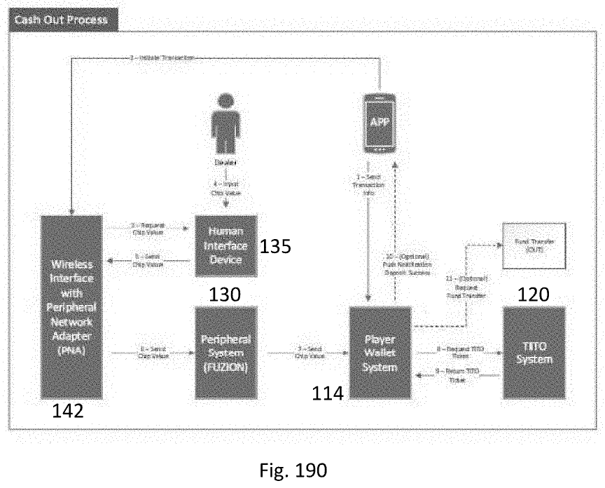

FIGS. 190-196 show instances where a virtual TITO ticket is created and stored in the Player Wallet System 114 without the need of a printer. The PNA 142 obtains information about the Player Wallet System 114 when the transaction is initiated.

FIG. 190 shows a process where a virtual TITO ticket is created and stored in the Player Wallet System 114 without the need of a printer. The PNA 142 obtains information about the player's Player Wallet System 114 when the transaction is initiated. The mobile device 110 obtains the player's Player Wallet System 114 and relays it to the PNA 142 while initiating the transaction. As shown, upon receiving the cash out amount, the Player Wallet System 114 obtains the virtual TITO ticket directly from the TITO System 120.

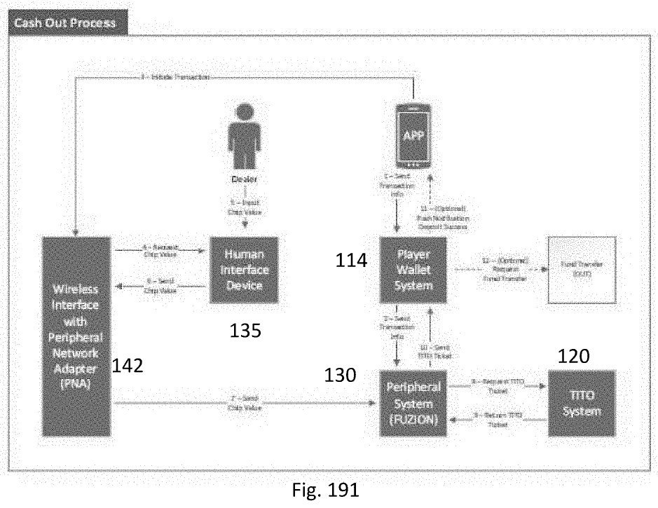

FIG. 191 shows a process where the Peripheral System 130 obtains the virtual TITO ticket and deposits it into the player's Player Wallet System 114.

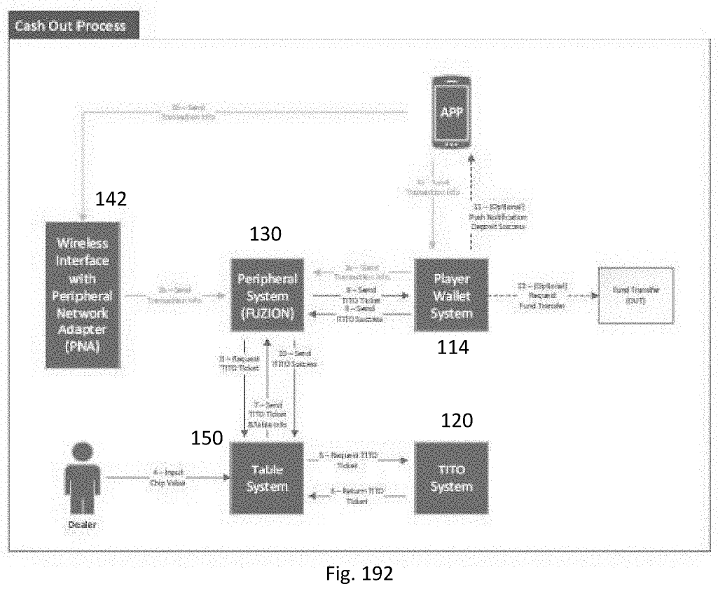

FIG. 192 shows a process where the CTG System 150 obtains the virtual TITO ticket and sends it to the player's Player Wallet System 114 through the Peripheral System 130.

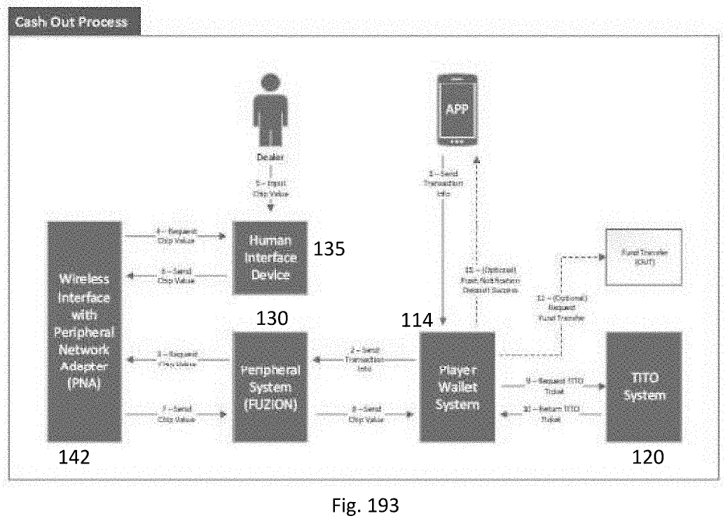

FIG. 193 shows a process where the Player Wallet System 114 receives a request to cash out from the mobile device 110. The Player Wallet System 114 relays the request along with the player's Player Wallet System 114 through the Peripheral System 130 to the PNA 142. In this embodiment, upon receiving the cash out amount, the Player Wallet System 114 obtains the virtual TITO ticket directly from the TITO System 120.

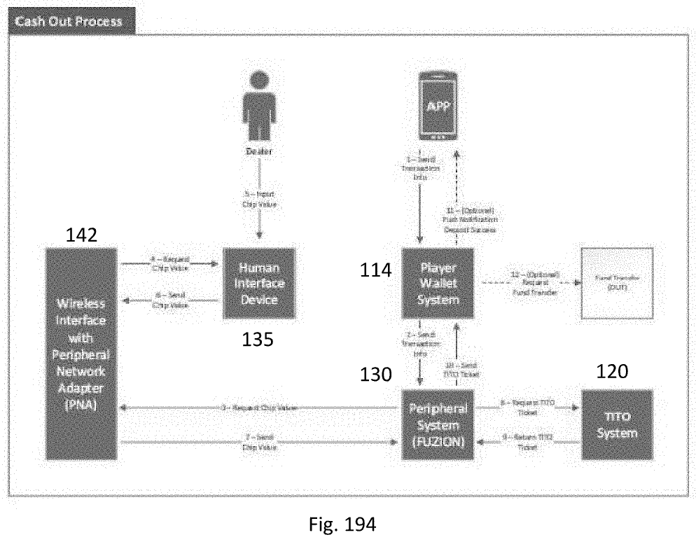

FIG. 194 shows a process where the Peripheral System 130 obtains the virtual TITO ticket and deposits it into the player's Player Wallet System 114.

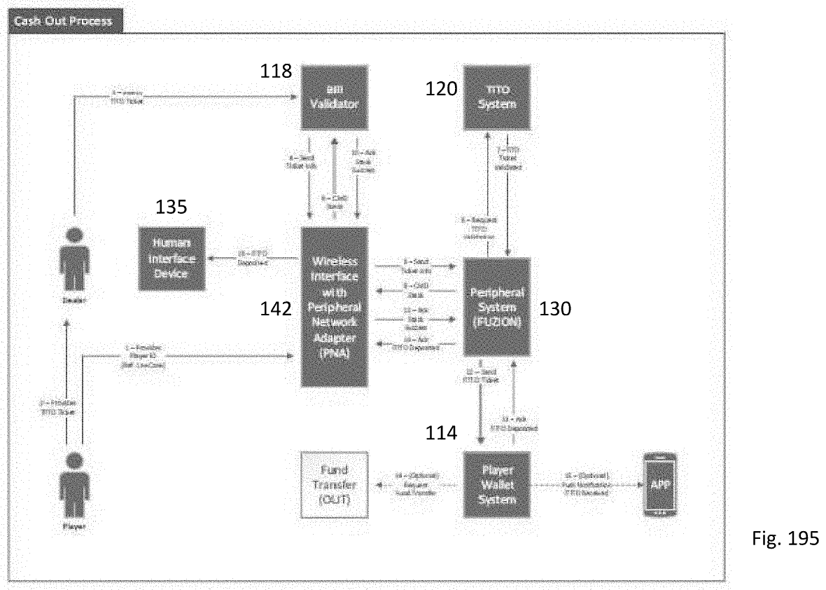

FIG. 195 shows a process where the dealer converts a physical TITO ticket into a virtual TITO ticket. Such an embodiment may be applicable when the player does not have a mobile device 110 to access their Player Wallet System 114. As shown, the Peripheral System 130 obtains the virtual TITO ticket from the TITO System 120 and deposits it into the Player Wallet System 114.

FIG. 196 shows a process where the CTG System 150 obtains the virtual TITO ticket and deposits it into the Player Wallet System 114 through the Peripheral System 130.

FIG. 197 shows a gaming table 200 with wireless interface units 205-1 through 205-N integrated therein. The wireless interface units 205-1 through 205-N are configured to communicate with the mobile devices of players for purposes as detailed herein.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

Although the invention has been described in detail with reference to several embodiments, additional variations and modifications exist within the scope and spirit of the invention as described and defined in the following claims.

We claim:

1. A system for funding table game wagers in a gaming environment, comprising:
at least one player interface device;
at least one processing unit, communicably connected to the at least one player interface device and table game system, that:
identifies a mobile wallet account and table game based at least on a first communication between a mobile device and the at least one player interface device and a second communication between the at least one processing unit and the mobile device; and
identifies at least a value available for redemption in the form of gaming chips.

2. The system of claim 1, wherein the first communication between the mobile device and the at least one player interface device comprises a bump communication.

3. The system of claim 1 wherein the at least one player interface device is integrated into a gaming table.

4. The system of claim 1, wherein the at least one processing unit communicates with a TITO system to validate a virtual ticket before redeeming the same in the form of gaming chips.

5. The system of claim 1 wherein responsive to a cash out event the system generates a virtual TITO ticket.

6. A system for funding table game wager in a gaming environment, comprising:
at least one player interface device communicably connected to a table game system including a plurality of table games; and
at least one processing unit, communicably connected to the at least one player interface device and the table game system, that:
identifies a mobile wallet account and a table game based at least on a first communication between a mobile device and the at least one player interface device and a second communication between the at least one processing unit and the mobile device; and
identifies at least a value available for redemption in the form of gaming chips at said table game.

7. The system of claim 6, wherein the first communication between the mobile device and the at least one player interface device passes an identifier associated with the mobile wallet account from the mobile device to the at least one player interface device.

8. The system of claim 6 wherein responsive to a cash out event the system generates a virtual TITO ticket with an associated value that corresponds to a value of gaming chips cashed in by a player.

9. The system of claim 6 wherein responsive to a buy in event the system verifies a virtual TITO ticket prior to redemption thereof for gaming chips.

10. The system of claim 6 wherein responsive to a buy in event the system verifies a physical TITO ticket prior to redemption thereof for gaming chips.

11. The system of claim 6 wherein responsive to a cash out event the system generates a virtual TITO ticket.

12. A system for funding table game wagers in a gaming environment, comprising:
at least one player interface device;
a bill validator;
at least one processing unit, communicably connected to the at least one player interface device and table game system, that:
identifies a mobile wallet account and table game based at least on a first communication between a mobile device and the at least one player interface device and a second communication between the at least one processing unit and the mobile device; and
identifies at least a value available for redemption in the form of gaming chips.

13. The system of claim 12, wherein the first communication between the mobile device and the at least one player interface device comprises a bump communication.

14. The system of claim 12 wherein the at least one player interface device is integrated into a gaming table.

15. The system of claim 12, wherein the at least one processing unit communicates with a TITO system to validate a virtual ticket before redeeming the same in the form of gaming chips.15.

16. The system of claim 12 wherein the bill validator is configured to read physical and virtual TITO tickets.

17. The system of claim 12 wherein responsive to a cash out event the system generates a virtual TITO ticket.

18. A system comprising:
a table game system configured to communicatively link a plurality of gaming tables to a common network;
each of said plurality of gaming tables incorporating one or more wireless interfaces configured to communicate with mobile devices of players; and
a casino table game system configured to track gaming chips provided to players or chased in by players.

19. The system of claim 18, wherein the first communication between the mobile device and the at least one player interface device comprises a bump communication.

20. The system of claim 18 wherein the at least one player interface device is integrated into a gaming table.

21. The system of claim 18, wherein the at least one processing unit communicates with a TITO system to validate a virtual ticket before redeeming the same in the form of gaming chips.

22. The system of claim 18 wherein responsive to a cash out event the system generates a virtual TITO ticket.

23. The system of claim 18 wherein responsive to a cash out event the system generates a virtual TITO ticket.

24. A system comprising:
a plurality of gaming tables configured to accept wagers on live games of chance;
a table game system configured to communicatively link said plurality of gaming tables to a common network;
one or more bill validators;
each of said plurality of gaming tables incorporating one or more wireless interfaces configured to communicate with mobile devices of players; and
a casino table game system configured to redeem mobile payments in exchange for gaming chips to be provided to players for game play.

25. The system of claim 24 wherein the bill validator is configured to read physical and virtual TITO tickets.

26. The system of claim 24, wherein the first communication between the mobile device and the at least one player interface device comprises a bump communication.

27. The system of claim 24, wherein the at least one processing unit communicates with a TITO system to validate a virtual ticket before redeeming the same in the form of gaming chips.

28. The system of claim 24 wherein responsive to a buy in event the bill validator verifies a virtual TITO ticket prior to redemption thereof for gaming chips.

29. The system of claim 24 wherein responsive to a buy in event the bill validator verifies a physical TITO ticket prior to redemption thereof for gaming chips.

30. The system of claim 24 wherein responsive to a cash out event the system generates a virtual TITO ticket.
